(19) United States
(12) Patent Application Publication
(10) Pub. No.: US 2017/0351996 A1
(43) Pub. Date: Dec. 7, 2017

(54) Customizable Building Delivery Systems

(71) Applicant: Yoorang LLC, New City, NY (US)

(72) Inventor: Doron J. Fetman, Monsey, NY (US)

(21) Appl. No.: 15/590,315

(22) Filed: May 9, 2017

Related U.S. Application Data
(60) Provisional application No. 62/345,521, filed on Jun. 3, 2016.

(51) Int. Cl. G06Q 10/08; G06Q 30/06; G06Q 50/12

(52) U.S. Cl. CPC G06Q 10/087; G06Q 50/12; G06Q 30/0601; G06Q 10/0832; G06Q 10/08355; G06Q 10/0833; G06Q 30/06

(57) ABSTRACT

A delivery system for coordination of the receiving and distribution of goods and services throughout a building from outside vendors that do not have direct access is described. An intra-building delivery system is established that places low-profile kiosks in the lobbies and message areas of commercial and residential buildings. These kiosks may be deemed the “transfer point.” The delivery system may also use a building-specific web portal for allowing residents, employees, and business leaders to place orders through outside vendors and coordinate delivery from the lobby of a building to their offices or apartments. Kiosk dispatchers and delivery runners may use mobile/tablet applications to receive goods and services at the transfer point and to validate delivery through signature-based delivery acceptance by residents and employees.

### REFERENCE TO PRIOR APPLICATIONS

This application claims the benefit of U.S. Provisional Patent Application Ser. No. 62/345,521, filed on Jun. 3, 2016.

### FIELD OF THE DISCLOSURE

The present invention relates to the field of providing a customizable system and methods for improved delivery systems within high-security office and residential buildings.

### BACKGROUND

Modern high-rise office and residential buildings offer numerous amenities to their tenants or occupants. One such feature of these buildings is enhanced security that restricts entry to outside parties, including personnel providing deliveries to building occupants. These security systems and restrictive transportation systems such as pass-code elevators and barriers provide barriers to delivery services being able to reach customers in high-rise buildings.

In such buildings, delivery personnel must often wait at the building lobby for the customer to retrieve the delivery. But a customer in such a building will not always desire to meet a delivery in person. Running down to the entry of a building to meet a delivery wastes time and resources and sometimes is not possible. Further, delivery services themselves also lose valuable time in waiting for customers to meet them in lobbies of buildings.

Accordingly, there is a need to provide an improved system and method of providing enhanced delivery services within high-security buildings.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows a desktop homepage of the delivery system for a user.

FIG. 2 shows a desktop homepage of the delivery system for a user showing an instructional video on how the delivery system works.

FIG. 3 shows a desktop homepage of the delivery system inviting a user to search for a system-enabled building.

FIG. 4 shows a desktop homepage of the delivery system with an autocomplete feature where the user is typing in an address of a desired building.

FIG. 5 shows a desktop homepage of the delivery system with a autocomplete hovering feature when a user is locating a building.

FIG. 6 shows a desktop homepage of the delivery system for a user showing information about a building registered within the delivery system.

FIG. 7 shows a desktop homepage of the delivery system showing a screen allowing a user to request adding a new building to be registered within the delivery system.

FIG. 8 shows a desktop homepage of the delivery system showing a screen confirming that the user has requested adding a new building to be registered within the delivery system.

FIG. 9 shows a desktop homepage login screen for users of the delivery system.

FIG. 10 shows a registration page for a new user of the delivery system.

FIG. 11 shows a registration page for a new user of the delivery system where the user searches for his or her building.

FIG. 12 shows a registration page for a new user of the delivery system with an autocomplete feature to assist a user in locating a building.

FIG. 13 shows a registration page with a autocomplete hovering feature to assist a user in locating a building.

FIG. 14 shows a registration page where a user registers a building to be used with the delivery system.

FIG. 15 shows a registration page where the user enters information for registration with the delivery system for the chosen building.

FIG. 16 shows a registration page where the user is shown those buildings for which he or she is registered for the delivery system.

FIG. 17 shows a registration page where the user enters personal details for the delivery system.

FIG. 18 shows a registration page with a drop-down menu for eligible buildings where the user enters personal details for the delivery system.

FIG. 19 shows a page where the user accepts the terms of service for the delivery system.

FIG. 20 shows a payment information registration system for a user of the delivery system.

FIG. 21 shows a Paypal screen for payment information when registering a user of the delivery system.

FIG. 22 shows a desktop homepage for a registered user of the delivery system.

FIG. 23 shows a desktop homepage for a registered user of the delivery system with the menu displayed.

FIG. 24 shows a desktop homepage for a registered user of the delivery system with the eligible buildings displayed.

FIG. 25 shows another desktop homepage for a registered user of the delivery system.

FIG. 26 shows another desktop homepage for a registered user of the delivery system with the menu displayed and a reminder by the orders menu.

FIG. 27 shows a desktop homepage for a registered user with an exclusive offer highlighted when hovered.

FIG. 28 shows an account information page for a registered user of the delivery system.

FIG. 29 shows a building editing page for a registered user of the delivery system.

FIG. 30 shows a menu that is in the building that is registered to a user of the delivery system.

FIG. 31 shows a building search page for a registered user of the delivery system.

FIG. 32 shows an autocomplete feature in a building search page for a registered user of the delivery system,

FIG. 33 shows a building selection page for a registered user of the delivery system.

FIG. 34 shows a delivery.com homepage framed by the delivery system.

FIG. 35 shows a seamless.com homepage framed by the delivery system.

FIG. 36 shows a desktop homepage showing current and prior orders of a user registered with the delivery system.

FIG. 37 shows a desktop homepage showing current and prior orders of a user registered with the delivery system with a current order highlighted.

FIG. 38 shows a desktop homepage showing sortable current and prior orders of a user registered with the delivery system.

FIG. 39 shows a homepage of a delivery manager module for the delivery system.

FIG. 40 shows a registration page for a delivery person to be appointed within the delivery system.

FIG. 41 shows a second registration page for a delivery person to be appointed within the delivery system.

FIG. 42 shows a background check permission notice for a delivery person to be appointed within the delivery system.

FIG. 43 shows a background check confirmation notice for a delivery person to be appointed within the delivery system.

FIG. 44 shows a login screen for users of the delivery manager module within the delivery system.

FIG. 45 shows an incomplete profile screen for a delivery person within the delivery system.

FIG. 46 shows a summary of orders in a building within the delivery system.

FIG. 47 shows a menu for sorting orders by status in a building within the delivery system.

FIG. 48 shows a menu for sorting orders by type in a building within the delivery system.

FIG. 49 shows expanded order information for one order in a building within the delivery system.

FIG. 50 shows a menu showing only incoming orders in a building within the delivery system.

FIG. 51 shows both an expanded order information for one order and a menu showing only incoming orders in a building within the delivery system.

FIG. 52 shows a menu showing only arrived orders in a building within the delivery system.

FIG. 53 shows a menu showing only outgoing orders in a building within the delivery system.

FIG. 54 shows both an expanded order information for one order and a menu showing only outgoing orders in a building within the delivery system.

FIG. 55 shows a menu showing only delivered orders in a building within the delivery system.

FIG. 56 shows both an expanded order information for one order and a menu showing only arrived orders in a building within the delivery system.

FIG. 57 shows a scanning tool for scanning an arriving package in a building within the delivery system.

FIG. 58 shows a list of available delivery runners for a package in a building within the delivery system.

FIG. 59 shows an assignment page for assigning a delivery runner for a package in a building within the delivery system.

FIG. 60 shows a module for a delivery runner to be onboarded within the delivery system.

FIG. 61 shows a system for confirming a time for a delivery runner to be onboarded within the delivery system.

FIG. 62 shows information for a delivery runner's compensation within the delivery system.

FIG. 63 shows information for a delivery runner's approval to work in a building within the delivery system.

FIG. 64 shows a delivery runner's approved shifts and available shifts to work within the delivery system.

FIG. 65 shows a delivery runner's approved shifts to work within the delivery system.

FIG. 66 shows an expanded menu of a delivery runner's approved shifts to work within the delivery system.

FIG. 67 shows an agreement for a delivery runner that cancels a future shift within the delivery system.

FIG. 68 shows an agreement for a delivery runner that signs up for a future shift within the delivery system.

FIG. 69 shows a delivery runner's available shifts to work within the delivery system.

FIG. 70 shows a delivery runner's highlighted available shifts to work within the delivery system.

FIG. 71 shows a delivery runner's schedule of an onboarding within the delivery system.

FIG. 72 shows a delivery runner's scheduling of a time for onboarding within the delivery system.

FIG. 73 shows a delivery runner's completion of the scheduling of a time for onboarding within the delivery system.

FIG. 74 shows a list of orders for which a delivery runner is responsible within the delivery system.

FIG. 75 shows a confirmation screen for an order to be confirmed by a user within the delivery system.

FIG. 76 shows a signature screen for an order to be confirmed by a user within the delivery system.

FIG. 77 shows an illustrated environment for implementing modules in accordance with the delivery system.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The solution disclosed herein essentially provides an overall system for a delivery of other deliveries. This solution provides cutting edge technology and white-glove service to empower residents, office workers, tenants, and businesses to more efficiently manage how they find and receive goods and services from outside vendors. The solution also enables building management to become more efficient by delivering deliveries from lobby/messaging center directly to a user within a building without a user needing to leave their space. The solution may be marketed under the YOORANG trademark.

Specifically, the delivery system allows coordination of the receiving and distribution of goods and services throughout a building from outside vendors that do not have direct access. To do so, an intra-building delivery system is established that places low-profile kiosks in the lobbies and message areas of commercial and residential buildings. These kiosks may be deemed the “transfer point” herein. The delivery system may also use a building-specific web portal for allowing residents, employees, and business leaders to place orders through outside vendors and coordinate delivery from the lobby of a building to their offices or apartments. Kiosk dispatchers and delivery runners may use mobile/tablet applications to receive goods and services at the transfer point and to validate delivery through signature-based delivery acceptance by residents, employees, and business leaders.

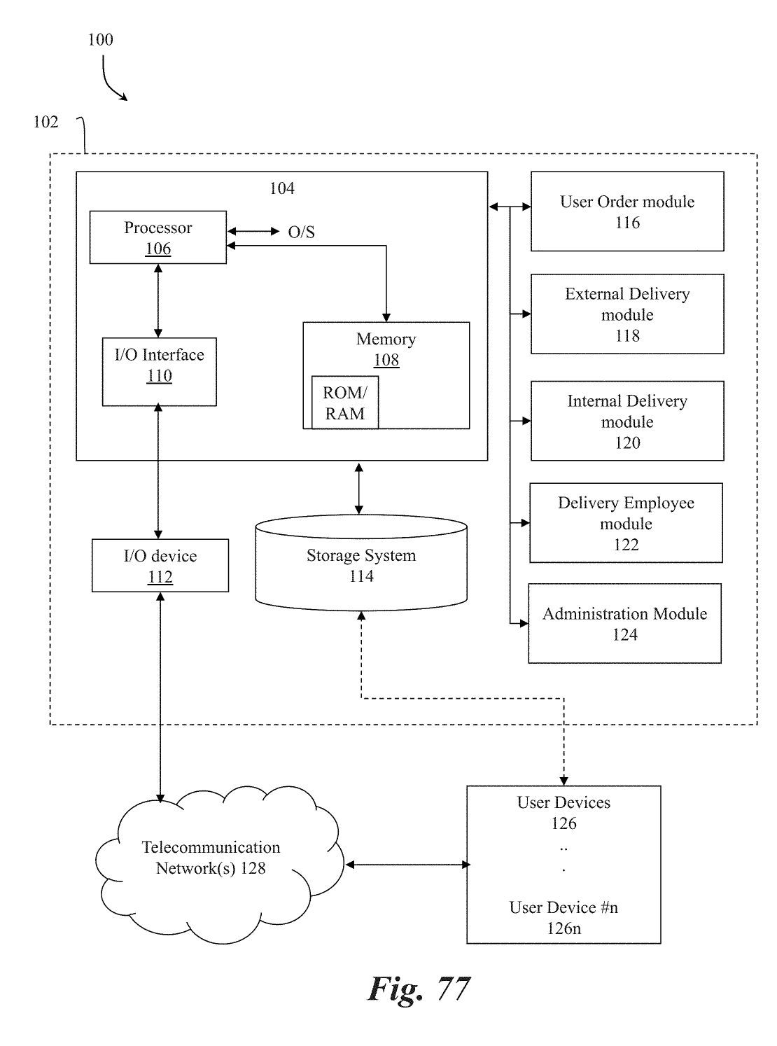

FIG. 77 depicts an illustrative system 100 for implementing the steps in accordance with the aspects of the invention. In particular, FIG. 77 depicts a system 100 including an coordinating system 102. In accordance with an example embodiment, the coordinating system 102 is a combination of hardware and software configured to carry out aspects of the present invention. In particular, the coordinating system 102 may be a computing system with specialized software and databases designed for providing an order-based system. For example, the coordinating system 102 may be software installed on a computing device, a web based application accessible by computing devices (e.g., the computing device 104), a cloud based application accessible by computing devices, etc. The combination of hardware and software that make up the coordinating system 102 are specifically designed to provide a technical solution to a particular problem utilizing an unconventional combination of steps/operations to carry out aspects of the present invention. In particular, the coordinating system 102 is designed to execute a unique combination of steps to provide a novel approach to delivery systems within secure buildings.

In accordance with an example embodiment of the present invention, the coordinating system 102 can include a computing device 104 having a processor 106, a memory 108, an input output interface 110, input and output devices 112 and a storage system 114. Additionally, the computing device 104 can include an operating system configured to carry out operations for the applications installed thereon. As would be appreciated by one skilled in the art, the computing device 104 can include a single computing device, a collection of computing devices in a network computing system, a cloud computing infrastructure, or a combination thereof, as would be appreciated by those of skill in the art. Similarly, as would be appreciated by one of skill in the art, the storage system 114 can include any combination of computing devices configured to store and organize a collection of data. For example, storage system 114 can be a local storage device on the computing device 104, a remote database facility, or a cloud computing storage environment. The storage system 114 can also include a database management system utilizing a given database model configured to interact with a user for analyzing the database data.

A REST (Representational state transfer) and set of streaming APIs and web sockets send and receive data from the server/database to apps, the website, SMS and email gateways for notifications, and to 3rd party services such as Seamless etc. In some cases, a direct I/O device may not be used to directly to interface between parts of the system. Instead, the interface between system parts may be handled by third-party hardware and cloud hosting.

Continuing with FIG. 77, the coordinating system 102 can include a combination of core modules to carry out the various functions of the present invention. In accordance with an example embodiment of the present invention, the coordinating system 102 can include a user order module 116, an external delivery module 118, an internal delivery module 120, a delivery employee module 122, and an administration module 124. As would be appreciated by one skilled in the art, the user order module 116, the external delivery module 118, the internal delivery module 120, the delivery employee module 122, and the administration module 124 may include any combination of hardware and software configured to carry out the various aspects of the present invention. In particular, each of the user order module 116, the external delivery module 118, the internal delivery module 120, the delivery employee module 122, and the administration module 124 are configured to operate as a delivery system within secure buildings.

In accordance with an example embodiment of the present invention, the system 100 can include a plurality of user devices 126 configured to communicate with the coordinating system 102 over a telecommunication network(s) 128. The coordinating system 102 can act as a centralized host providing the functionality of the modules 116, 118, 120, 122, 124 sharing a secured network connection. As would be appreciated by one skilled in the art, the plurality of user devices 126 can include any combination of computing devices, as described with respect to the coordinating system 102 computing device 104. For example, the computing device 104 and the plurality of user devices 126 can include any combination of servers, personal computers, laptops, tablets, smartphones, etc. In accordance with an example embodiment of the present invention, the computing devices 104, 126 can be configured to establish a connection and communicate over telecommunication network(s) 128 to carry out aspects of the present invention. As would be appreciated by one skilled in the art, the telecommunication network(s) 128 can include any combination of known networks. For example, the telecommunication network(s) 128 may be combination of a mobile network, WAN, LAN, or other type of network. The telecommunication network(s) 128 can be used to exchange data between the computing devices 104, 126, exchange data with the storage system 114, and/or to collect data from additional sources.

In operation, the system 100 provides a graphical user interface (GUI) to carry out the various aspects of the present invention. In particular, the computing device 104 generates a GUI providing a skills framework for individual employees throughout a company to be utilized for evaluations and career path planning. As would be appreciated by one skilled in the art, the GUI can be generated utilized any combination of software and hardware known in the art (e.g., via the User Order module 116).

Each of the five modules (User Order module 116, External Delivery module 118, Internal Delivery module 120, Delivery Employee module 122 and Administration module 124) are discussed in more detail below.

I. User Order Module

The purpose of the User Order module 116 include the following for registered users:

1. Users may order delivery goods and services through 3rd party services such as delivery.com or seamless.com and then to have them delivered to their desks from the lobby of a secured building by delivery system employees.

2. Users may order delivery goods and services through “In Your Building” vendors in the immediate vicinity of a delivery system building or within the delivery system building.

3. Users may purchase goods and services through a “group buy” system where additional purchases within the building unlock progressive discounts, thereby incentivizing residents/employees/business leaders to purchase more products/services together.

A. Initiation

The User Order module 116 may be initiated by a user seeking to become a registered using the following steps. A “registered” user is a resident of a residential building, or an employee/business leader of a company in a commercial building residing within a building that does not allow delivery past the lobby of the building.

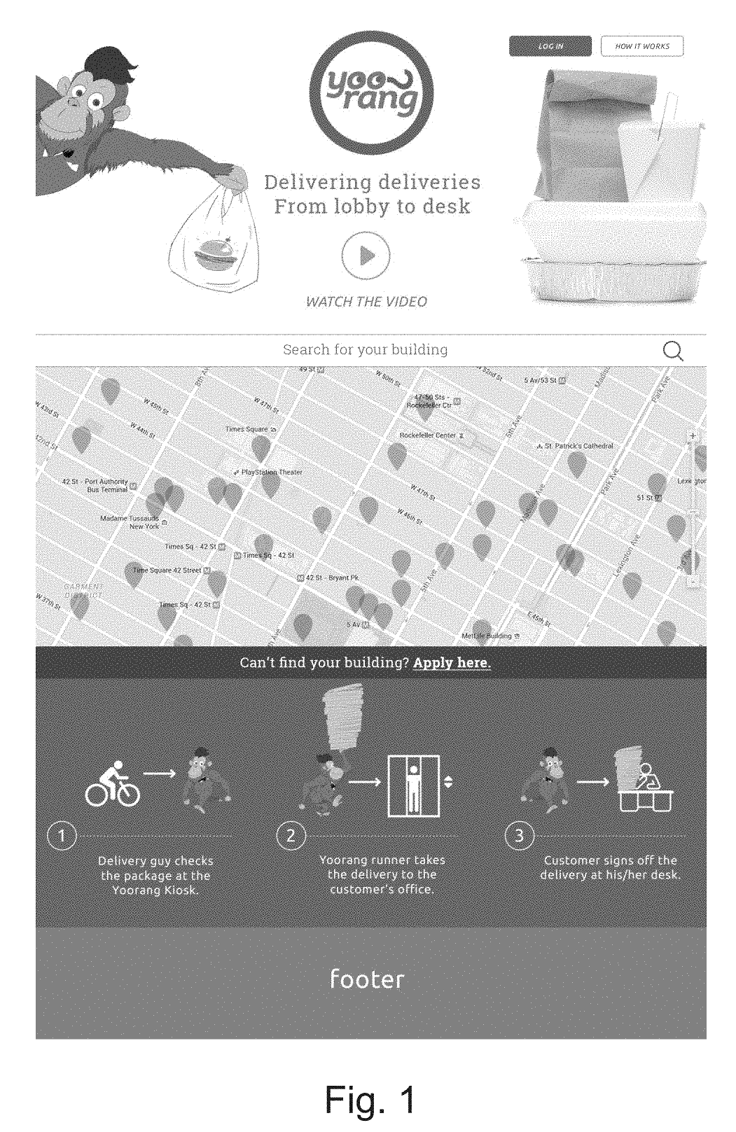

1. The delivery system may provide for a user to see a map of enabled buildings which is centered on the user's' current location, can choose their building on the map. FIG. 1 shows such an exemplary map that can be viewed by the user.

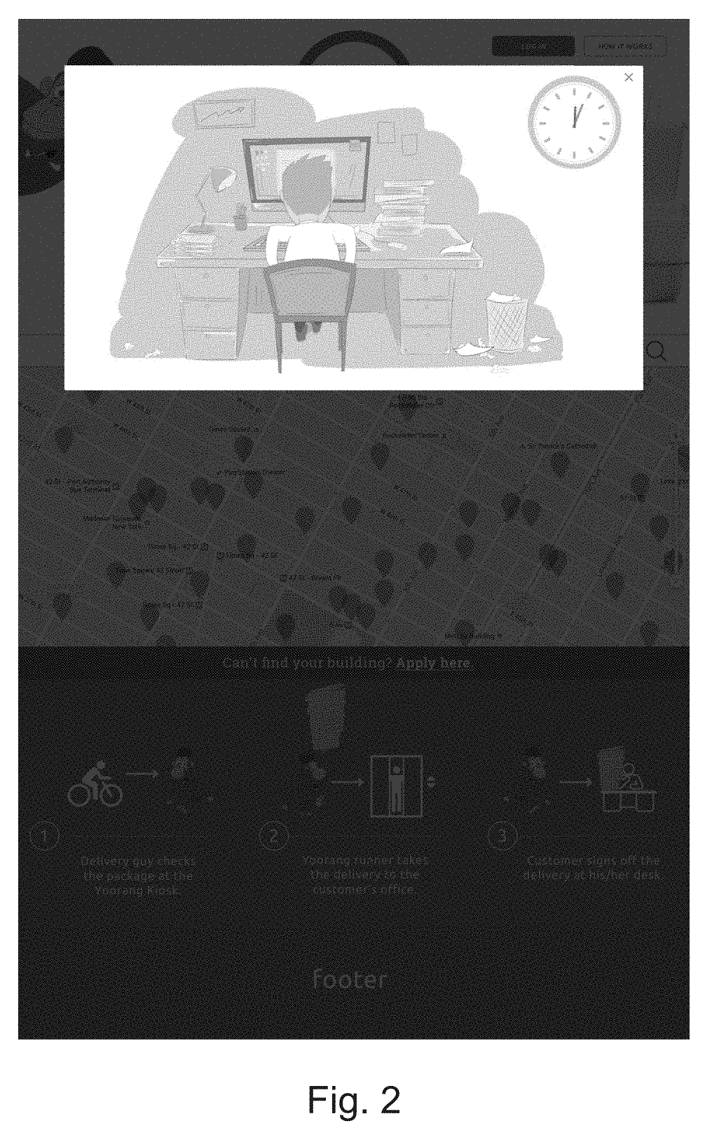

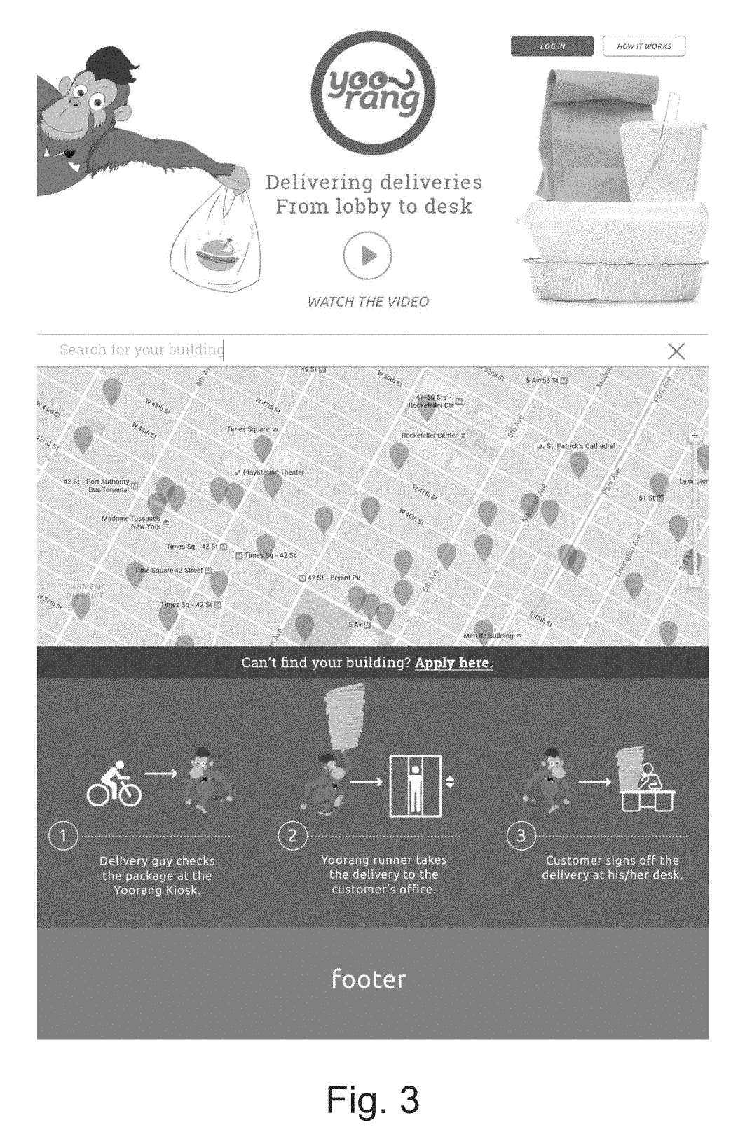

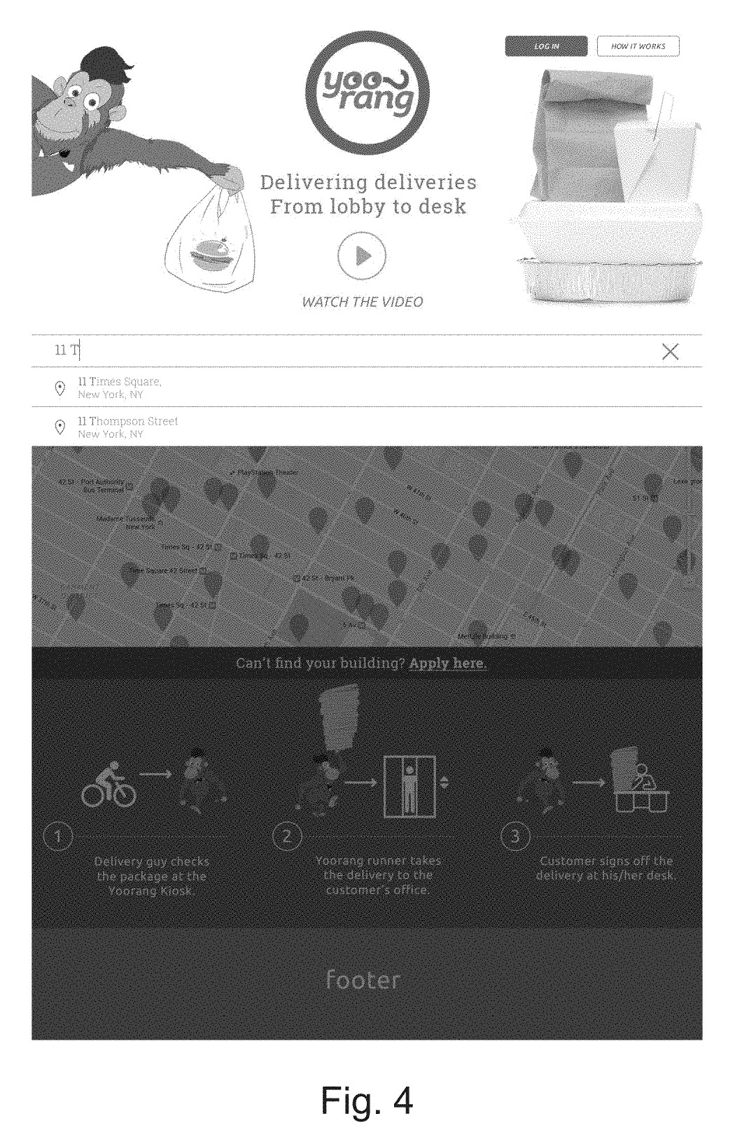

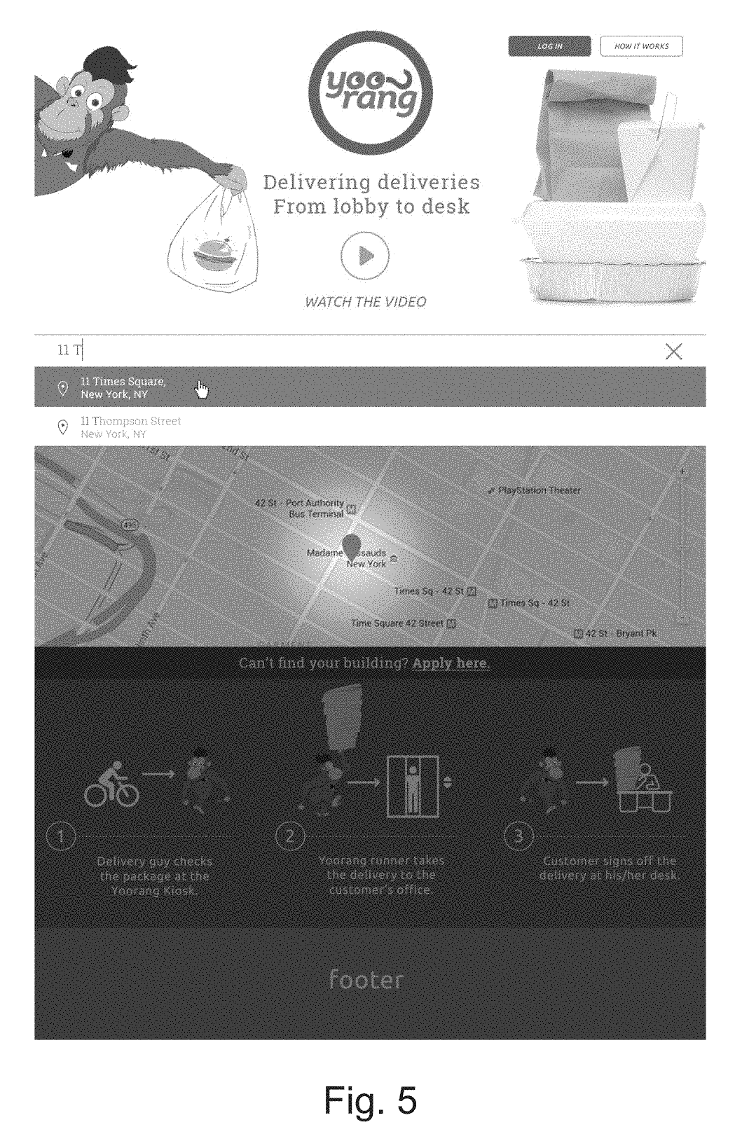

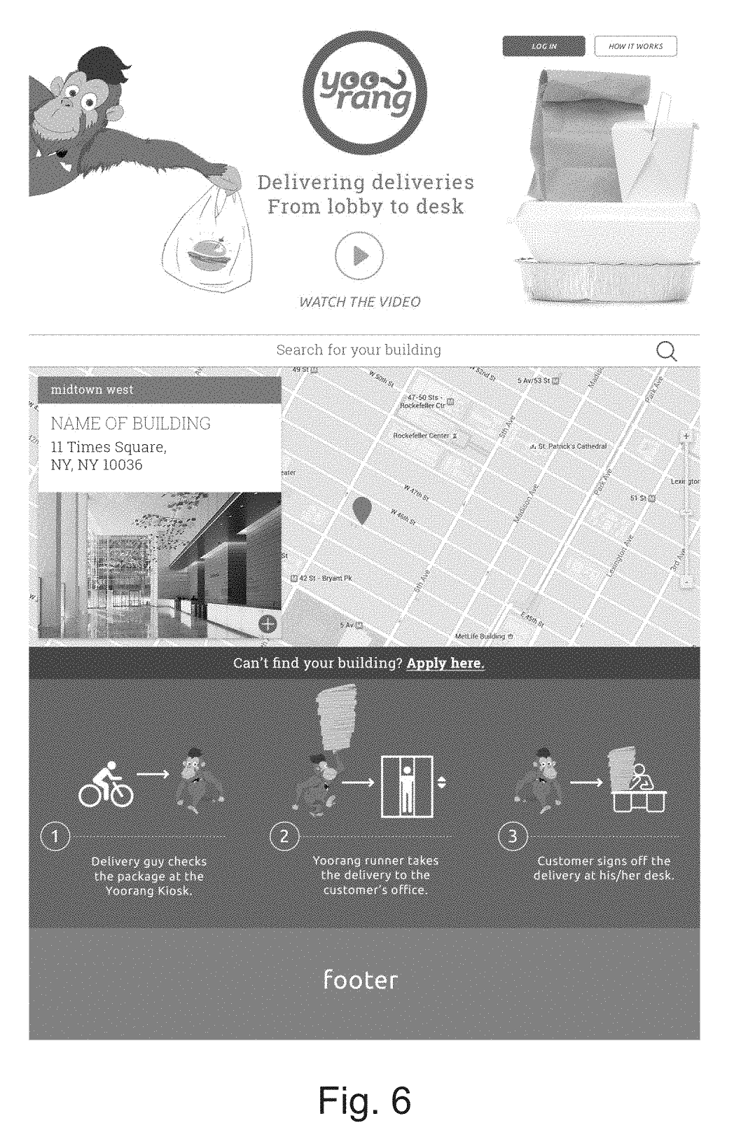

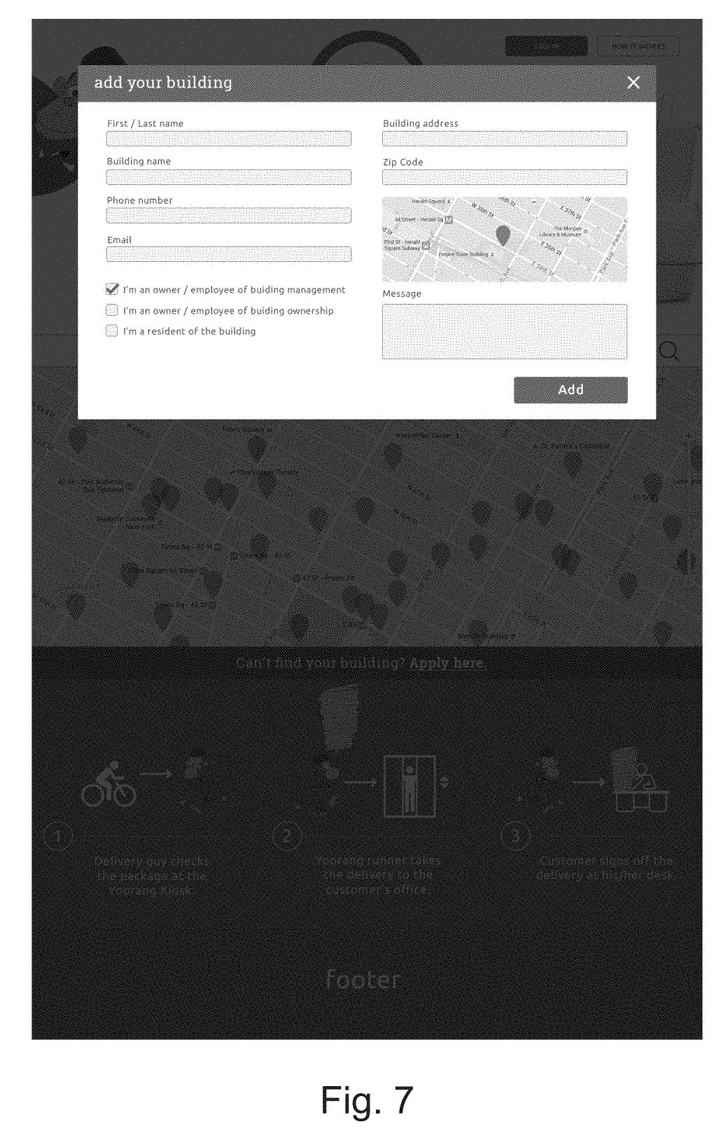

2. A user registers for the delivery system linking their profile to an enabled building in which they reside or work. This is shown in FIGS. 2-7. FIG. 2 shows a desktop homepage of the delivery system for a user showing an instructional video on how the delivery system works. FIG. 3 shows a desktop homepage of the delivery system inviting a user to search for a system-enabled building. FIG. 4 shows a desktop homepage of the delivery system with an autocomplete feature where the user is typing in an address of a desired building. FIG. 5 shows a desktop homepage of the delivery system with a autocomplete hovering feature when a user is locating a building. FIG. 6 shows a desktop homepage of the delivery system for a user showing information about a building registered within the delivery system. FIG. 7 shows a desktop homepage of the delivery system showing a screen allowing a user to request adding a new building to be registered within the delivery system.

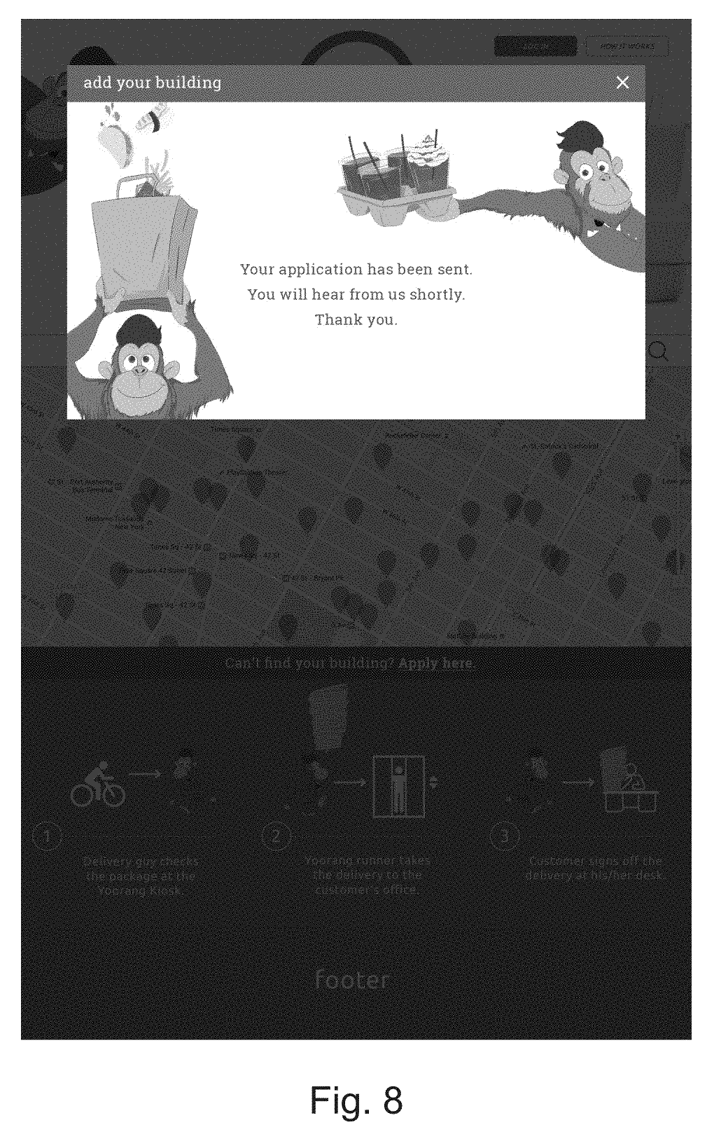

3. A user may also ask the delivery system be expanded to include a building of interest. This is demonstrated in FIG. 8, which shows a desktop homepage of the delivery system showing a screen confirming that the user has requested adding a new building to be registered within the delivery system.

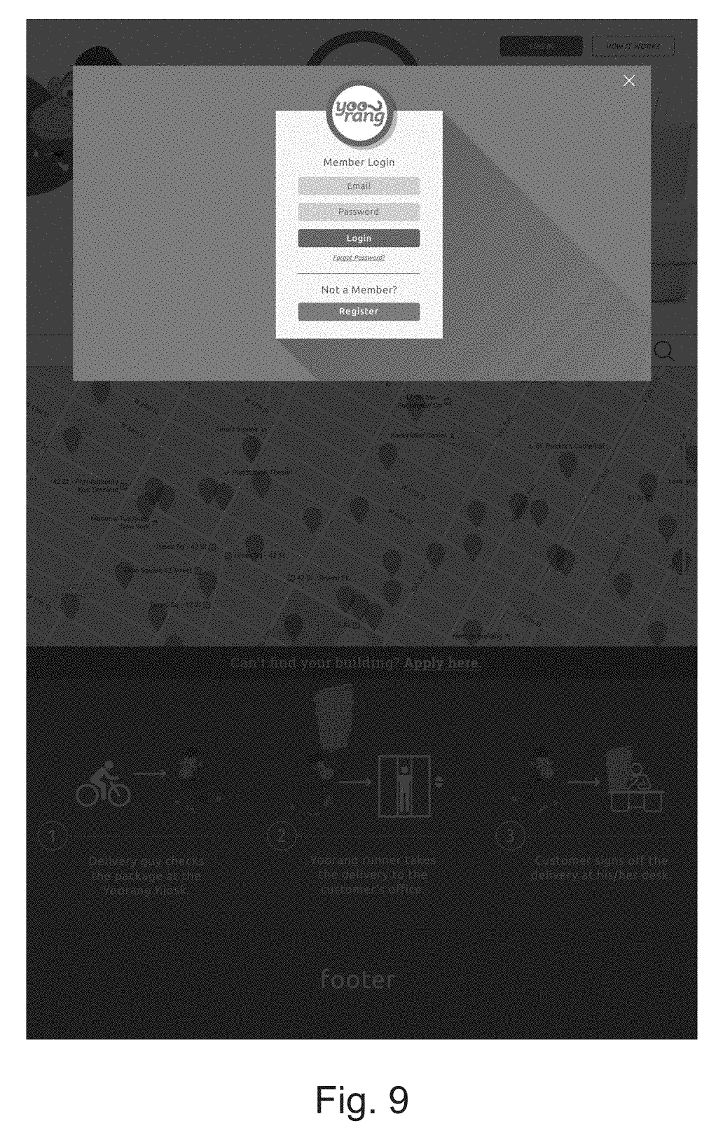

4. Once a user's building is identified to the delivery system, a user may register his or her personal details in the delivery system. This is illustrated in FIGS. 9-21.

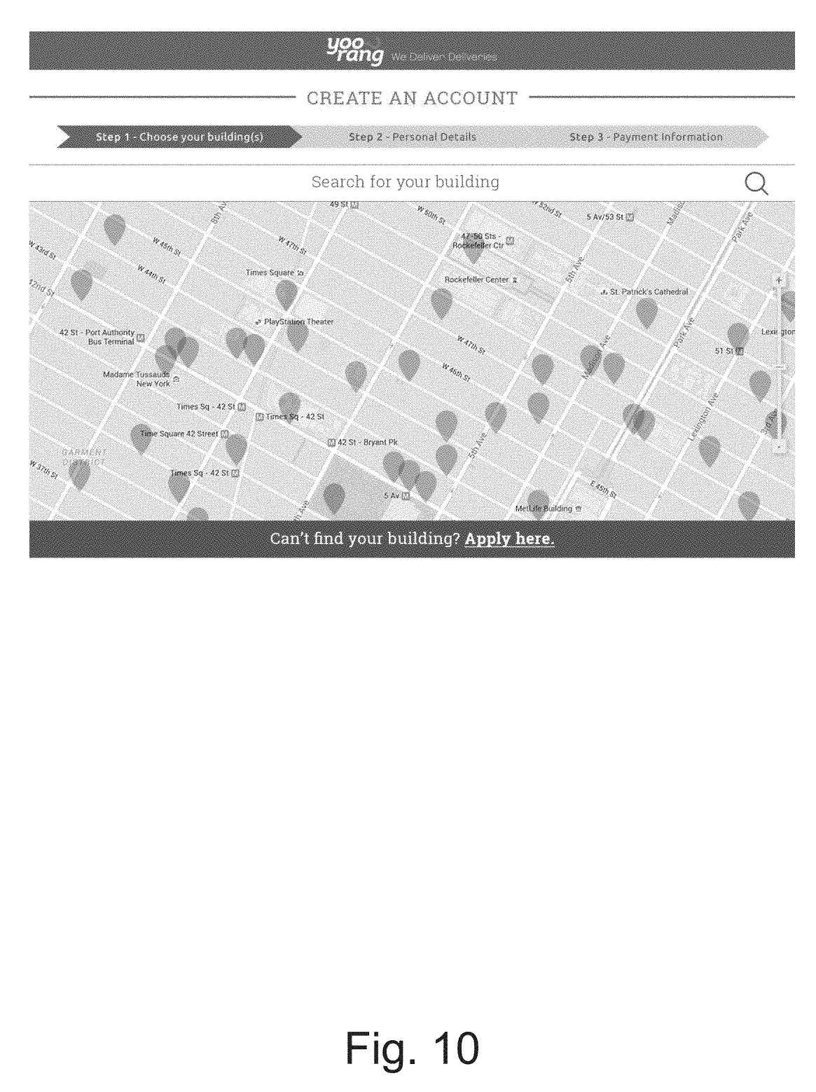

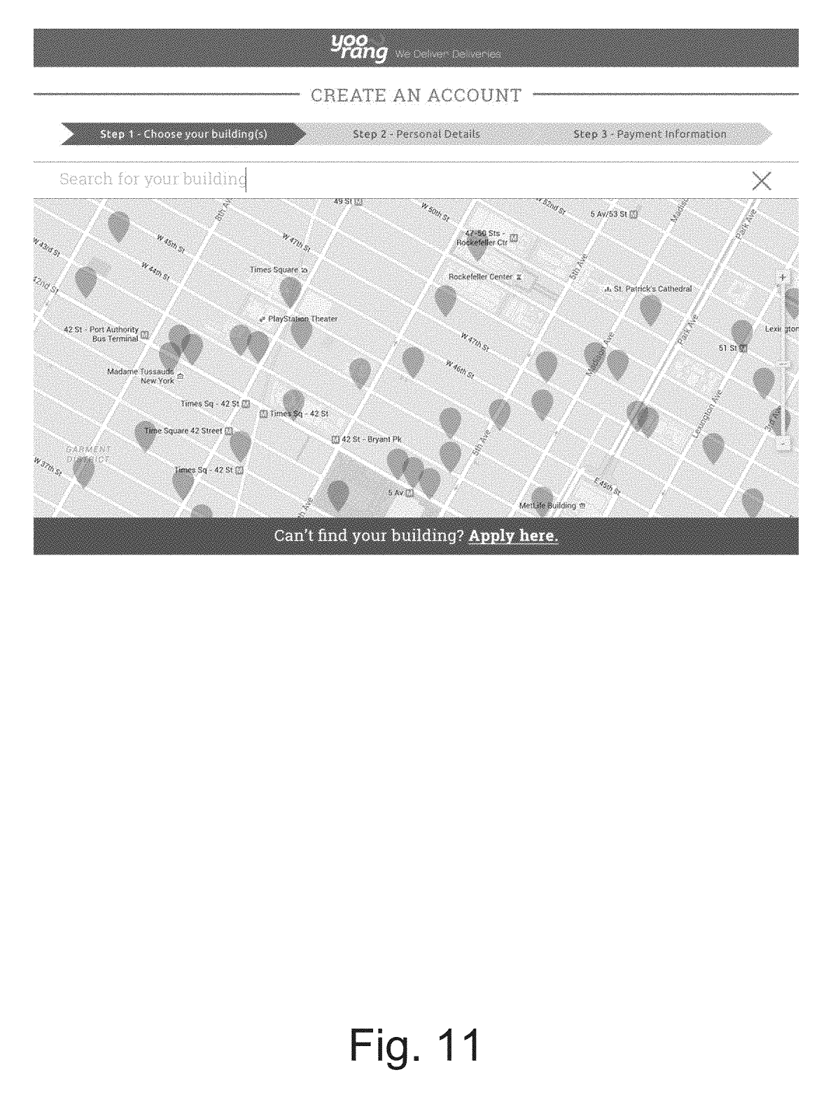

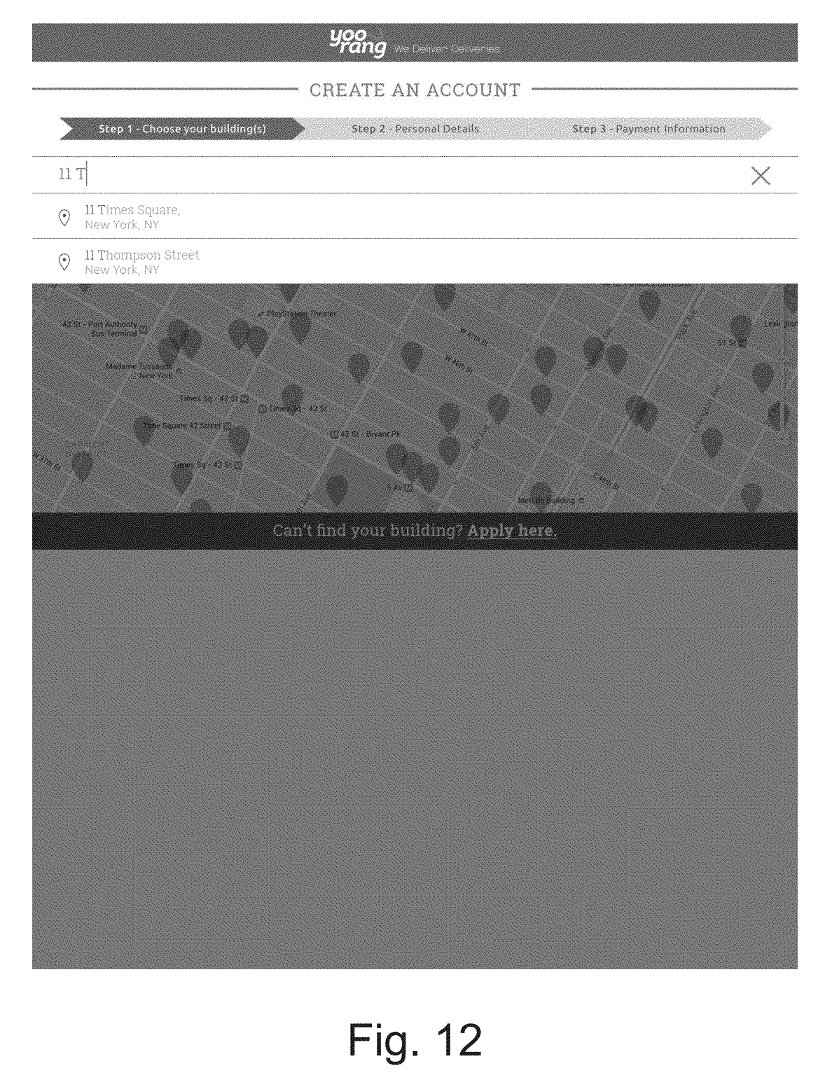

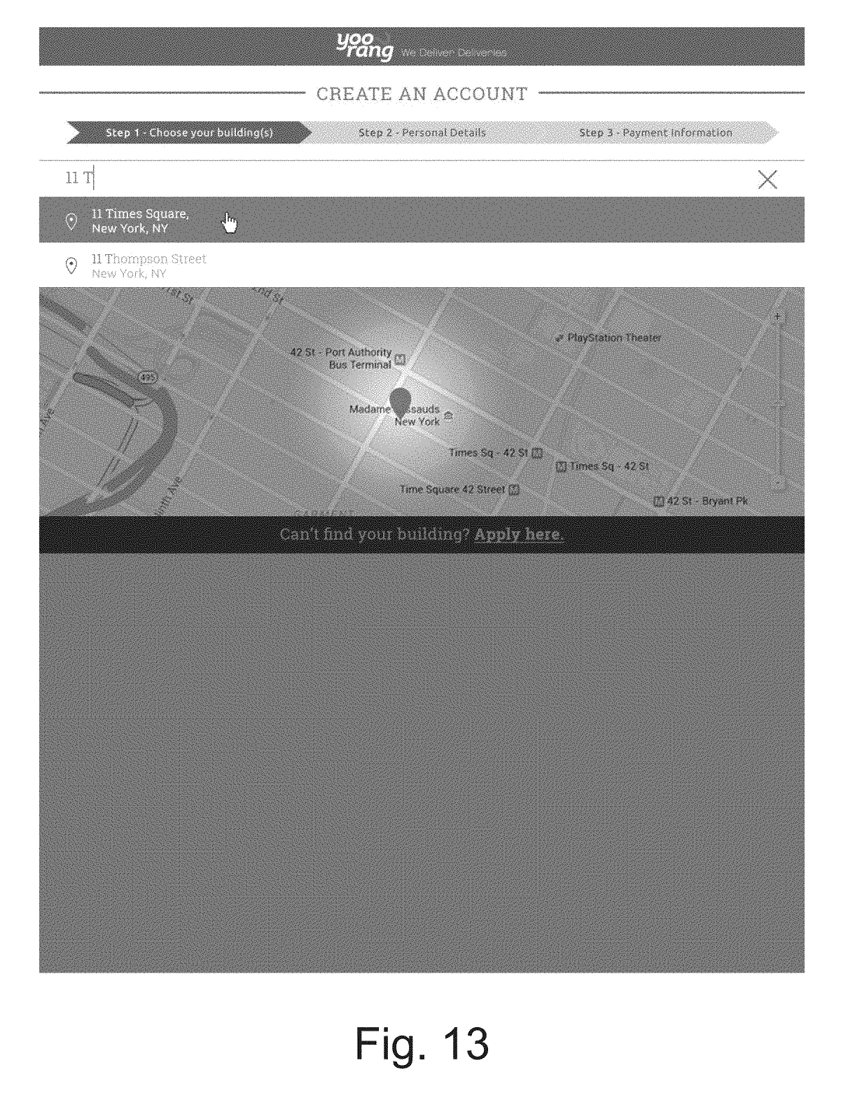

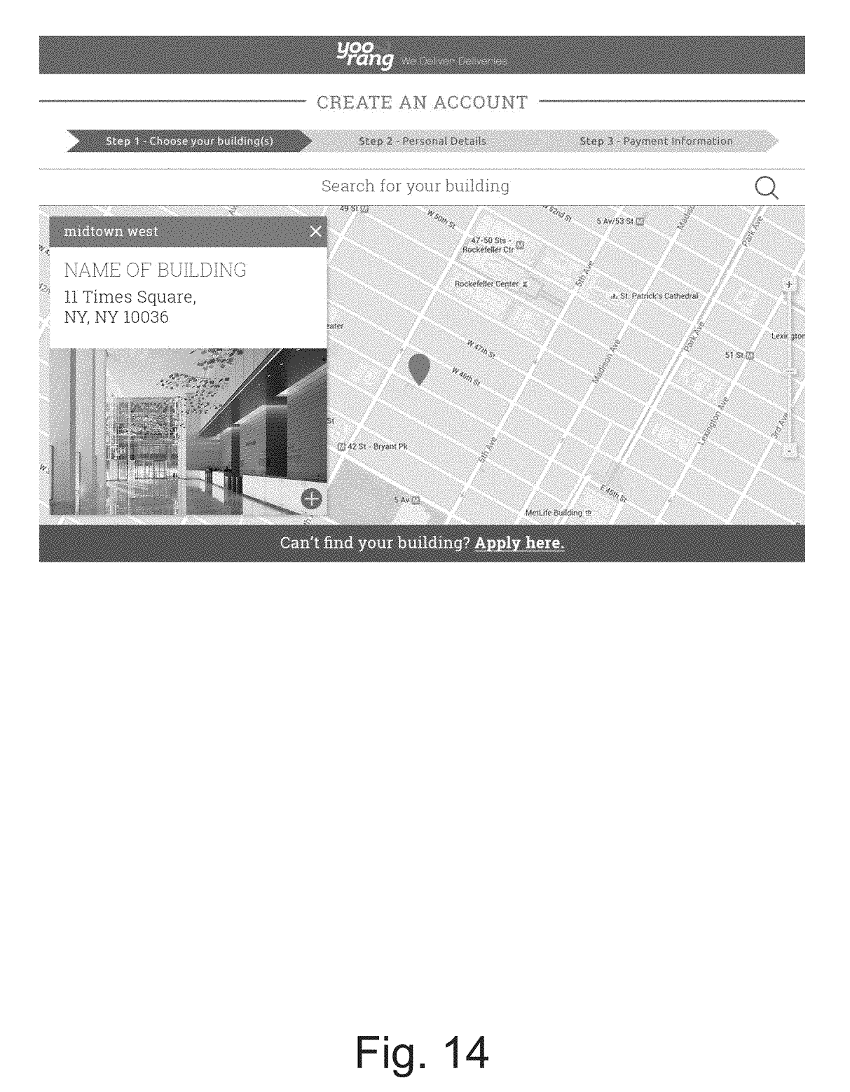

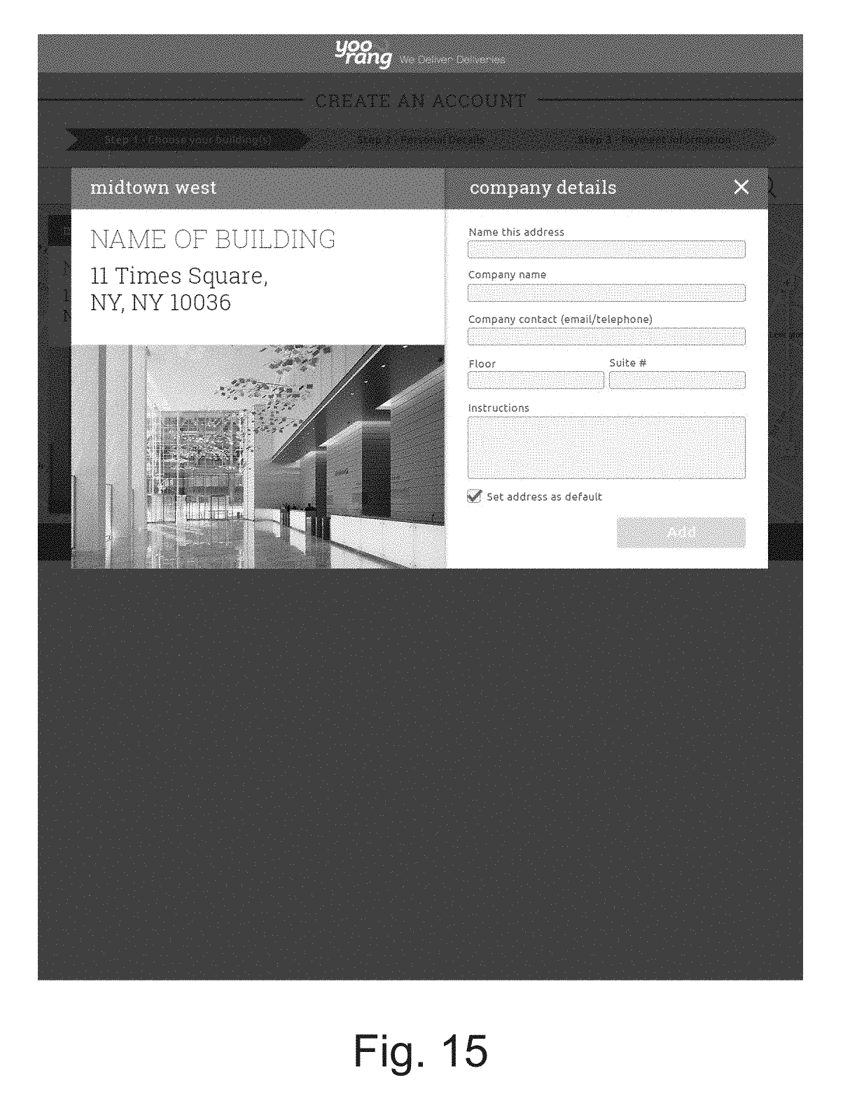

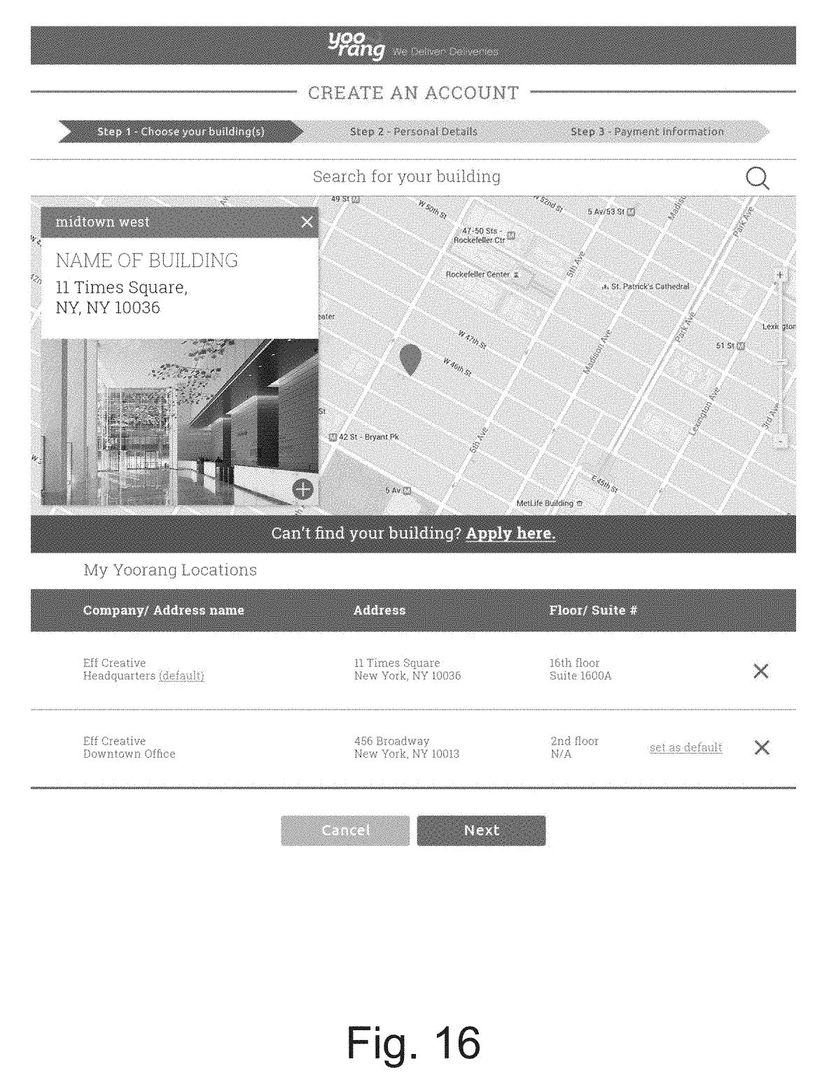

The user first identifies the building for which he or she wants to be associated in the delivery system. FIG. 9 shows a desktop homepage login screen for users of the delivery system. FIG. 10 shows a registration page for a new user of the delivery system. FIG. 11 shows a registration page for a new user of the delivery system where the user searches for his or her building. FIG. 12 shows a registration page for a new user of the delivery system with an autocomplete feature to assist a user in locating a building. FIG. 13 shows a registration page with a autocomplete hovering feature to assist a user in locating a building. FIG. 14 shows a registration page where a user registers a building to be used with the delivery system. FIG. 15 shows a registration page where the user enters information for registration with the delivery system for the chosen building. FIG. 16 shows a registration page where the user is shown those buildings for which he or she is registered for the delivery system.

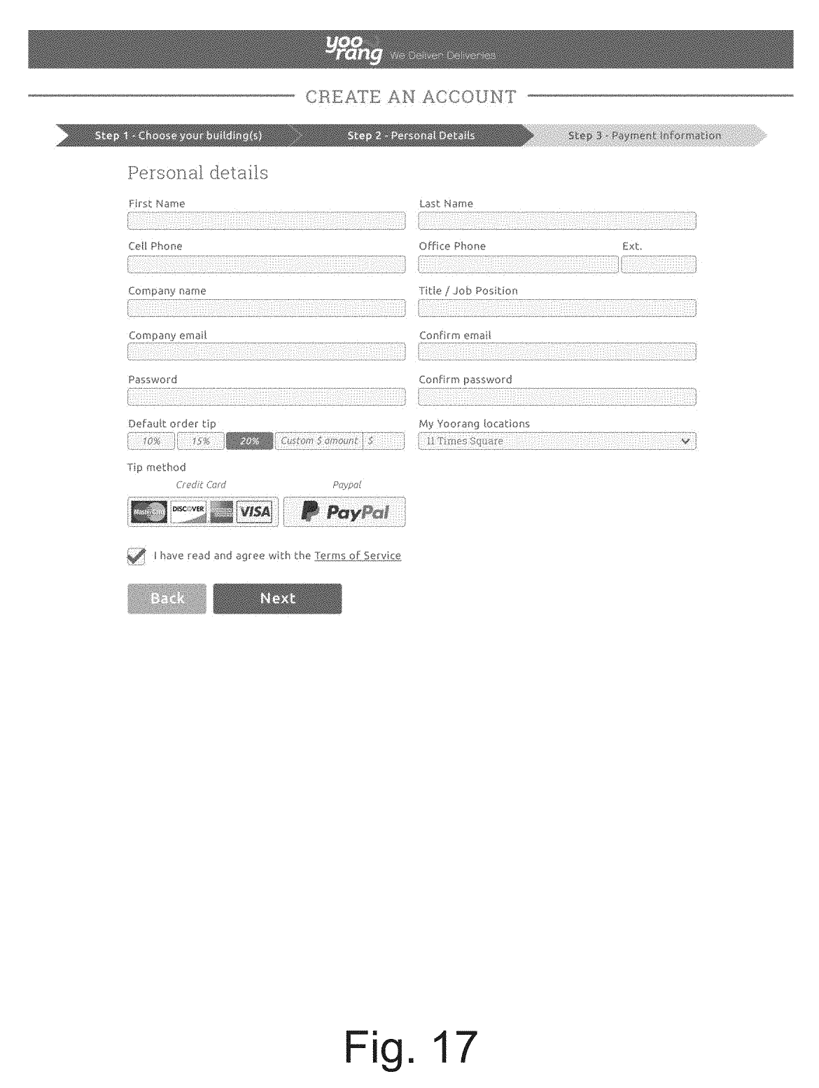

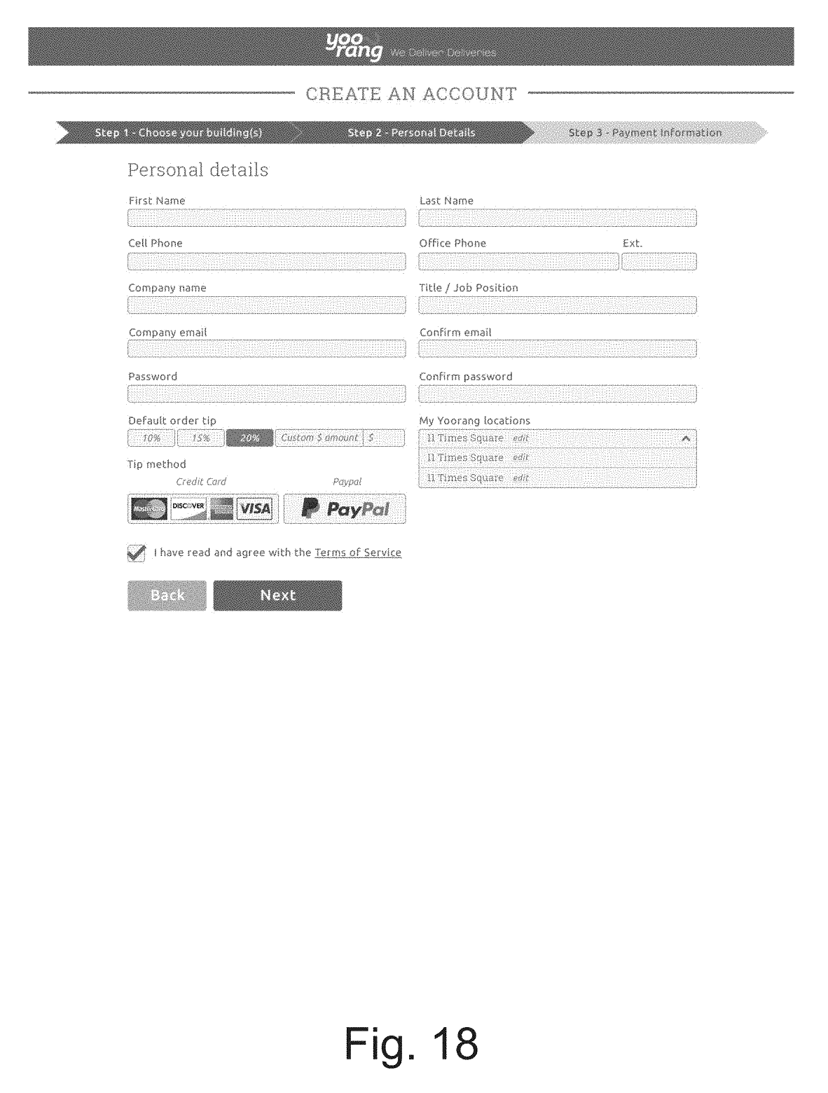

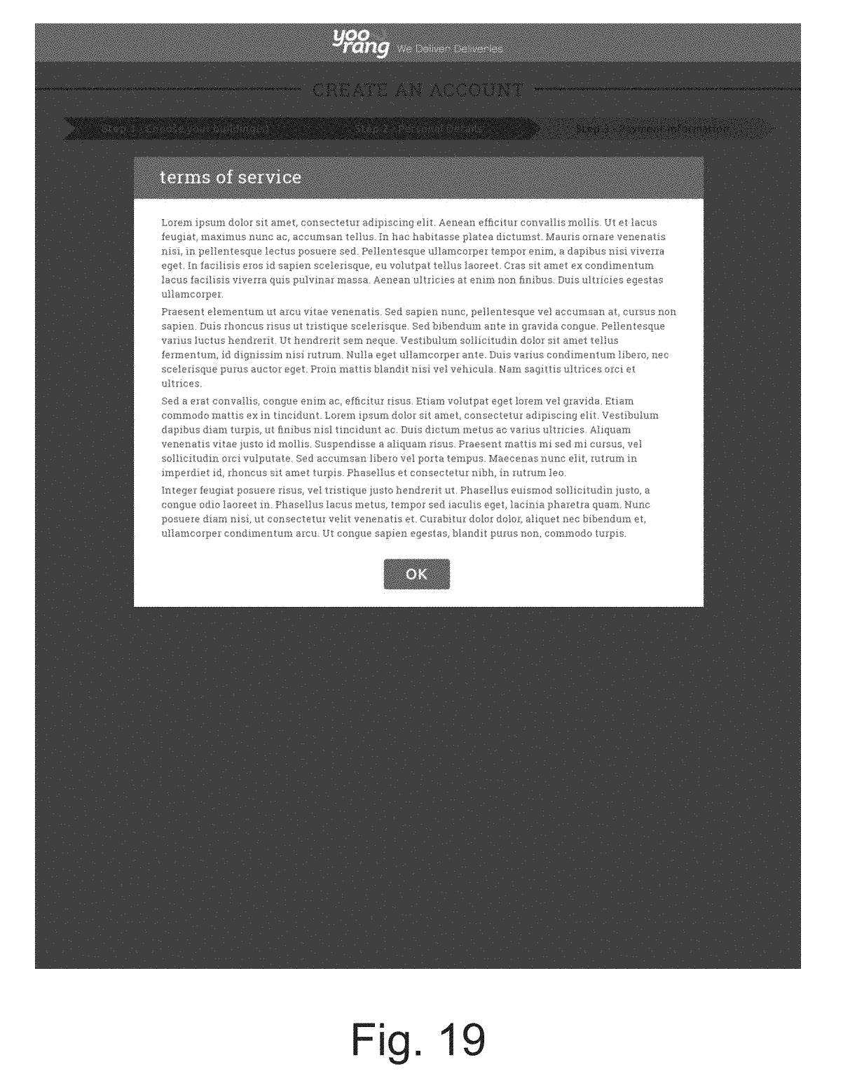

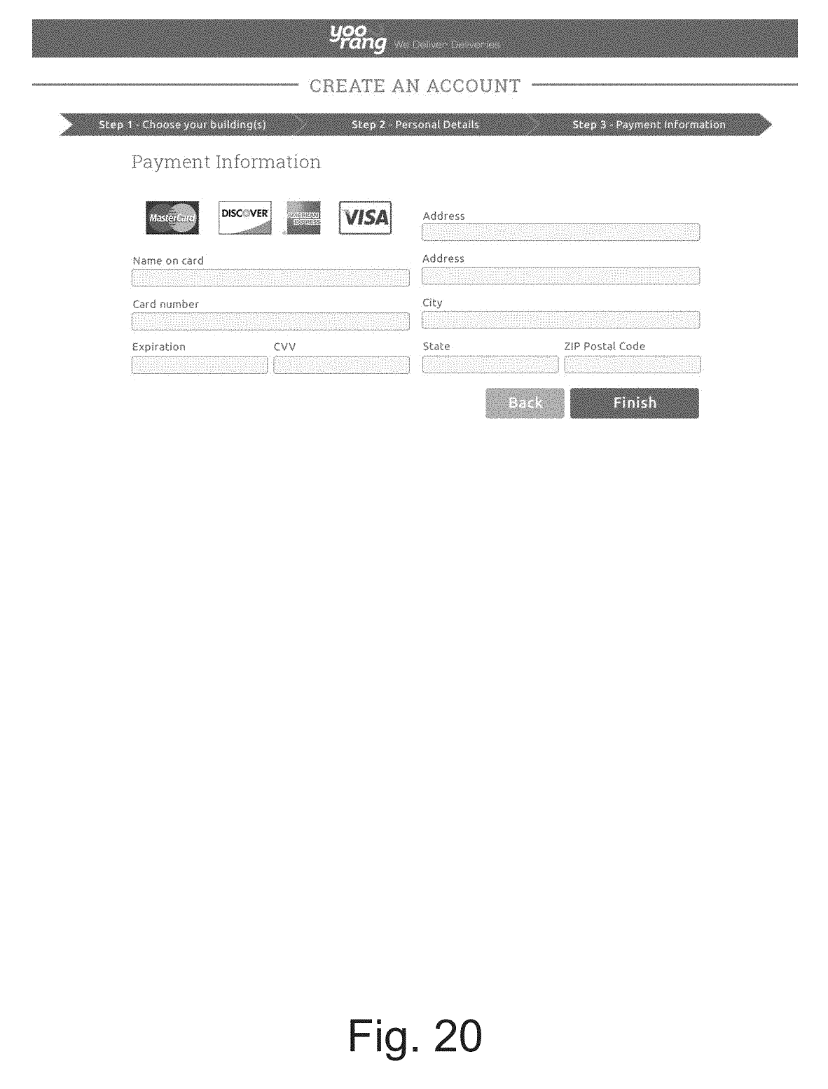

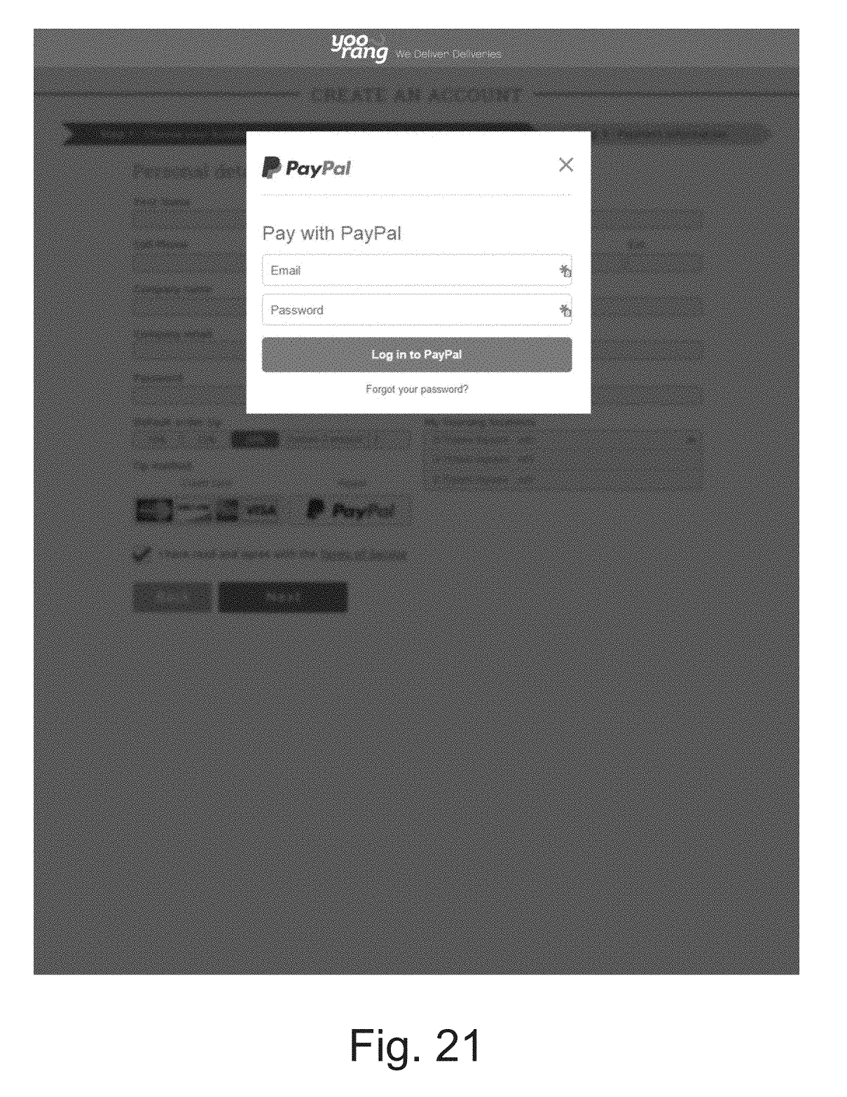

The user next provides his or her personal contact and payment information to the delivery system for each or all buildings for which he or she is associated. FIG. 17 shows a registration page where the user enters personal details for the delivery system. FIG. 18 shows a registration page with a drop-down menu for eligible buildings where the user enters personal details for the delivery system. FIG. 19 shows a page where the user accepts the terms of service for the delivery system. FIG. 20 shows a payment information registration system for a user of the delivery system. FIG. 21 shows a Paypal screen for payment information when registering a user of the delivery system.

B. Operation

Once a building is registered with the delivery system and a user's information is entered in the delivery system, a user is ready to place an order for goods or services.

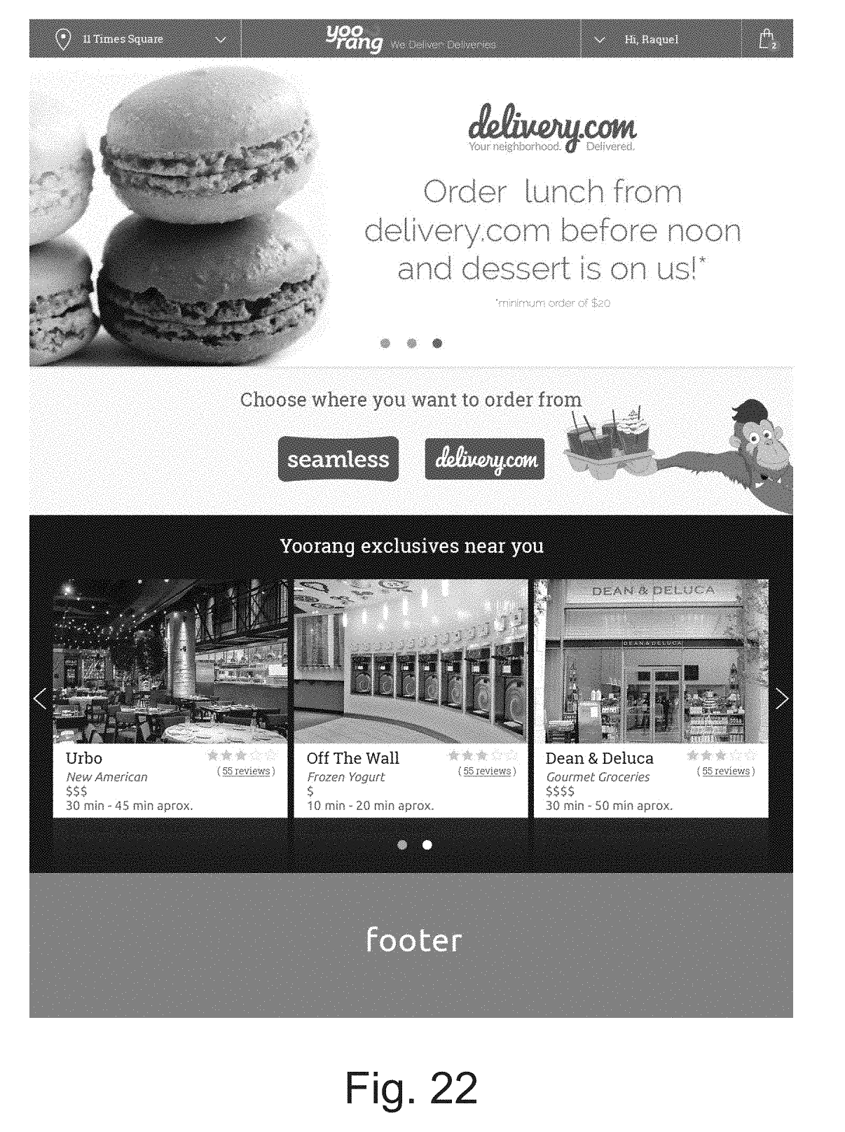

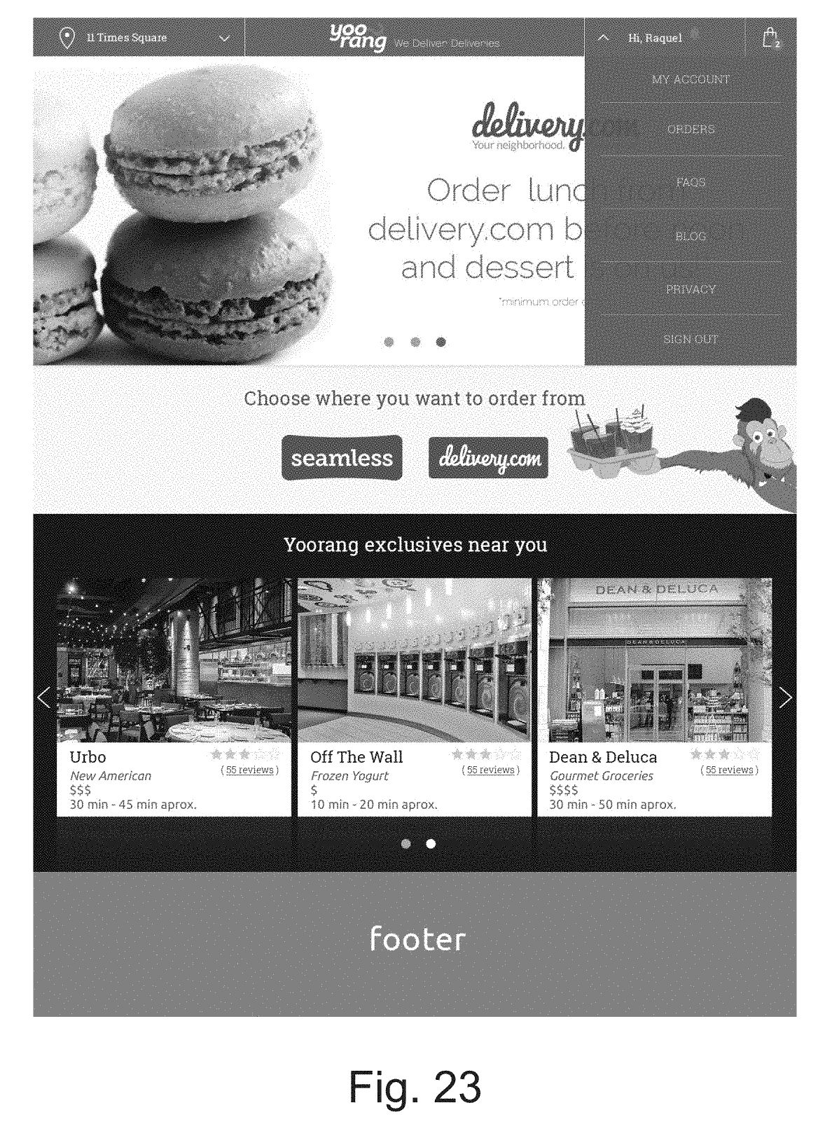

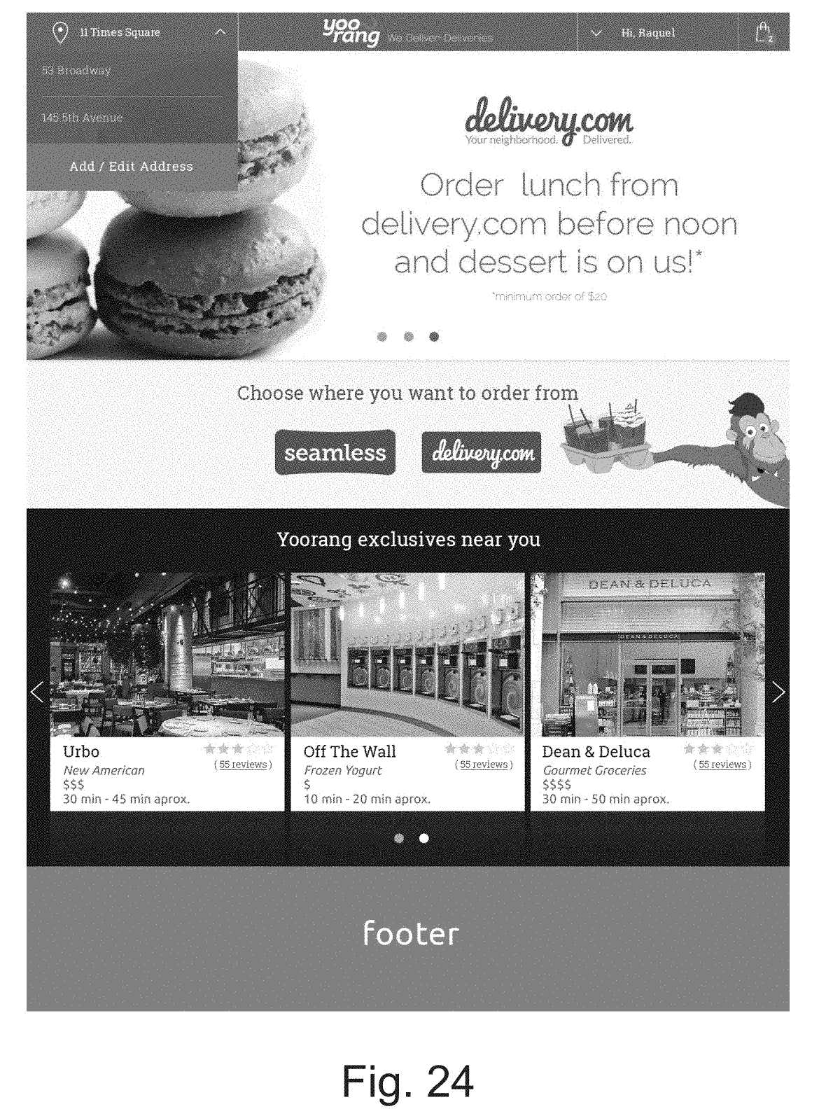

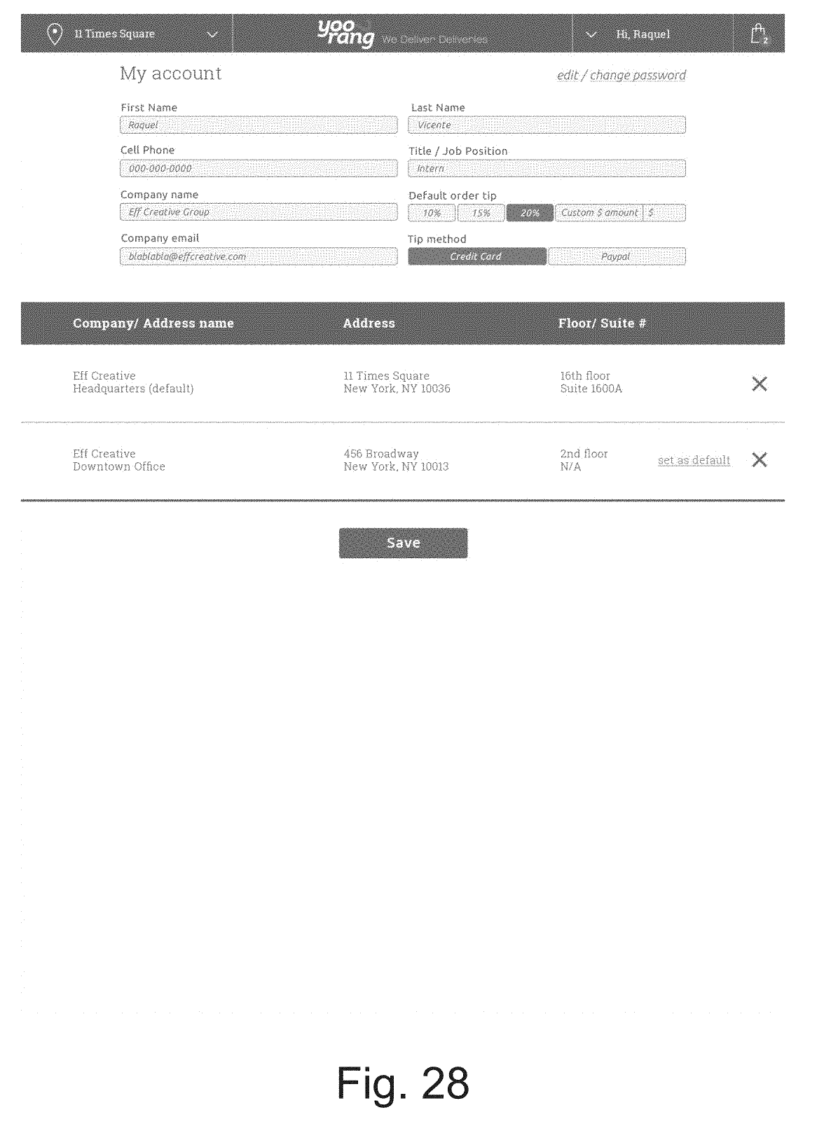

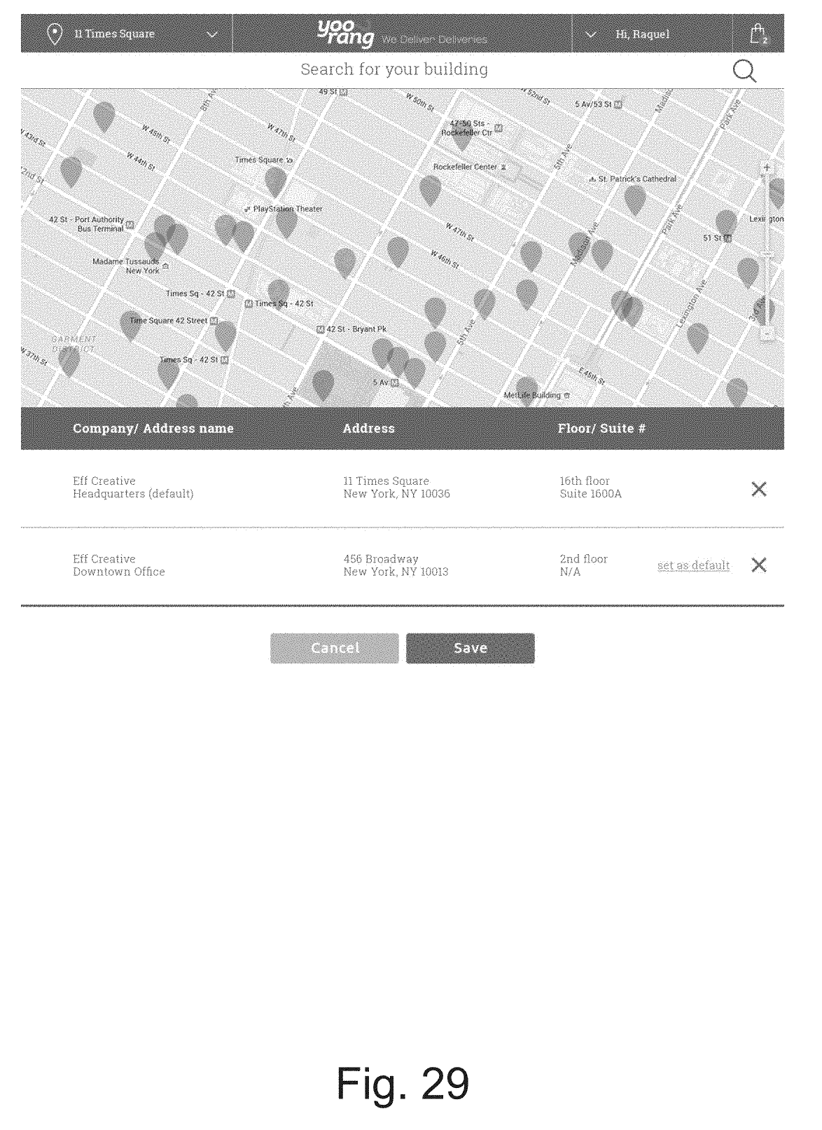

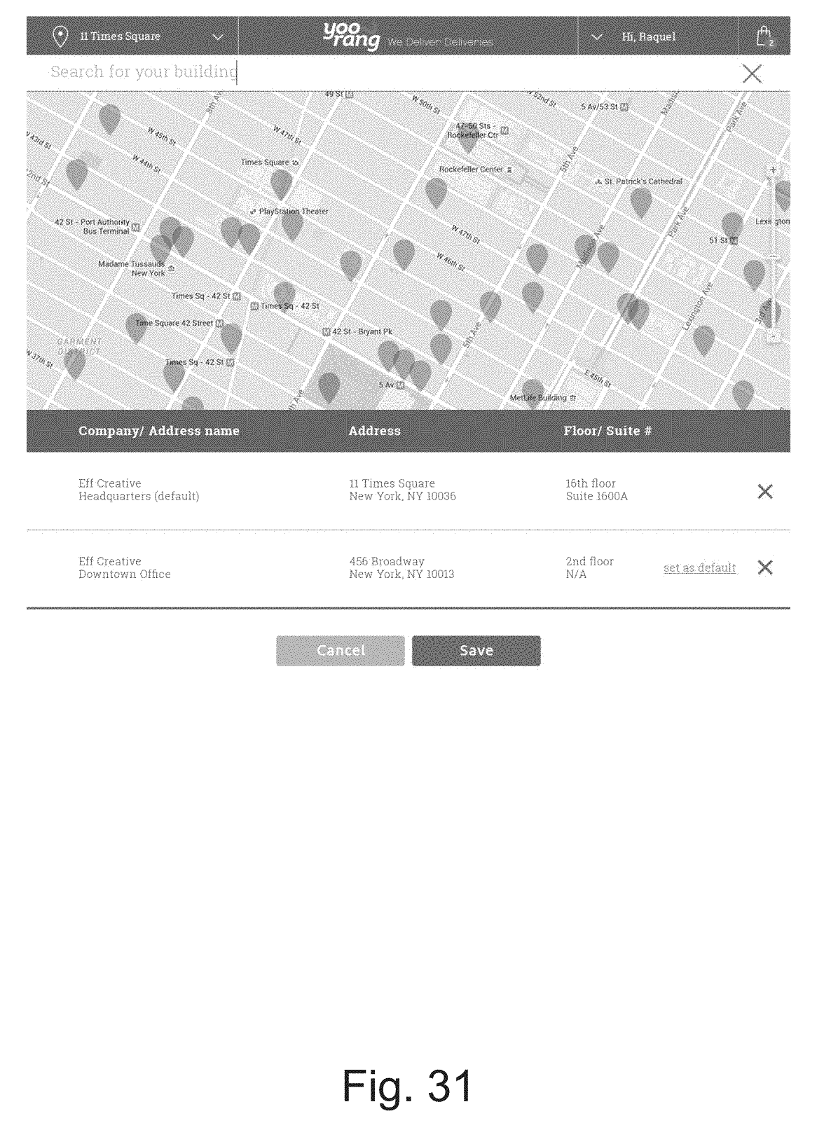

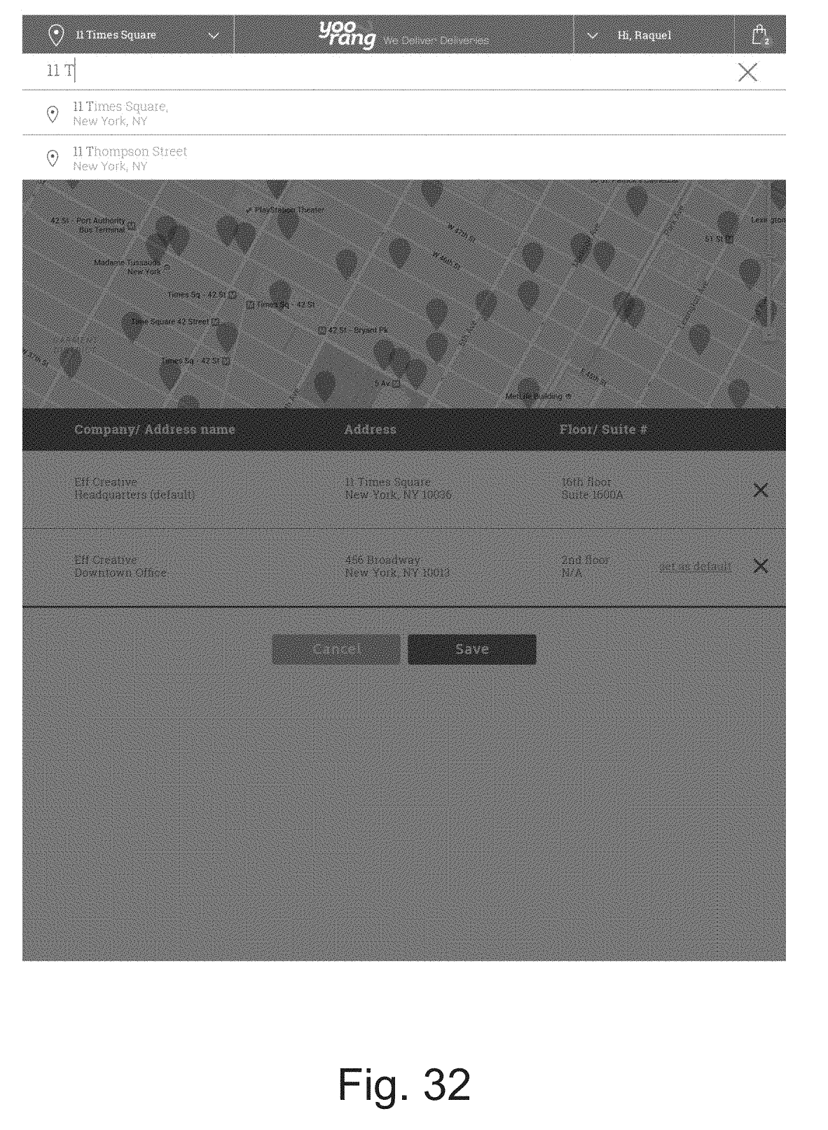

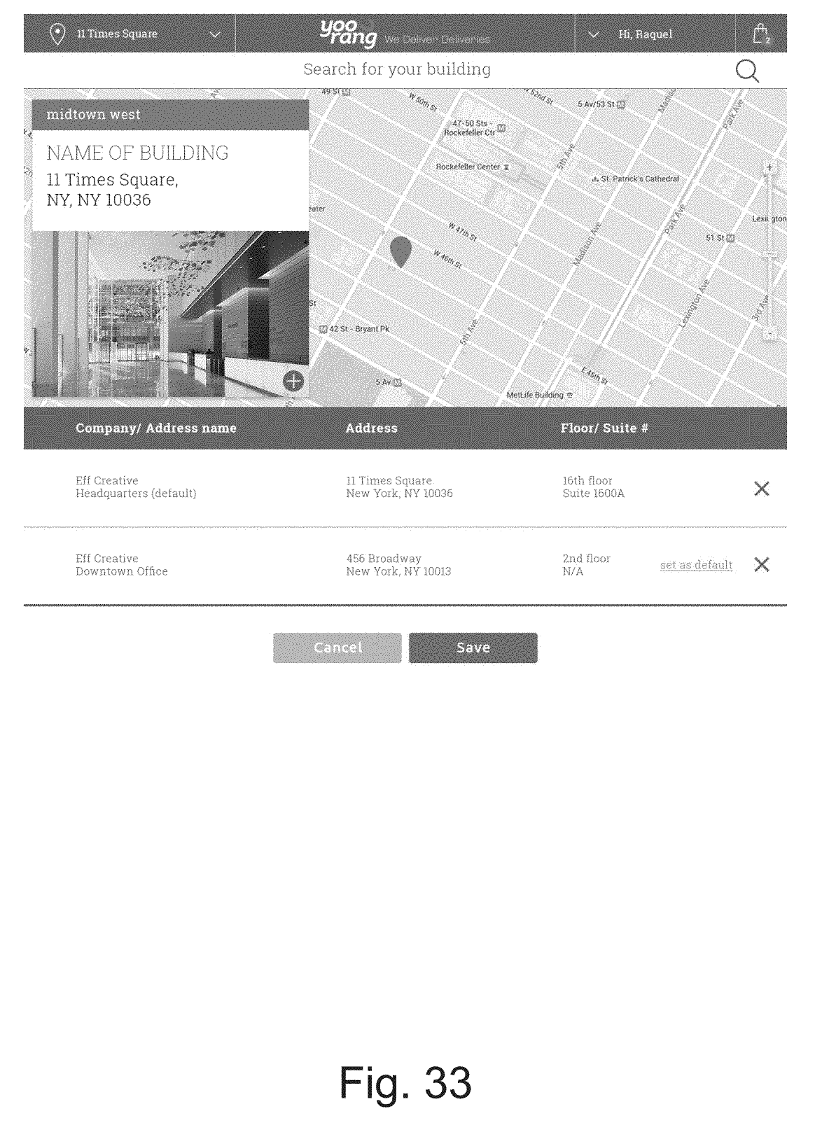

Before proceeding with an order, the user logs in from a particular building for which he or she is associated. This is illustrated in FIGS. 22-24, 28-29 and 31-33. FIG. 22 shows a desktop homepage for a registered user of the delivery system. FIG. 23 shows a desktop homepage for a registered user of the delivery system with the menu displayed. FIG. 24 shows a desktop homepage for a registered user of the delivery system with the eligible buildings displayed. FIG. 28 shows an account information page for a registered user of the delivery system. FIG. 29 shows a building editing page for a registered user of the delivery system. FIG. 31 shows a building search page for a registered user of the delivery system. FIG. 32 shows an autocomplete feature in a building search page for a registered user of the delivery system, FIG. 33 shows a building selection page for a registered user of the delivery system.

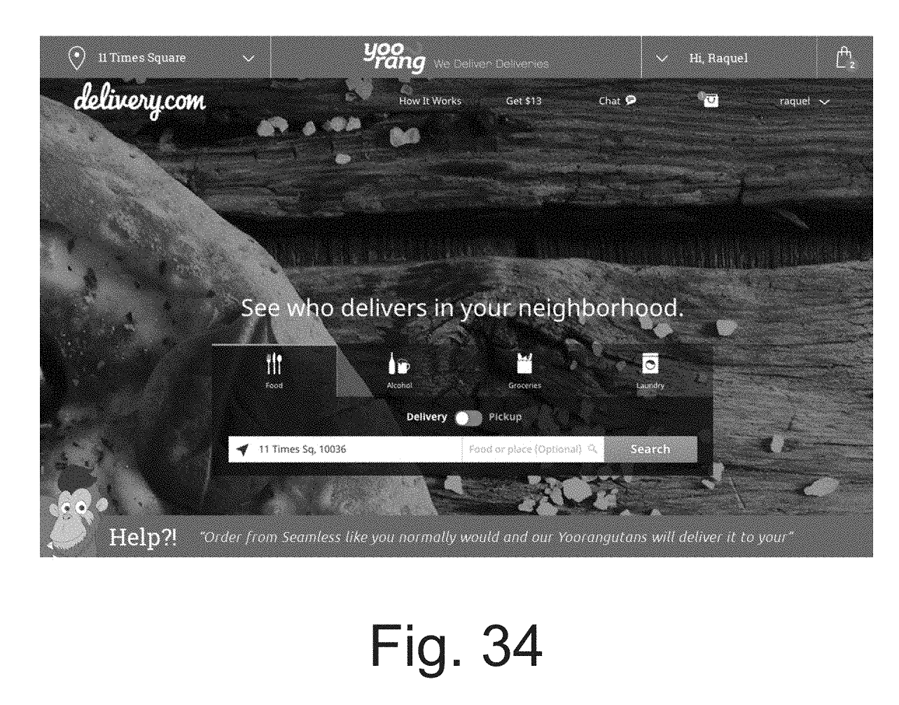

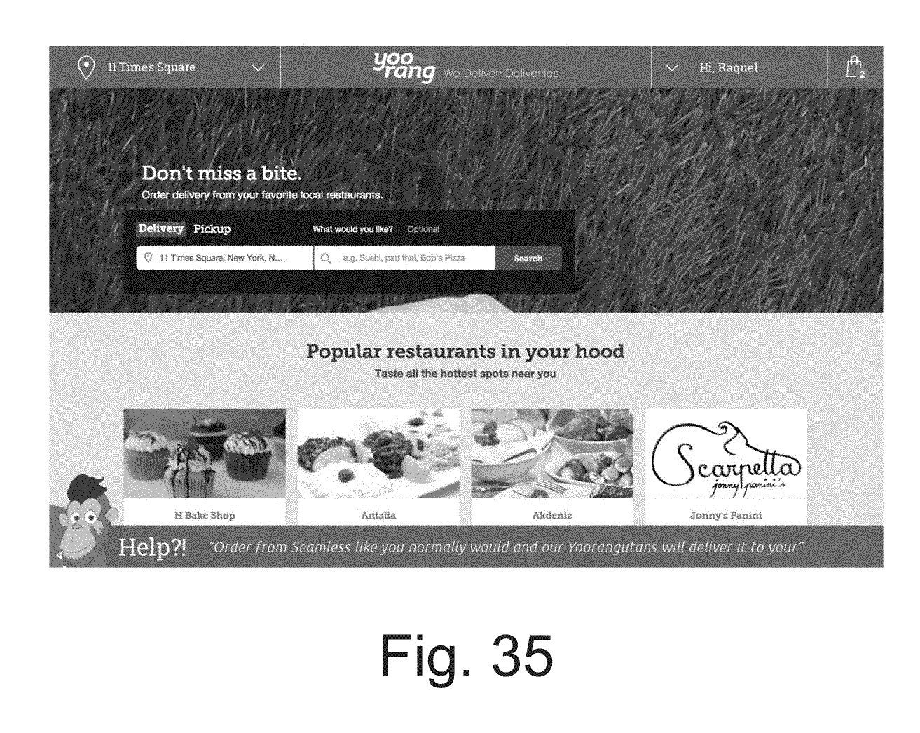

A. An existing external order service/website such as delivery.com or seamless.com may be placed within a system-owned iframe/nested browser contained within the delivery system website. This is illustrated in FIGS. 34-35. FIG. 34 shows a delivery.com homepage framed by the delivery system. FIG. 35 shows a seamless.com homepage framed by the delivery system. The delivery system may collect an affiliate fee for orders that are referred to external order service/website through external order service/website API.

The external order service/website is loaded in branded iframe after authenticating user with service's API. Location within the iframe changes are tracked so when user finishes order process, the site knows to use the API to retrieve the order details.

The user must authenticate with the external service/website's API so that:

1. Orders that are driven through the delivery system to the external order service/website are counted towards affiliate program of external service/website.

2. Order information and updates are automatically imported into the delivery system.

3. If an external order service/website revokes access to their API, a headless browser such as phantomjs will emulate user login and clicks in order to scrape the final order information manually at the end of the order process.

4. At end of order process, the user describes location in building the order needs to be delivered. After the delivery system order confirmation, the user is taken to a status screen where they can see the delivery status and estimated time of arrival to their offices/residence

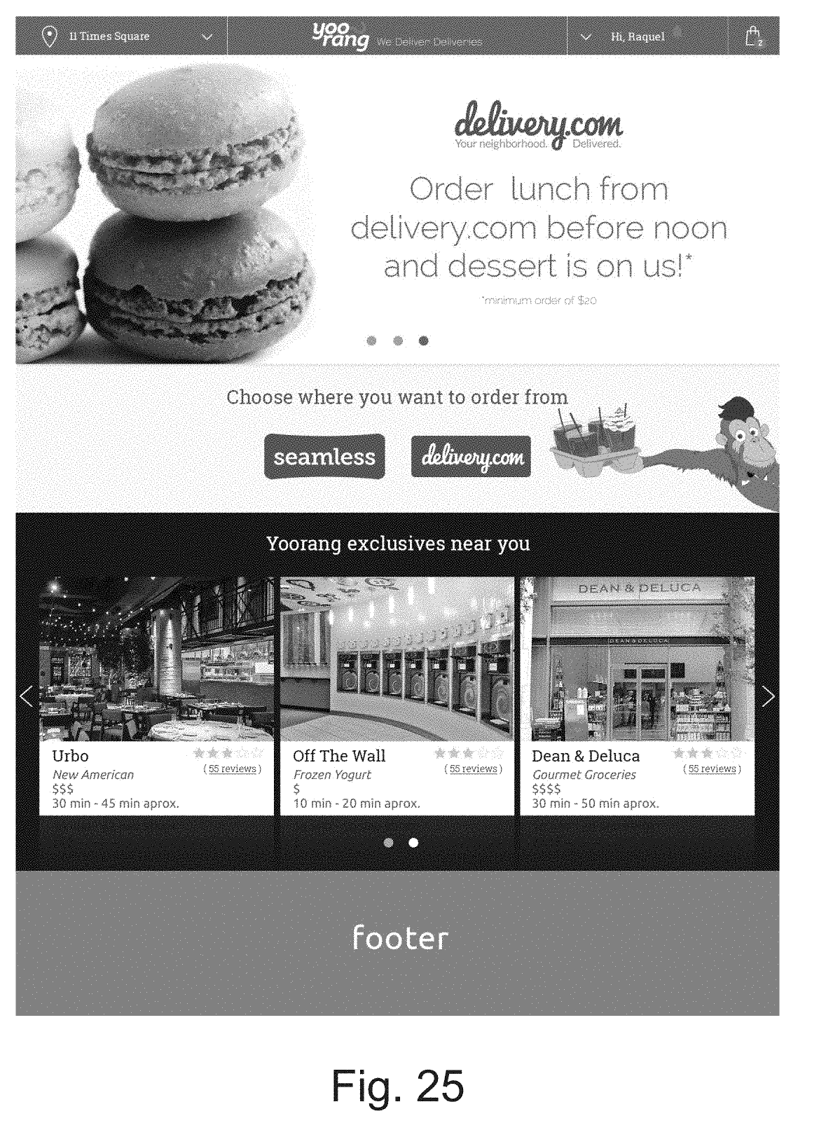

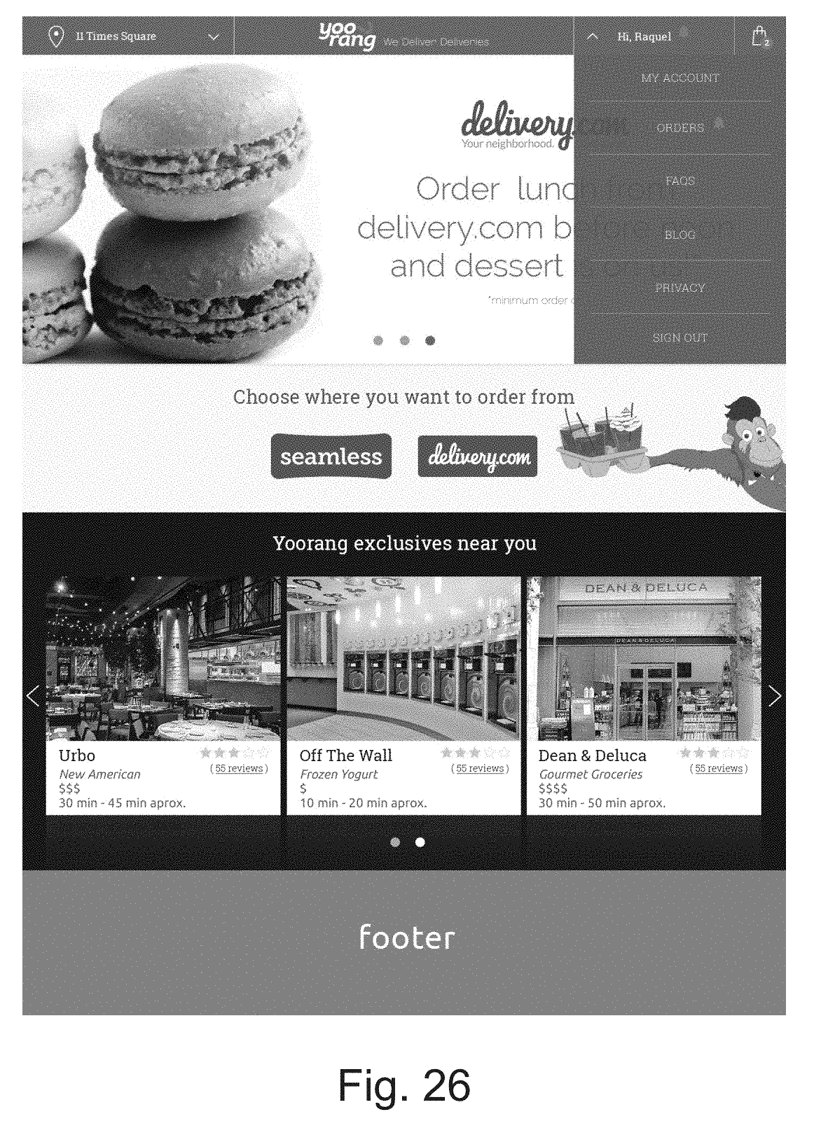

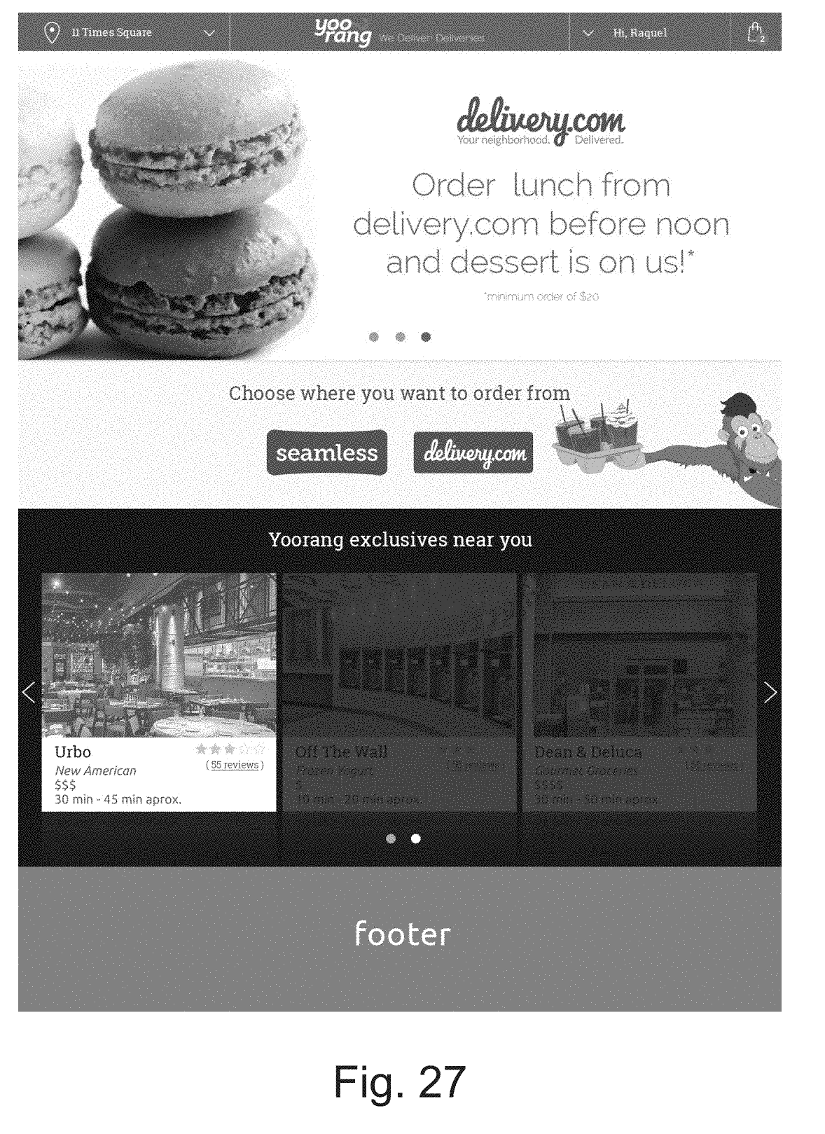

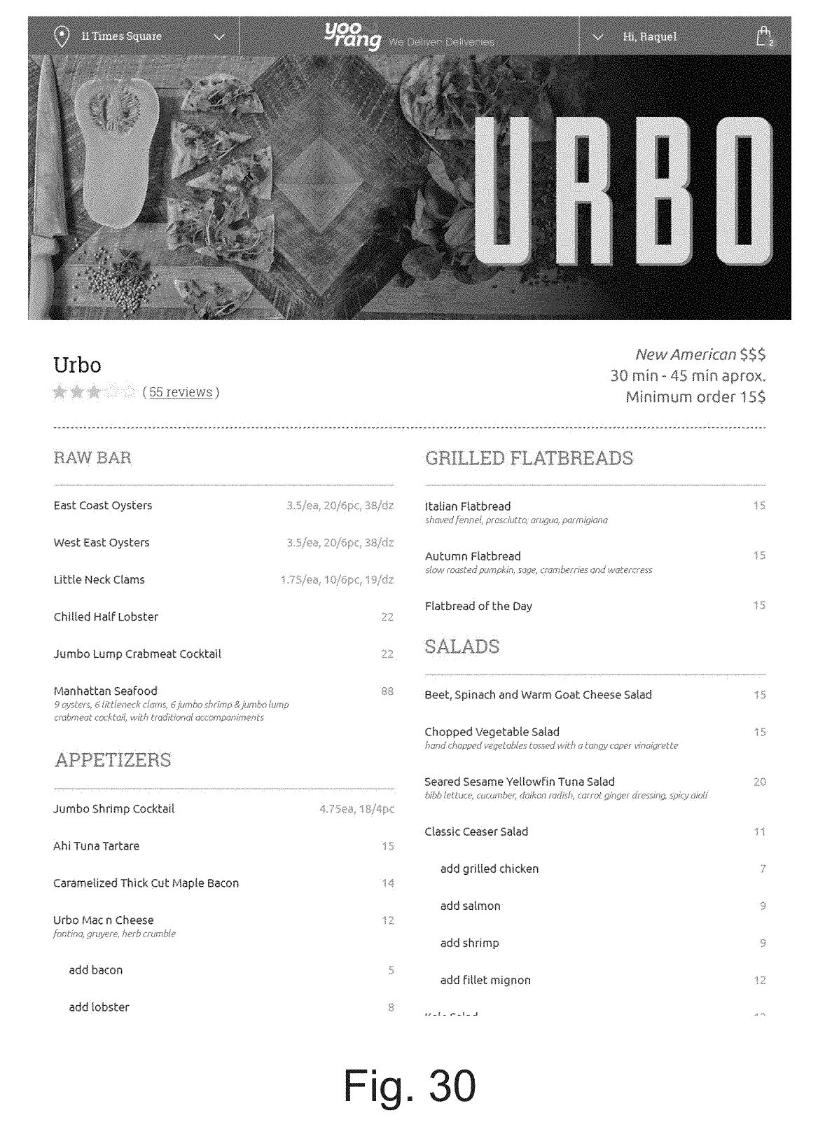

B. An “In your building” restaurant/store/cafe etc. in the immediate vicinity of the building or within the building may be used. Here, the order system is completed entirely within the delivery system. The delivery system takes a fixed percentage of the order value. Illustrations of “in your building” orders are further shown in FIGS. 25-27 and 30. FIG. 25 shows another desktop homepage for a registered user of the delivery system. FIG. 26 shows another desktop homepage for a registered user of the delivery system with the menu displayed and a reminder by the orders menu. FIG. 27 shows a desktop homepage for a registered user with an exclusive offer highlighted when hovered. FIG. 30 shows a menu that is in the building that is registered to a user of the delivery system.

C. The delivery system may include an optional “group buy” system where additional purchases within the building unlock progressive discounts incentivizing residents/employees/business leaders to purchase more products/services together.

At end of order process, the user describes the location in the building where the order needs to be delivered. After the delivery system provides an order confirmation, the user is taken to a status screen where they can see the delivery status and estimated time of arrival to their offices/residence for their orders including pick up by a system dispatch kiosk.

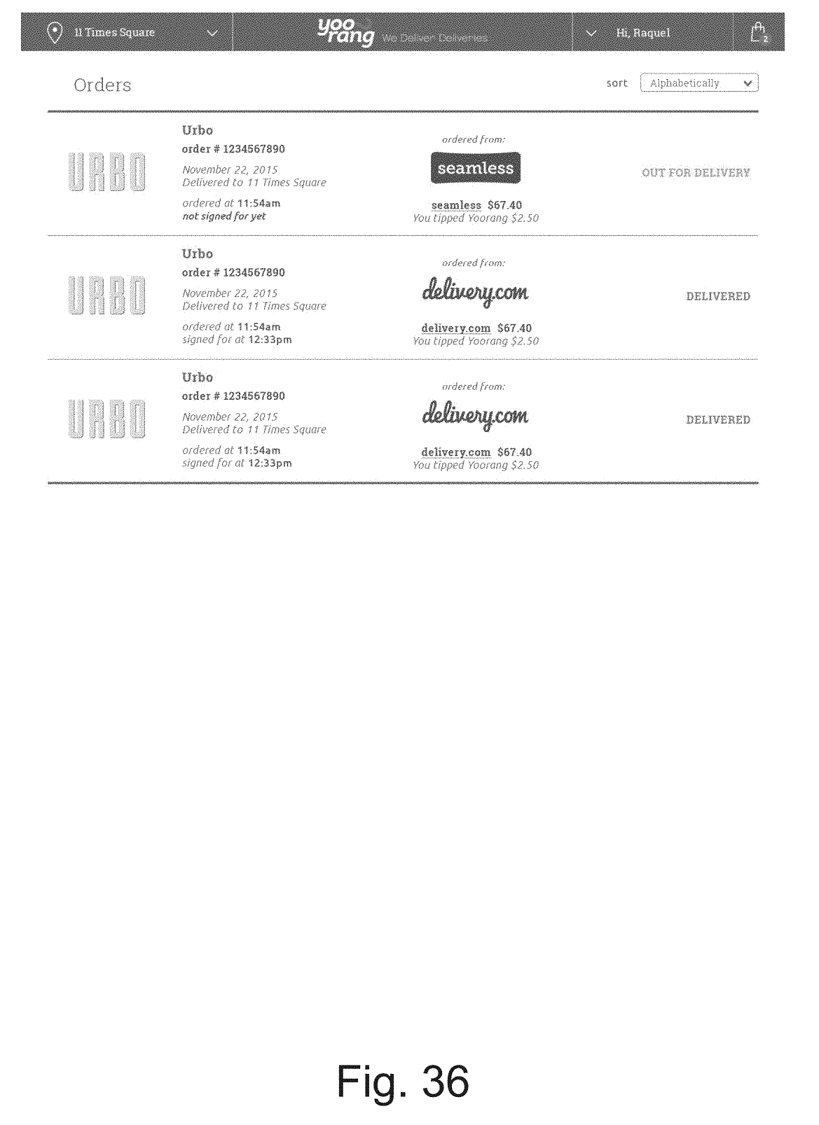

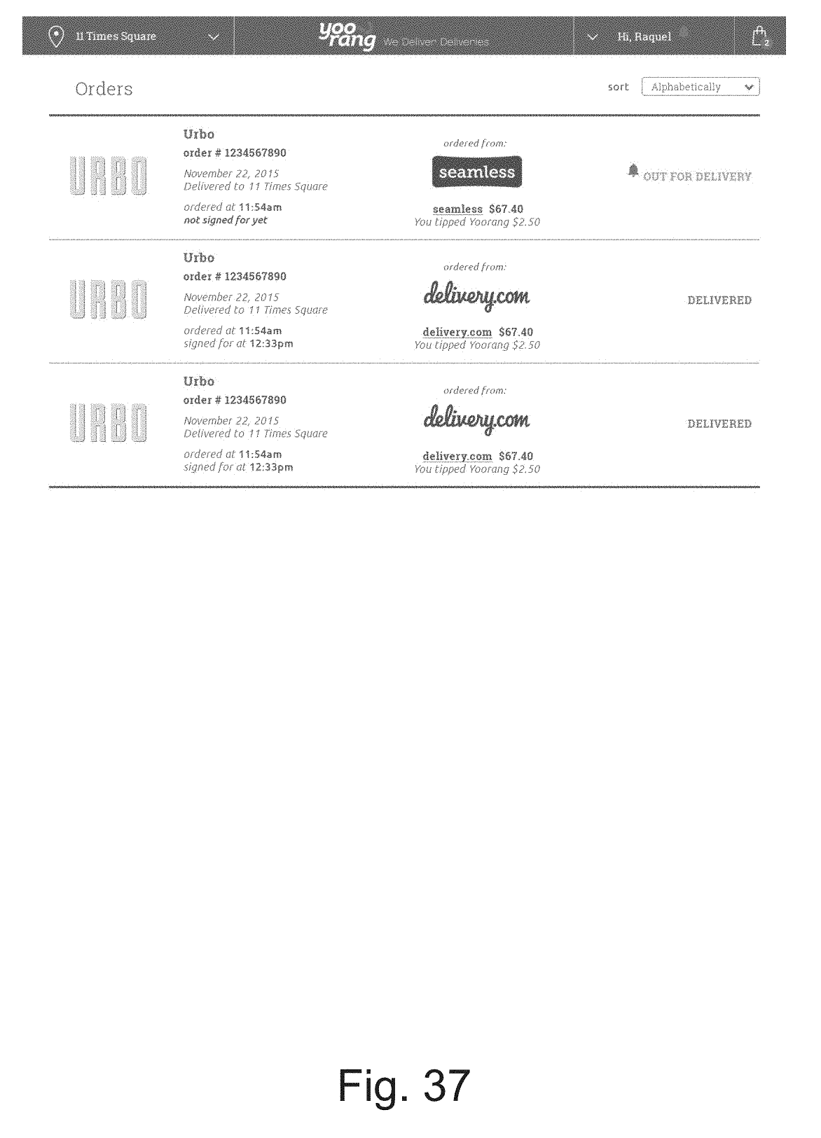

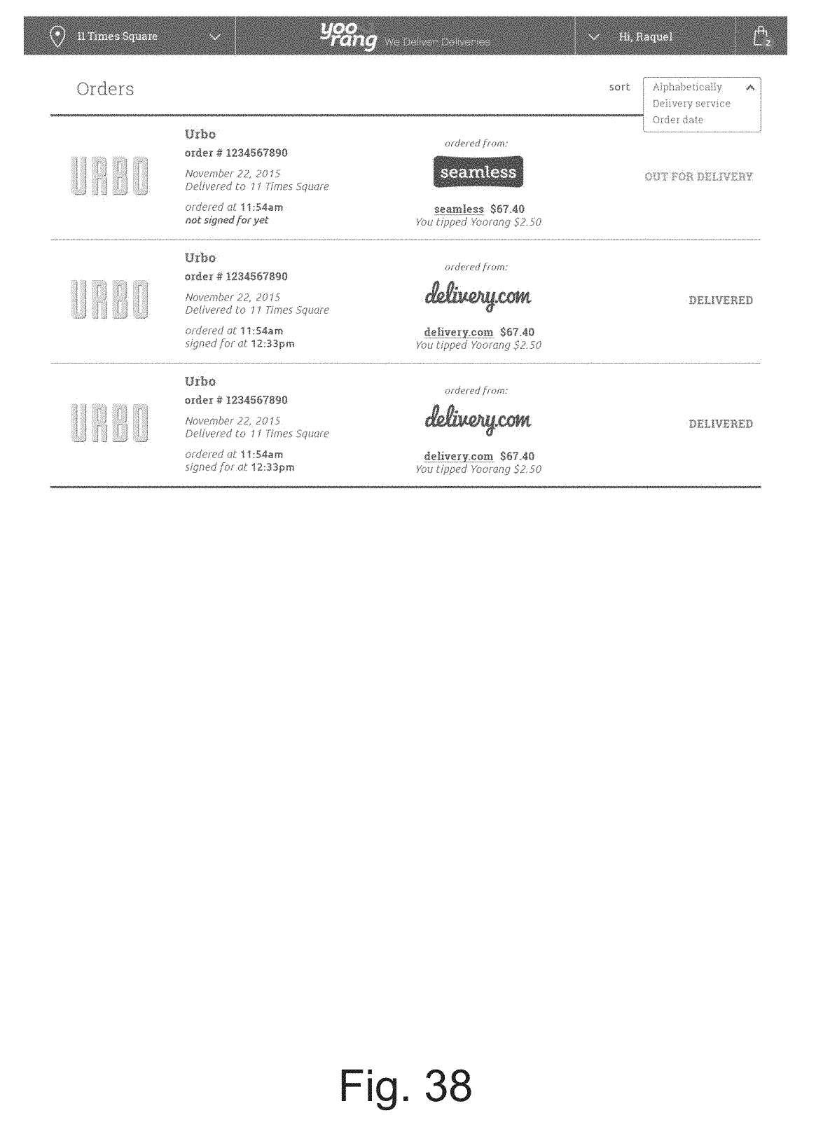

The delivery system may display prior and current orders of the user that is sortable in various formats, as illustrated in FIGS. 36-38. FIG. 36 shows a desktop homepage showing current and prior orders of a user registered with the delivery system. FIG. 37 shows a desktop homepage showing current and prior orders of a user registered with the delivery system with a current order highlighted. FIG. 38 shows a desktop homepage showing sortable current and prior orders of a user registered with the delivery system.

The delivery system dispatch desk/mobile/tablet app receives notification of the placed order within the building and it is placed on a list of incoming orders allowing them to know which orders to receive at the desk.

II. External Delivery Module

The delivery system may include an external delivery module for handling delivery of goods from any vendor outside the building until the transfer point.

A. Operation

The third-party delivery service from external order service/website, “In your building” restaurant/store/cafe etc., or group-buy affiliated vendor brings an order to the building. The delivery service checks in with an in-building dispatch to confirm that a resident/employee/business leader used the delivery system to place an order. If resident/employee/business leader used the delivery system to place order then the delivery service drops order off at dispatch desk.

A system dispatch kiosk employee uses the mobile/tablet application to scan a receipt corresponding with an order placed by a user changing the status of that order from “incoming” to “arrived”.

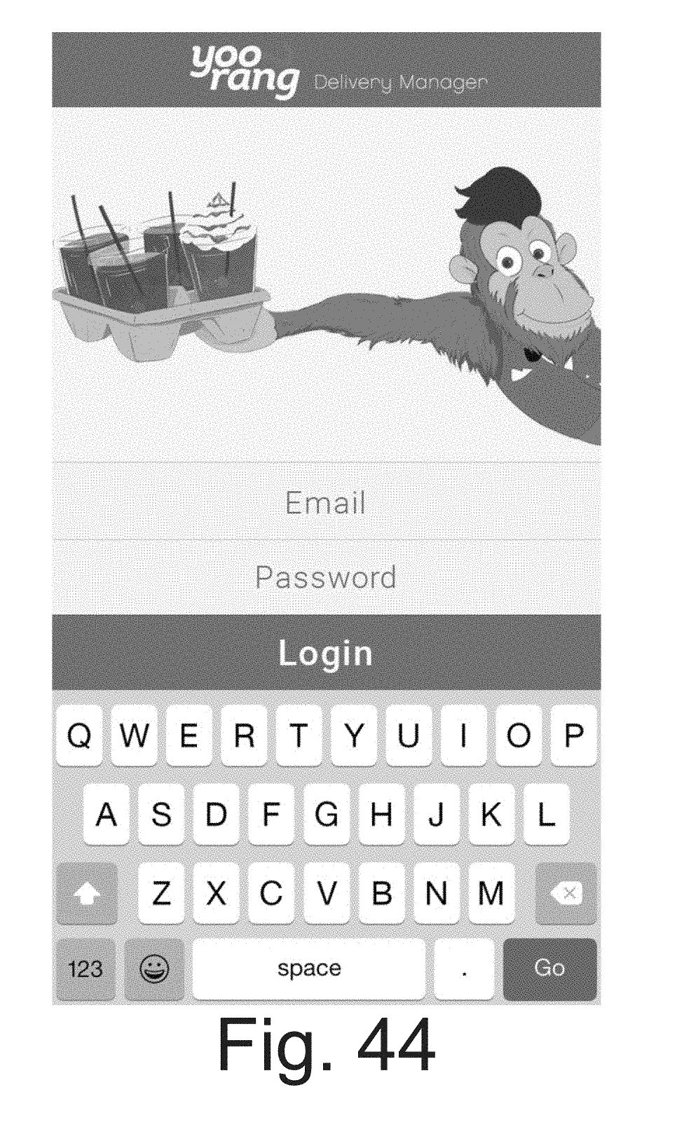

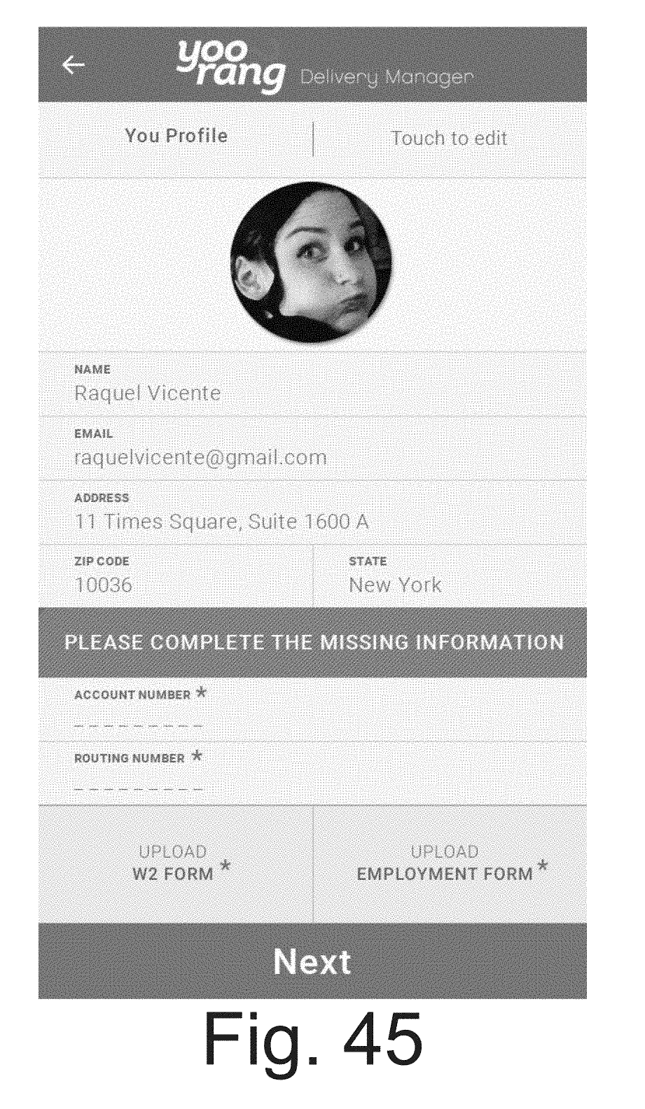

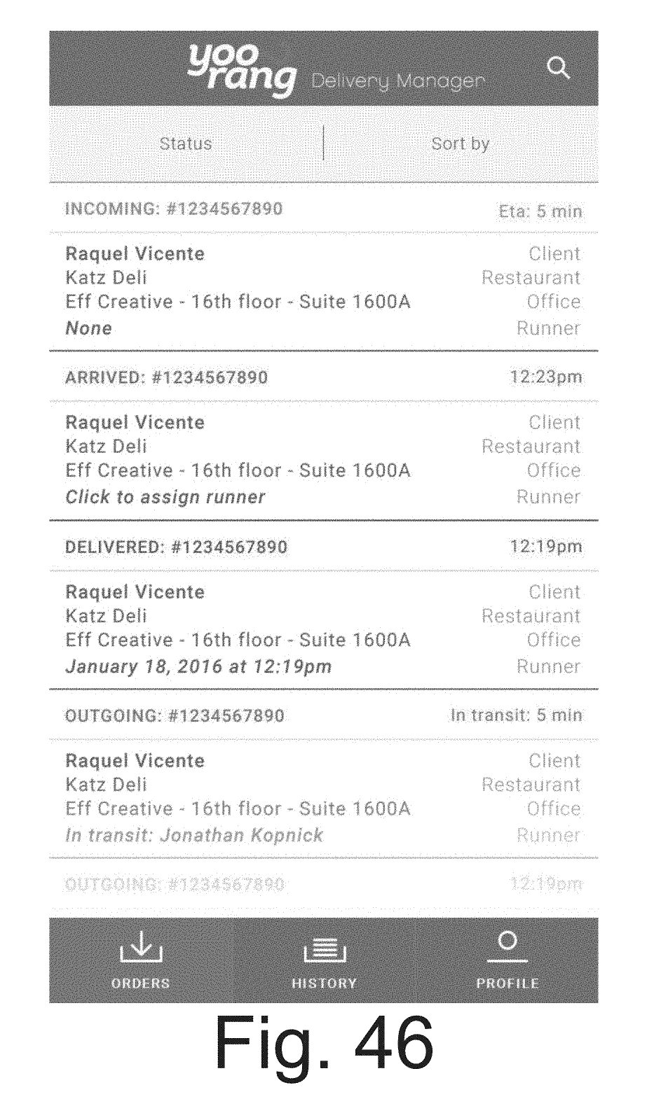

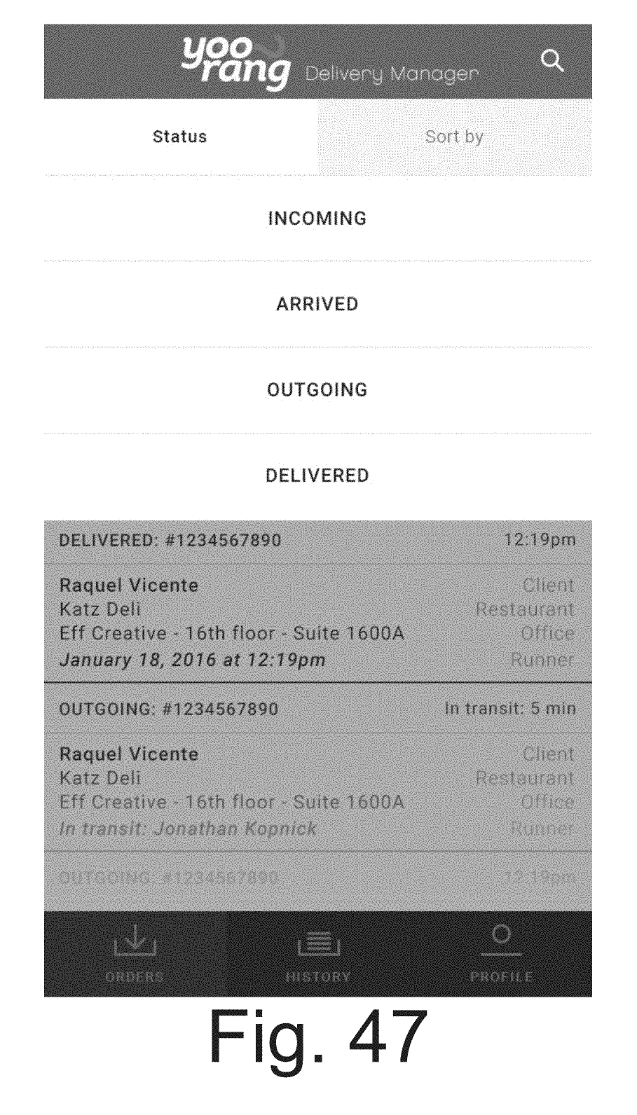

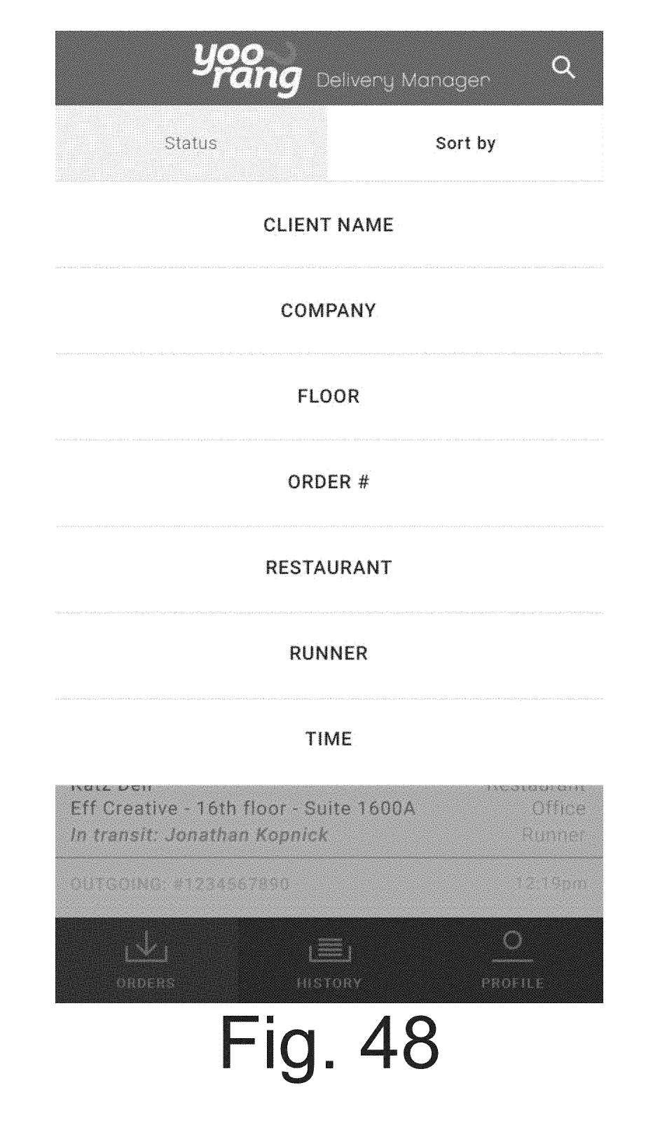

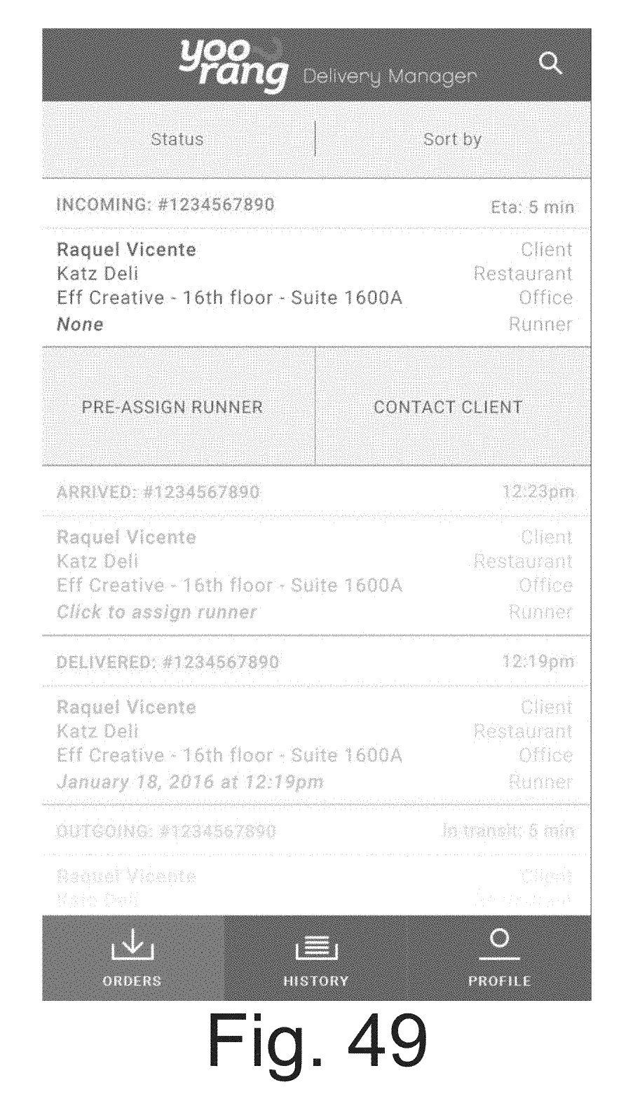

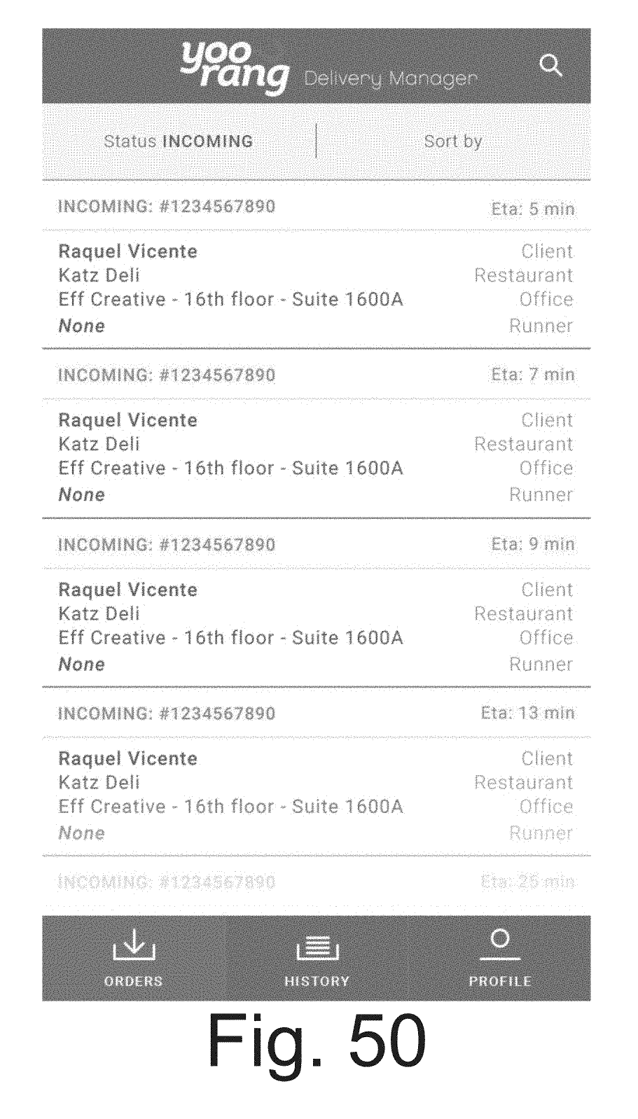

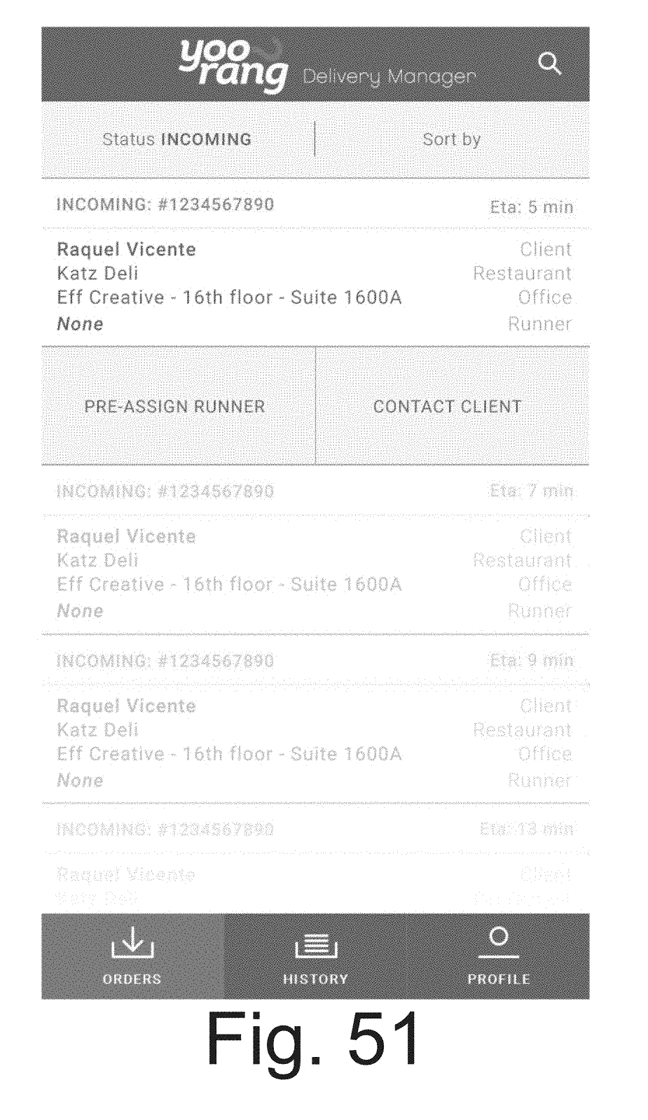

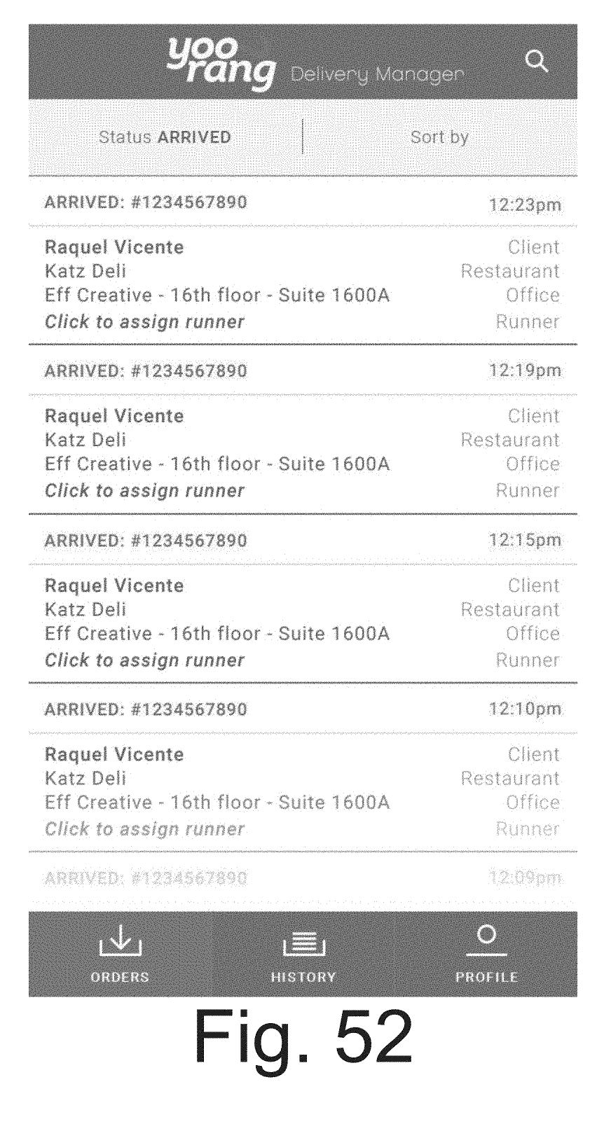

This process is illustrated in FIGS. 44-52 FIG. 44 shows a login screen for users of the delivery manager module within the delivery system. FIG. 45 shows an incomplete profile screen for a delivery person within the delivery system. FIG. 46 shows a summary of orders in a building within the delivery system. FIG. 47 shows a menu for sorting orders by status in a building within the delivery system. FIG. 48 shows a menu for sorting orders by type in a building within the delivery system. FIG. 49 shows expanded order information for one order in a building within the delivery system. FIG. 50 shows a menu showing only incoming orders in a building within the delivery system. FIG. 51 shows both an expanded order information for one order and a menu showing only incoming orders in a building within the delivery system. FIG. 52 shows a menu showing only arrived orders in a building within the delivery system.

B. Group Buys

As stated above, many companies and individuals within a building (or a group of buildings) from different companies and offices may order the same thing from the same vendors. A vendor may be forced to deliver the same thing to the same building two or more times due to a lack of coordination between the building vendor and the building residents. A “Group Buy” feature allows the vendor to provide discounts to building residents as in incentive for them to order goods or services together, thus saving the vendor delivery trips to the building.

The steps of the Group Buy may include the following:

1. The administrator may set up product listings with descriptive information to be displayed in the Group Buy section of the site. The administrator may choose for which buildings a group buy applies and can separate them amongst buildings.

2. The administrator may then sets up order goals and discount levels for those order goals. For instance, if the users in a building order 10 of a product, a 5% discount is applied to all purchases, if 20 then a 10% discount etc. The administrator may also sets up a termination date for each product listing at which point the payment is processed for all users at the given discount level achieved.

3. The users may view product listings sorted by category. Each product listing may have a counter that shows how many additional purchases are necessary in order to achieve the next discount level. Users can share product listings through email or social networks in order to refer other companies in a building to a product.

4. The users may submit and vote on new products they want to have in a new Group Buy.

C. “In Your Building” Vendor Creation

Many buildings have public vendors which already reside within their building (e.g.. the Empire State Building has a Starbucks by the entrance). Buildings may integrate these public vendors into the delivery system through an internal menu-ordering system in order to give them delivery options within their building. Many public vendors may not elect to offer delivery services. Nevertheless, for intra-building delivery these vendors may be willing to offer delivery service when the logistics of delivery are all handled by a third party.

1. Vendors in the immediate vicinity of a delivery system building or within it may fill out an application to be able to list their products/services in the delivery system.

2. The administrator may approve in-building vendors to allow them to create a menu of products and services on the delivery system.

3. The in-building approved vendor may create categorized products with discounts and other management options.

4. The in-building approved vendor links its bank account to receive payments processed through the delivery system order process.

5. The in-building approved vendor receives email/fax/SMS notifications when an order is placed and has a dashboard to review all orders both historical and present/in progress.

6. All in-building orders are automatically added into the queue of incoming orders for delivery system dispatch to assign to delivery system runners.

To join “In your building,” the business owner submits the following information to be reviewed by the admin for approval:

1. Owner name,

2. Business phone number,

3. Business Fax Number,

4. Business Name,

5. Business Email,

6. Password,

7. Business Category,

8. Business Description,

9. Featured Image (Square),

10. Profile Image (Rectangle),

11. Associated buildings they want to deliver to.

The business owner may create menu categories and individual menu items. The business owner may drag and drop menu items and categories to organize them with the placement they want on the page.

The business owner may add a unique item #, title, and description to menu items. Each menu item may also be given a price (with optional discount), category assignment and a descriptive image. Add-ons may be added to menu items, which can have a price or be free.

The business owner can add a checking account to receive payments.

The administrator can release payments from the administrative panel, such payments may be queued and released manually.

The “In your building” business owner may search and sort through an order history containing (order #, customer name, order placed date/time, delivered to runner, date/time, delivery amount).

The “in your building” business owner can see a queue of incoming orders containing order descriptions. The “In your building” business owner may receive SMS, Fax, Email, and Order Tracker notifications (browser push) alerting them to incoming orders with details. The business owner may mark these orders as fulfilled when he/she sends them to the delivery employee who drops off orders at the transfer point.

III. Internal Delivery Module

The delivery system may include an internal delivery module for handling delivery of goods or services from the transfer point to the resident or tenant in the secure building (deemed “outgoing” orders). The dispatch kiosk employee has either pre-assigned an order to be delivered by an intra-building delivery employee (runner) or assigns the delivery to a runner upon receiving the delivery. After an incoming order has been scanned and when a runner has been assigned to an order, the order is marked as “out for delivery.”

A dispatch employee is in charge of receiving incoming deliveries and assigning them to runners who deliver them to users.

A runner is in charge of delivering deliveries from the transfer point/dispatch kiosk in the lobby of the building to the desired delivery location indicated by the user.

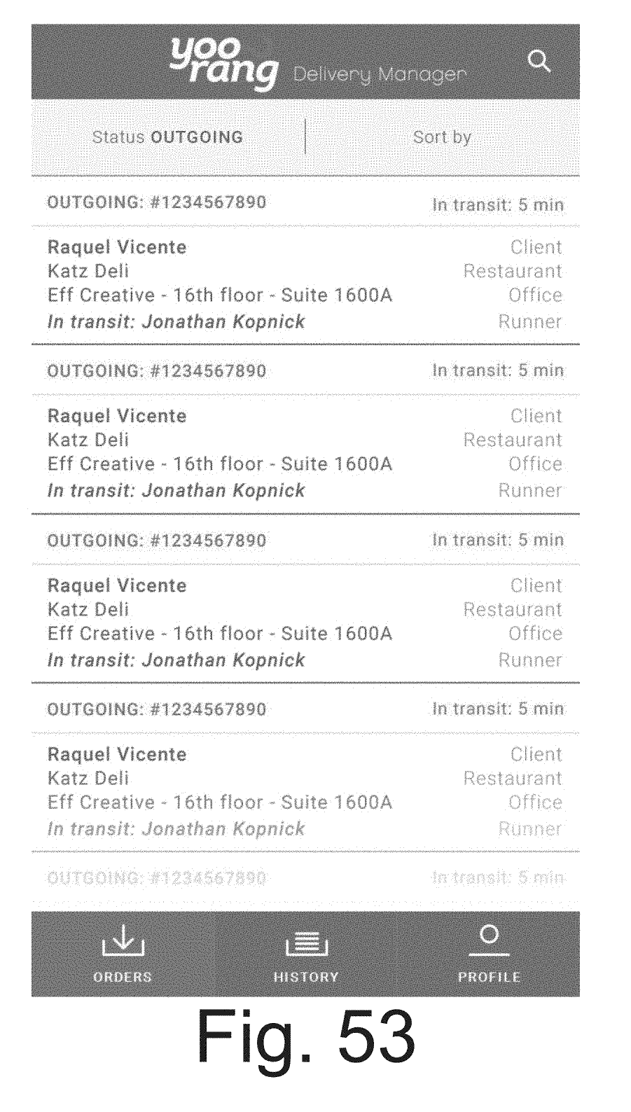

The process involves a runner that delivers the order to the user. The user uses their finger to sign and verify delivery on the runner's mobile/tablet application as well as indicate a tip to be given to the runner (charged to the user's credit card). This is illustrated in FIGS. 53-59 and 74-76.

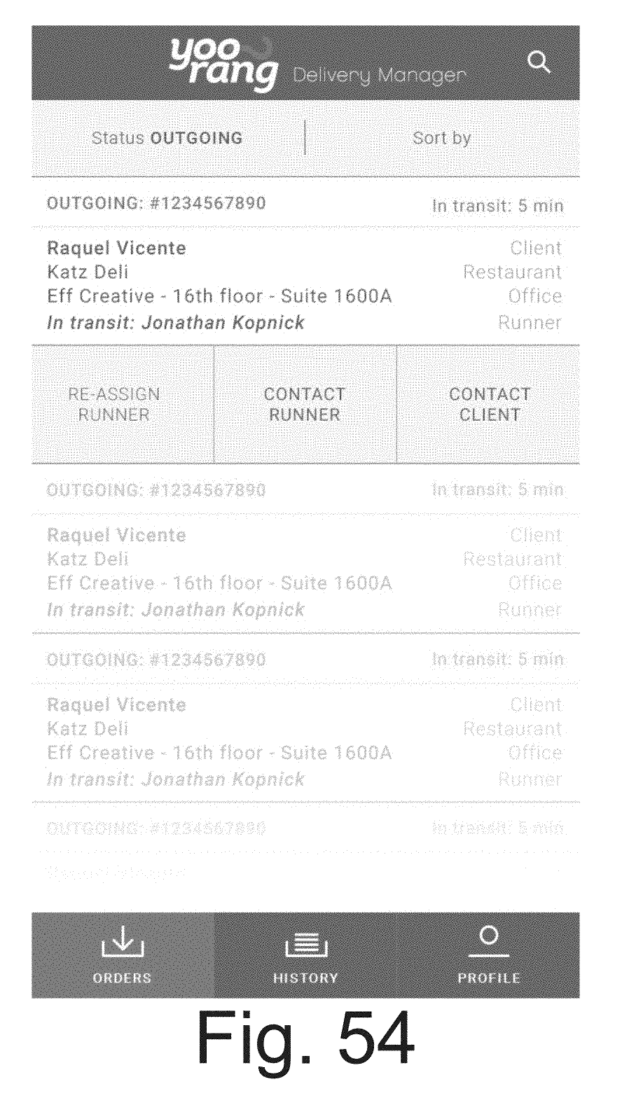

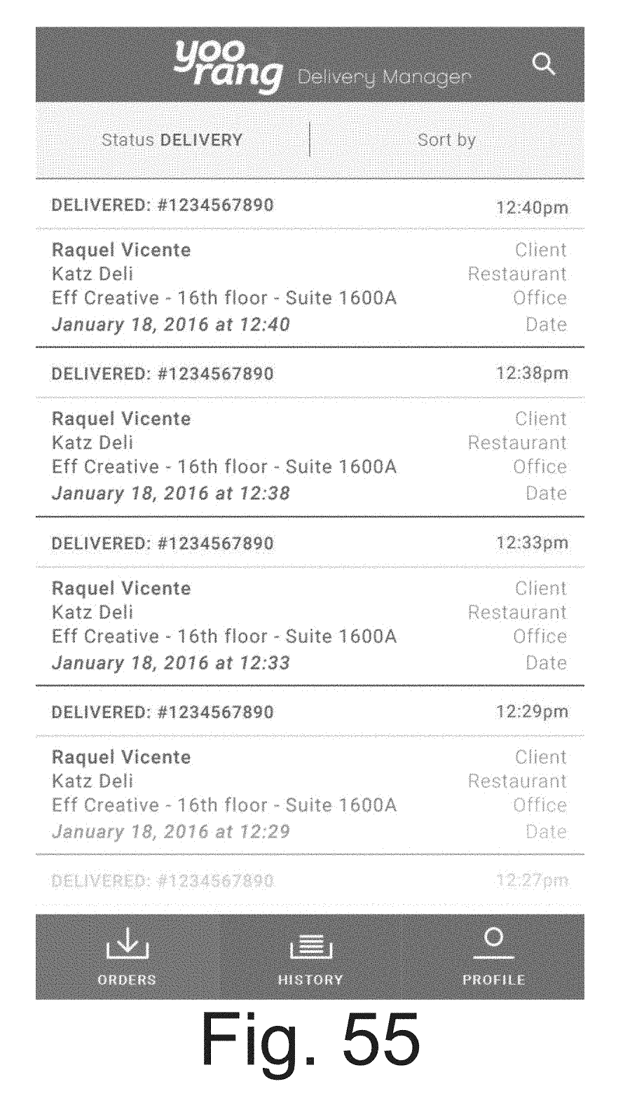

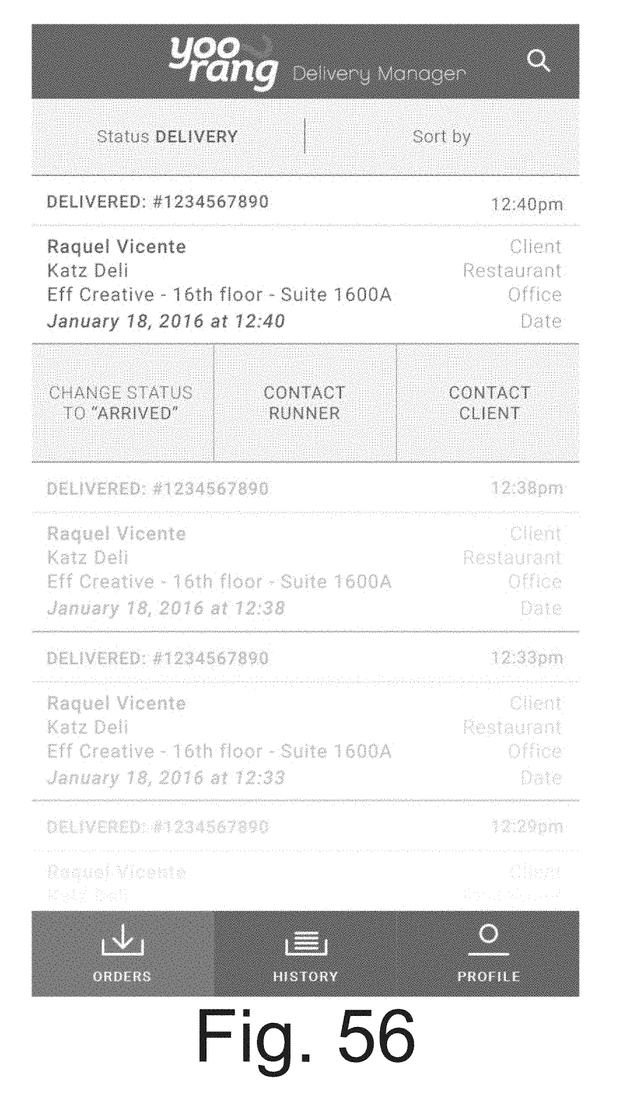

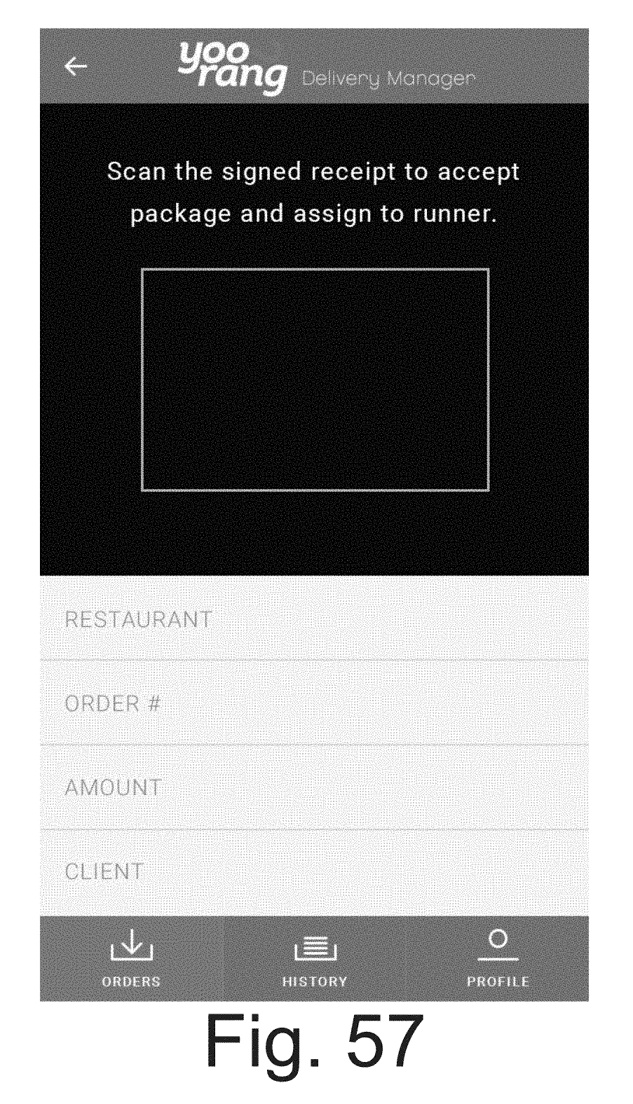

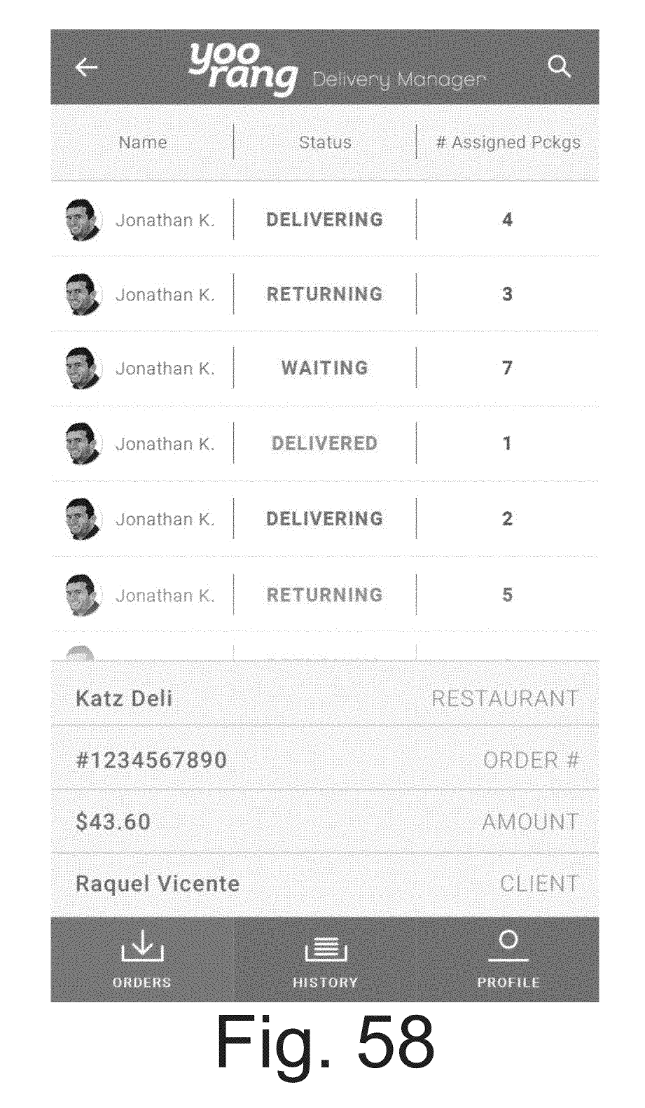

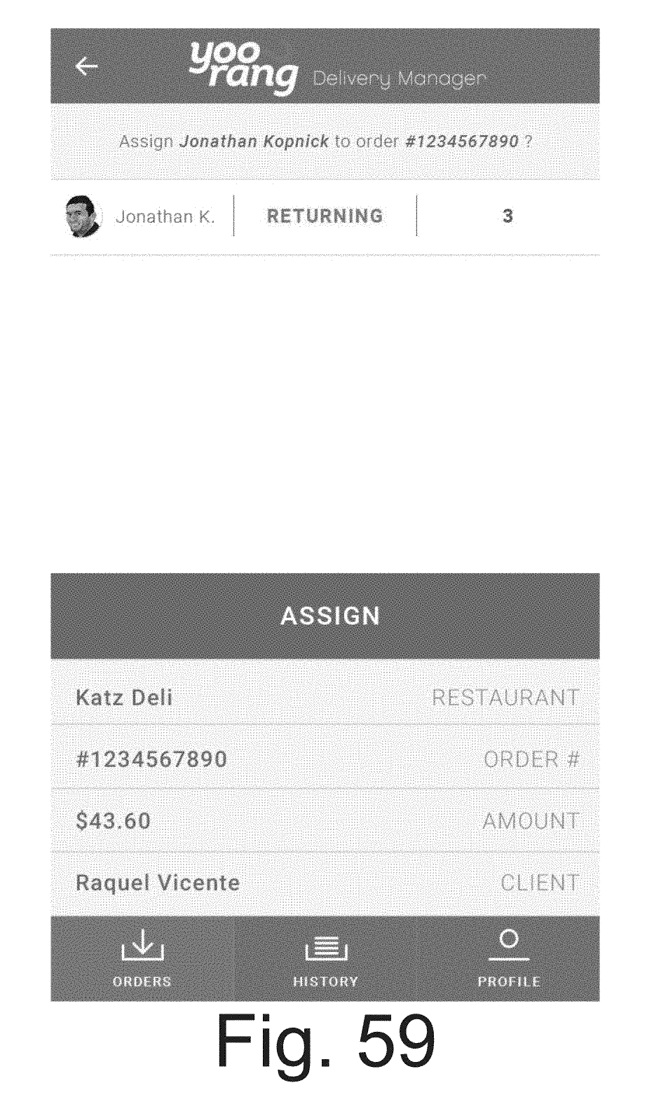

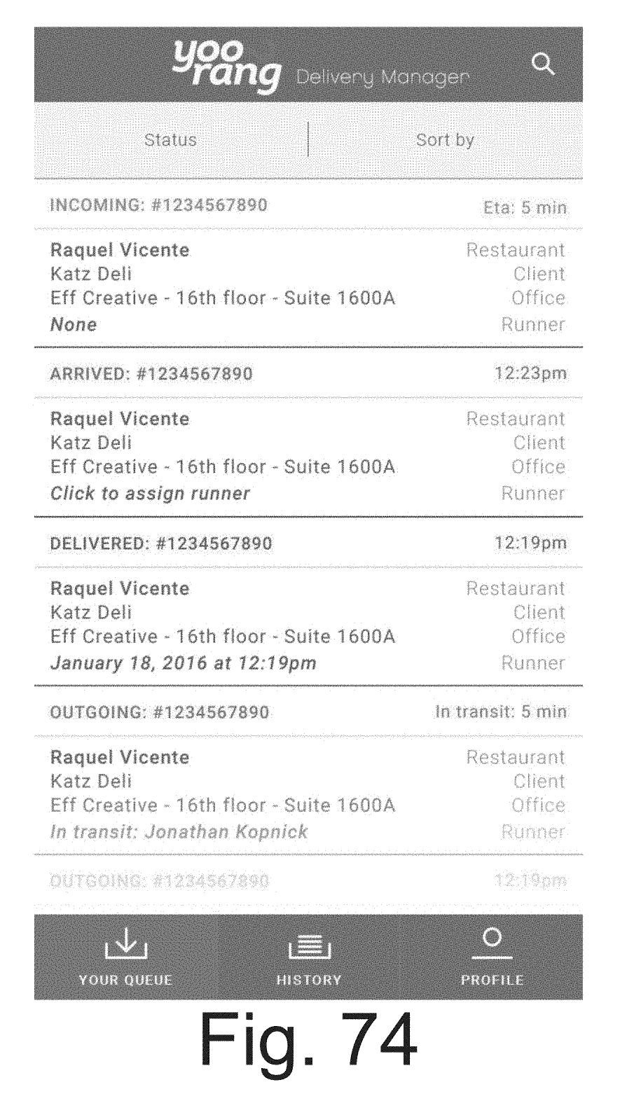

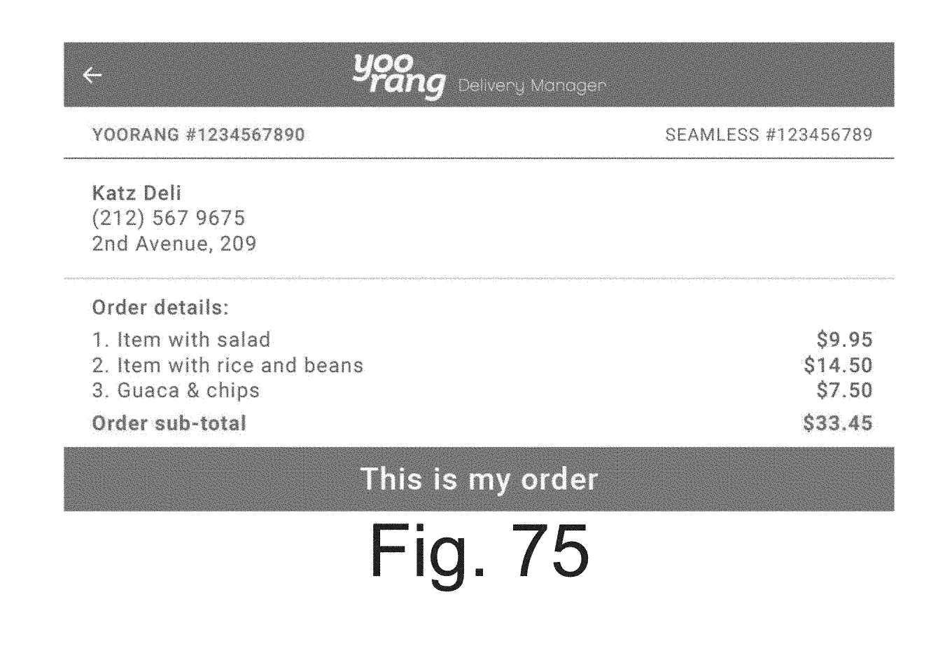

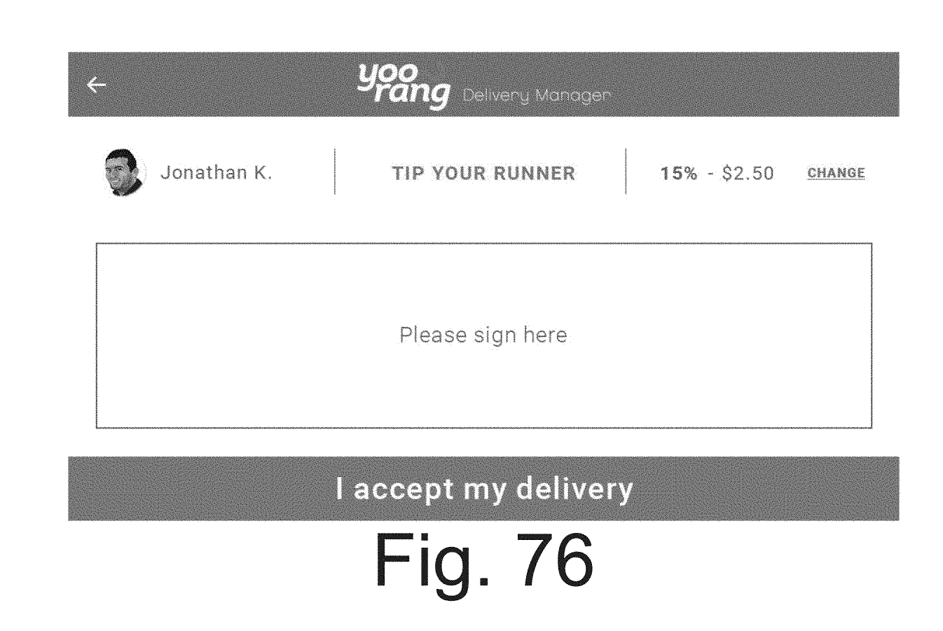

FIG. 53 shows a menu showing only outgoing orders in a building within the delivery system. FIG. 54 shows both an expanded order information for one order and a menu showing only outgoing orders in a building within the delivery system. FIG. 55 shows a menu showing only delivered orders in a building within the delivery system. FIG. 56 shows both an expanded order information for one order and a menu showing only arrived orders in a building within the delivery system. FIG. 57 shows a scanning tool for scanning an arriving package in a building within the delivery system. FIG. 58 shows a list of available delivery runners for a package in a building within the delivery system. FIG. 59 shows an assignment page for assigning a delivery runner for a package in a building within the delivery system. FIG. 74 shows a list of orders for which a delivery runner is responsible within the delivery system. FIG. 75 shows a confirmation screen for an order to be confirmed by a user within the delivery system. FIG. 76 shows a signature screen for an order to be confirmed by a user within the delivery system.

In further detail, the transfer point/dispatch desk mobile/tablet app receives notification of the placed order within the building and it is placed on a list of incoming orders allowing them to know which orders to receive at the desk

A transfer point employee uses the mobile/tablet application to scan a receipt corresponding with an order placed by a user changing the status of that order from “incoming” to “arrived”.

The transfer point employee may pre-assign an order to be delivered by an intra-building delivery employee (runner) or assign the delivery to a runner upon receiving the delivery.

The transfer point employee may change the status of a delivery from “delivered” back to “arrived” so it can be reassigned to a runner.

The transfer point employee can contact a client or runner through their phone.

The runner can see a list of orders that have been assigned to them as well as a history of orders they have previously delivered.

Upon arriving at the delivery location for an order, the runner presents the app on phone/tablet to registered user. The registered user confirms that the order is theirs, and then signs and sets a tip amount to complete order acceptance.

IV. Delivery Employee Module

The delivery system may include a delivery employee module for managing the onboarding and assignment of employees for delivery from the transfer point to the customer within the secure building.

The purpose of the runner/dispatch application is to allow delivery system runners and dispatch employees to:

1. Register to become an employee.

2. Register to sign up for employment shifts.

3. Track the receiving and delivery of goods from the transfer point to user's offices.

The delivery system module provides workers the ability to set their own schedule and location preferences in an on-demand employment model similar to Uber. This system allows part-time employment to be offered to nearly anyone who would want to use this service. (For example, an intern who wants to make extra money during free time may sign up to deliver goods within the building.)

A potential delivery employee may submit registration information to sign up as an employee. The potential employee may submit his or her social security number and other registration details. This information is sent to a third party background check API whose results are forwarded to an administrator.

The administrator reviews the potential employee's information and background check results, issues e-sign documents to the employee to fill out. Once they have been filled out by user and confirmed by administrator, the employee is granted the ability to login to system. The employee then enters in rest of necessary employment details including bank account details

Employees may then schedule onboarding meetings in available buildings using available times set by the building representative. The building representative maintains a calendar of available times for onboarding meeting scheduling and can see when employees onboarding meetings are schedule for.

After the onboarding meeting, the building representative is sent an email with the ability to approve or deny employee's approval to work in their building. If the building representative agrees, the employee is given the ability to schedule shifts in that building.

An administrator may schedule available shifts in a building, and can choose how many employees can sign up for each shift.

The system may allocate more/less shifts dynamically based on predicted delivery demand.

The employee may choose from available shifts in buildings for which they have been approved within their runner/dispatch app.

The employee scheduled shifts are sent to admin for approval. The administrator-approved shifts are added to employee's schedule.

An employee may cancel a scheduled shift and must accept terms of service that lay out penalties for doing so.

Upon arrival at a building for which an employee has a registered shift, the employee can clock in to show the administrator that they arrived on time for the shift start time. The employee may also be prompted to clock out at end of shift

The availability of work within a building is set by a building representative, who is responsible for:

1. Providing documentation which runners/dispatch must sign in order to be able to schedule shifts within their building;

2. Providing available times for runners/dispatch to be able to schedule onboarding meetings which must be attended for runners/dispatch to be able to work in the building; and

3. Providing approval for runners/dispatch to schedule sessions in their building.

The process may be accomplished as follows:

1. A job applicant registers an account through the runner/dispatch app. Within the registration process, the job applicant provides all employment information necessary for filling out employment documentation including a social security number. All forms may be filled out with e-forms.

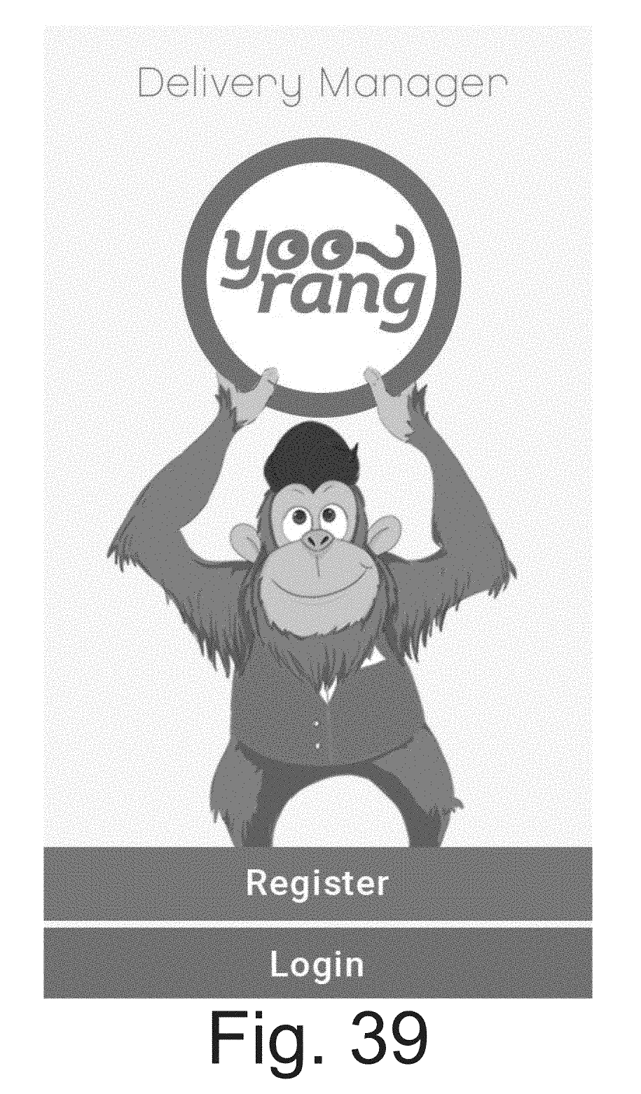

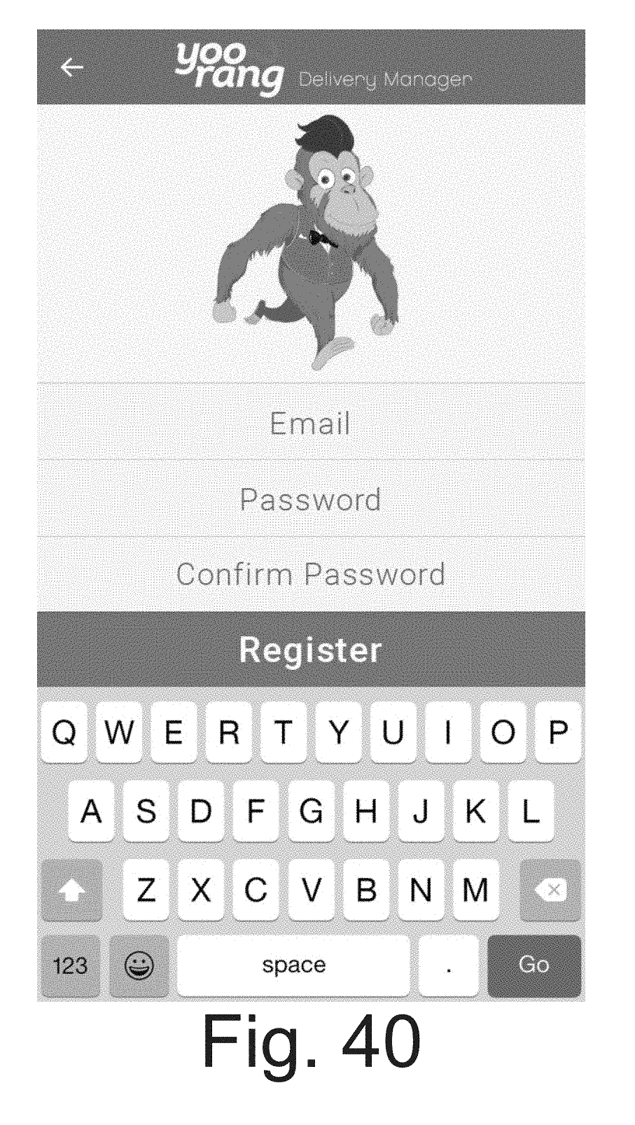

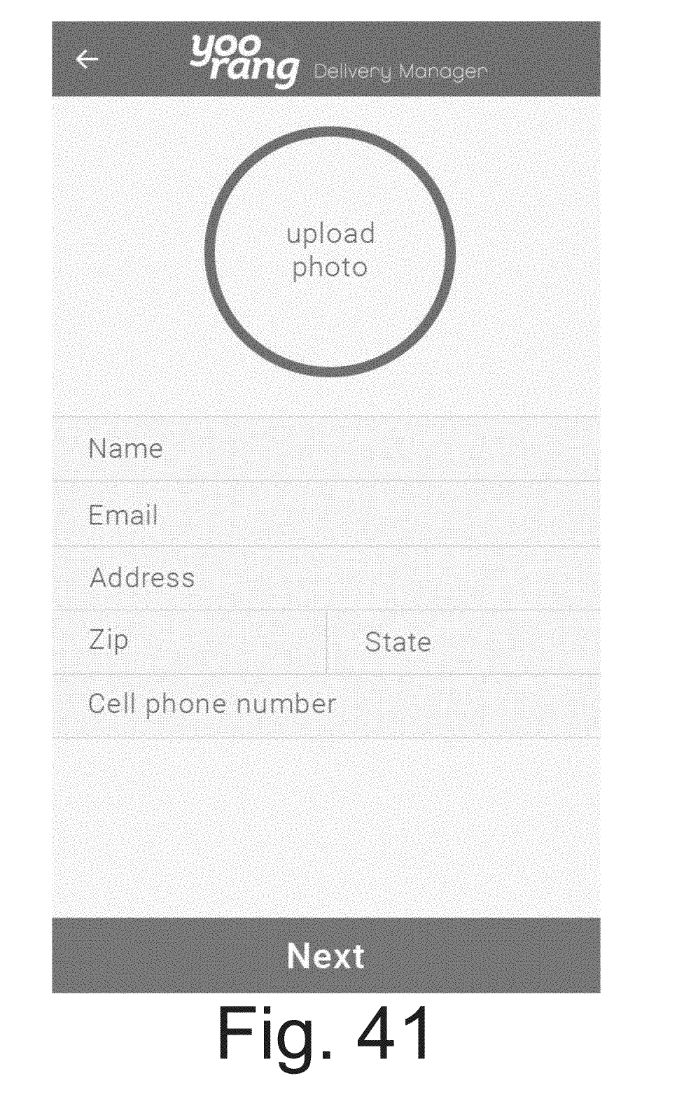

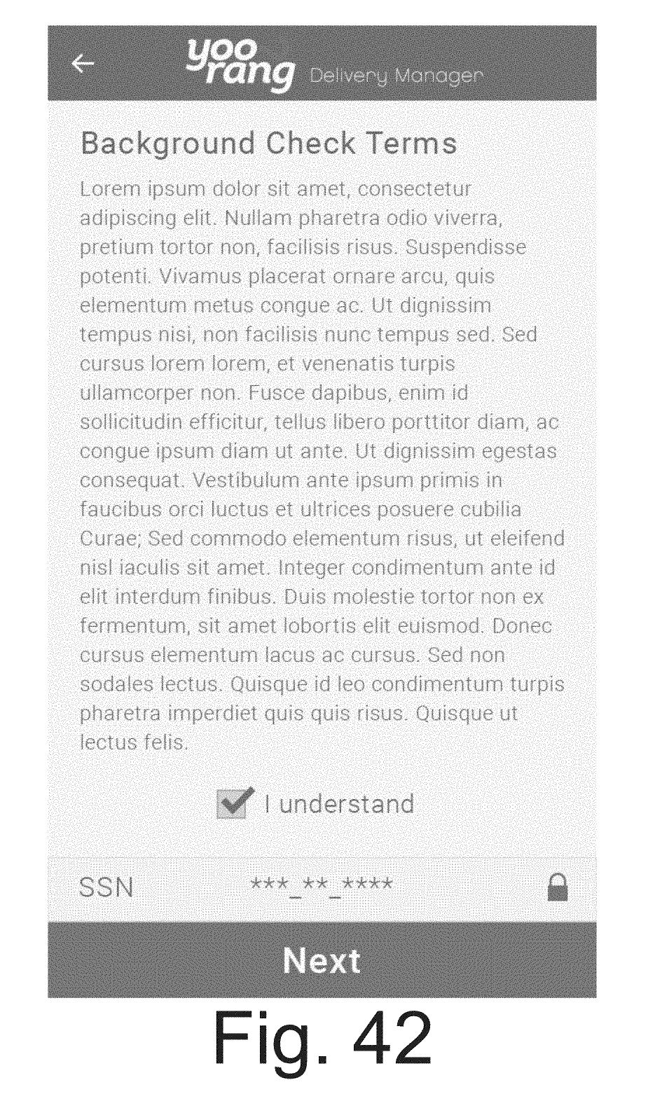

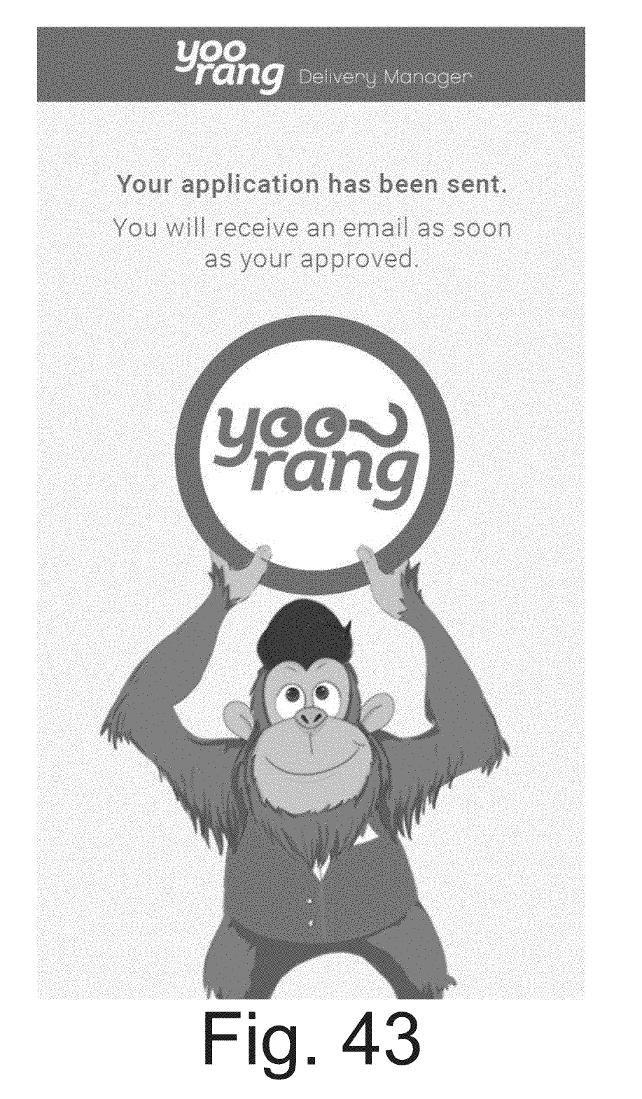

This is illustrated in FIGS. 39-43. FIG. 39 shows a homepage of a delivery manager module for the delivery system. FIG. 40 shows a registration page for a delivery person to be appointed within the delivery system. FIG. 41 shows a second registration page for a delivery person to be appointed within the delivery system. FIG. 42 shows a background check permission notice for a delivery person to be appointed within the delivery system. FIG. 43 shows a background check confirmation notice for a delivery person to be appointed within the delivery system.

2. Upon registration submission, the job applicant's profile is scanned by a 3rd party API to validate employment eligibility using both a background check and information accuracy validation system which verifies the accuracy of registration information. Results of the application scan and registration information are submitted to a system administrator to review whether an application is accepted or denied.

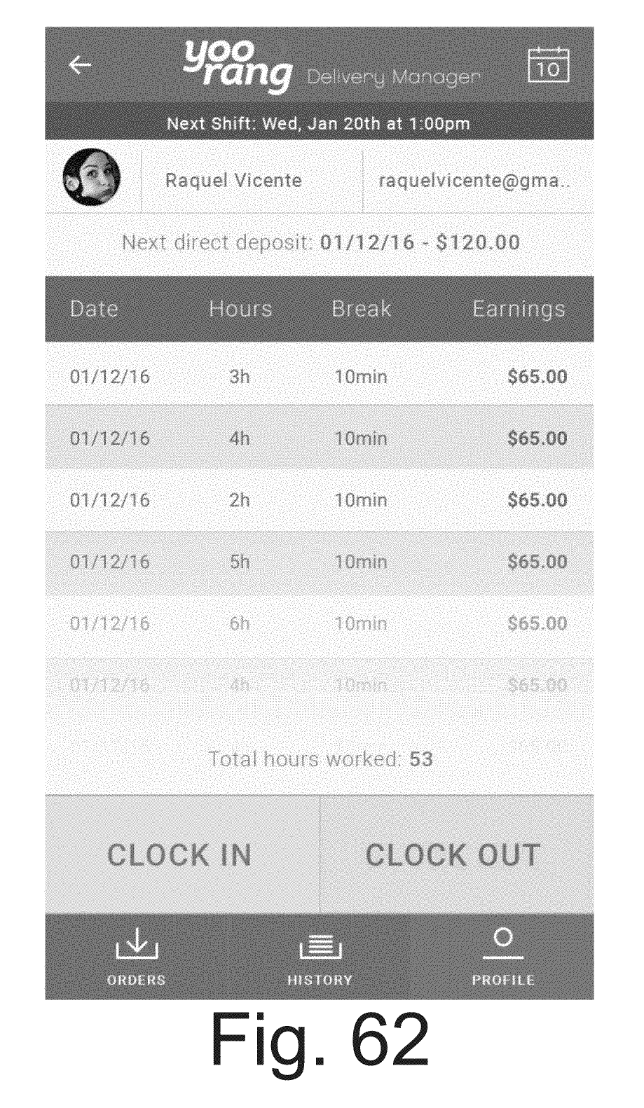

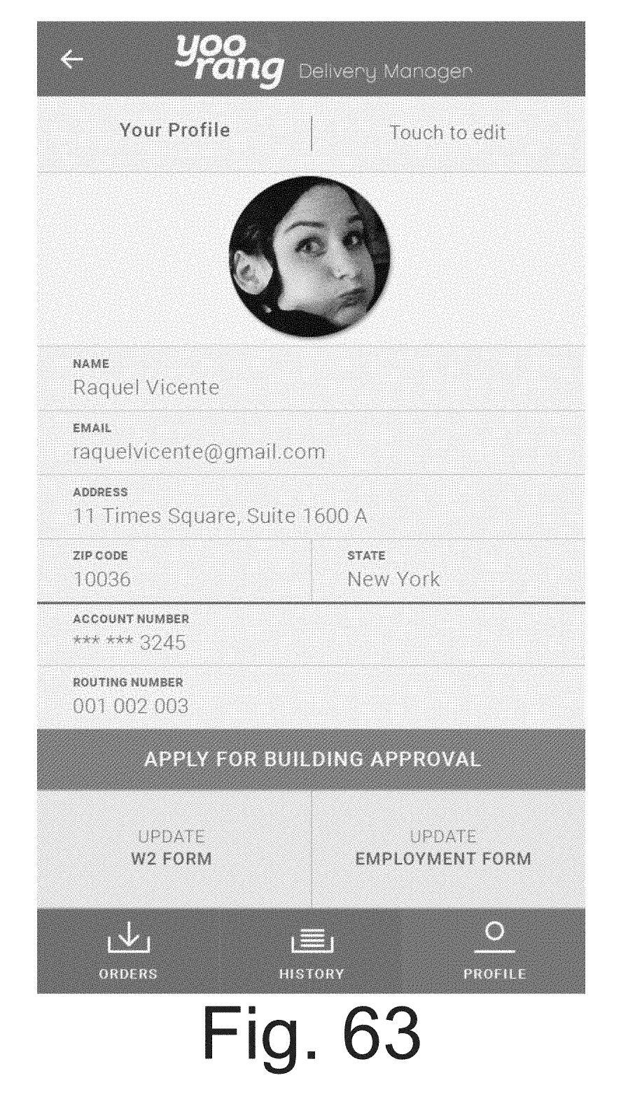

3. Upon application acceptance, the job applicant receives email with forms and an activation link to become a system employee. This is illustrated by FIGS. 62-63. FIG. 62 shows information for a delivery runner's compensation within the delivery system. FIG. 63 shows information for a delivery runner's approval to work in a building within the delivery system.

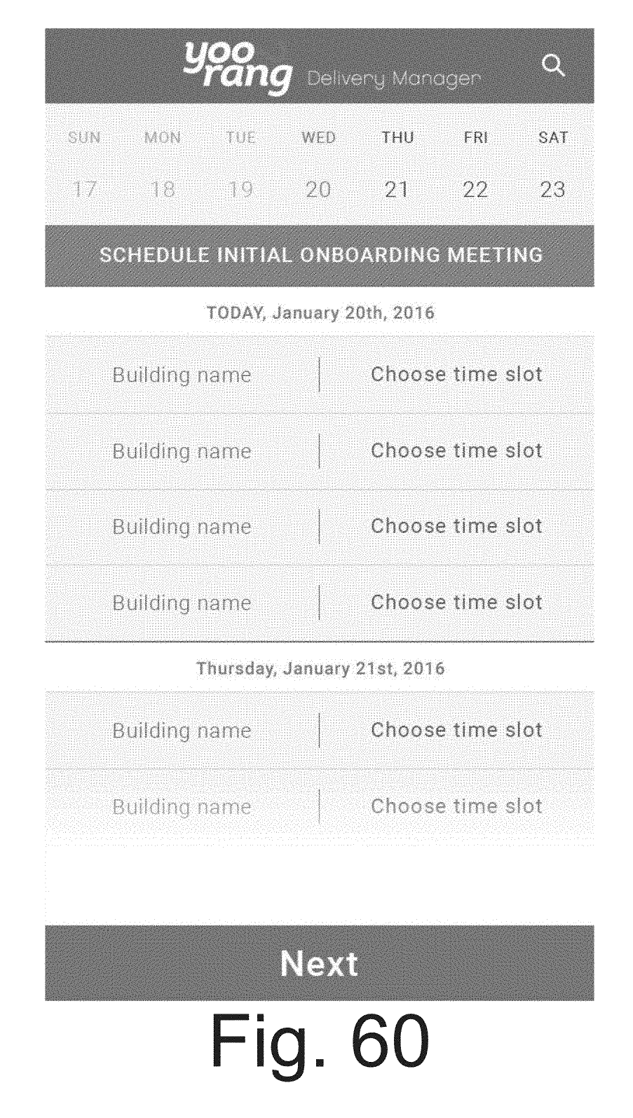

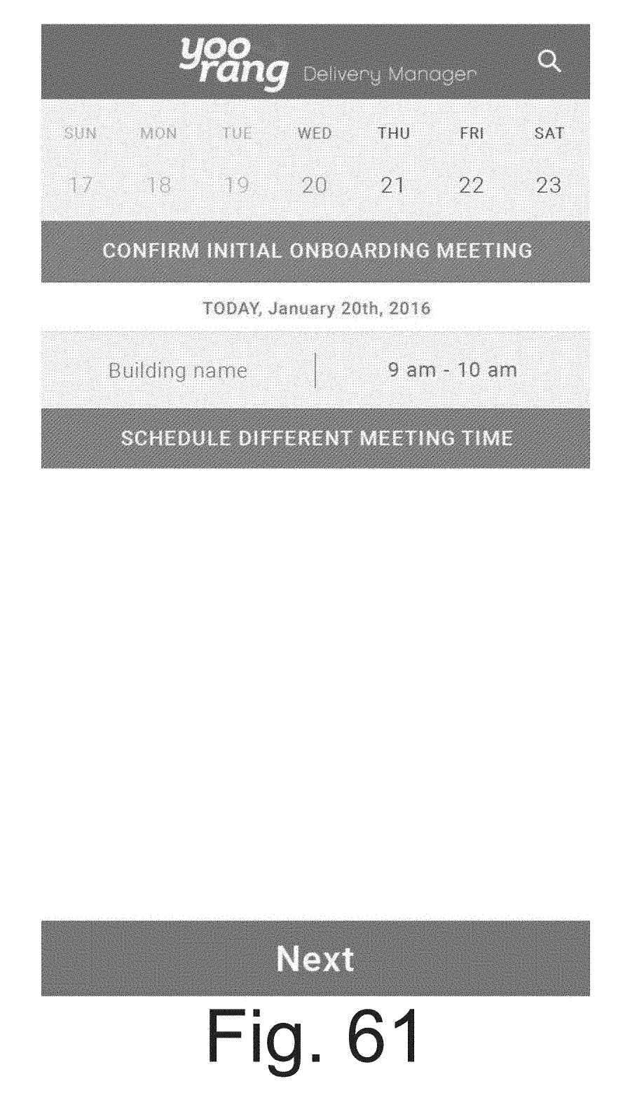

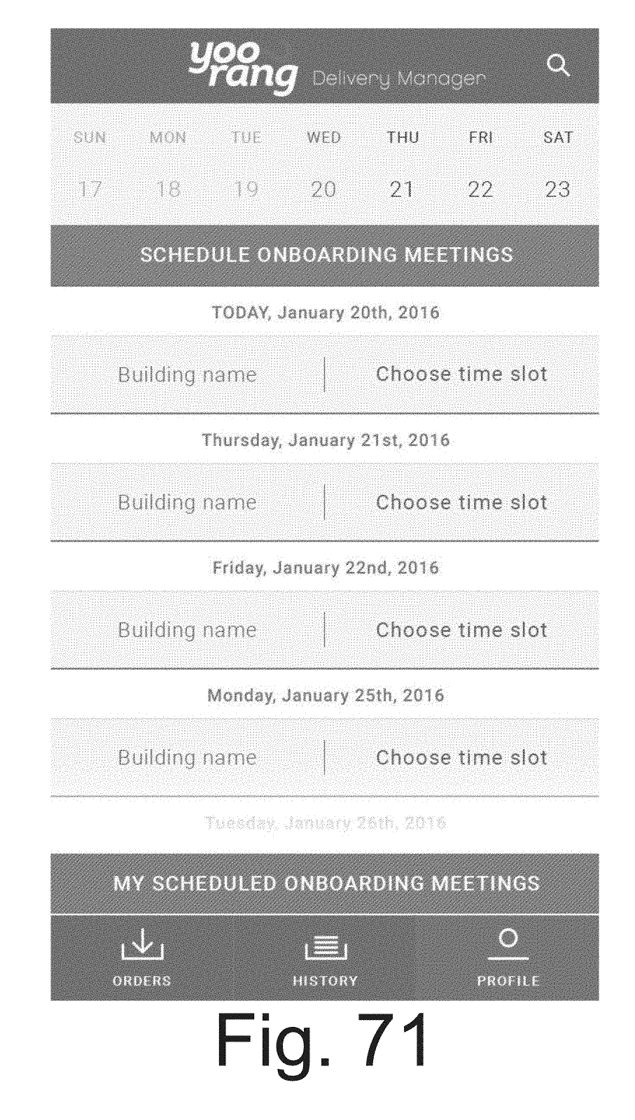

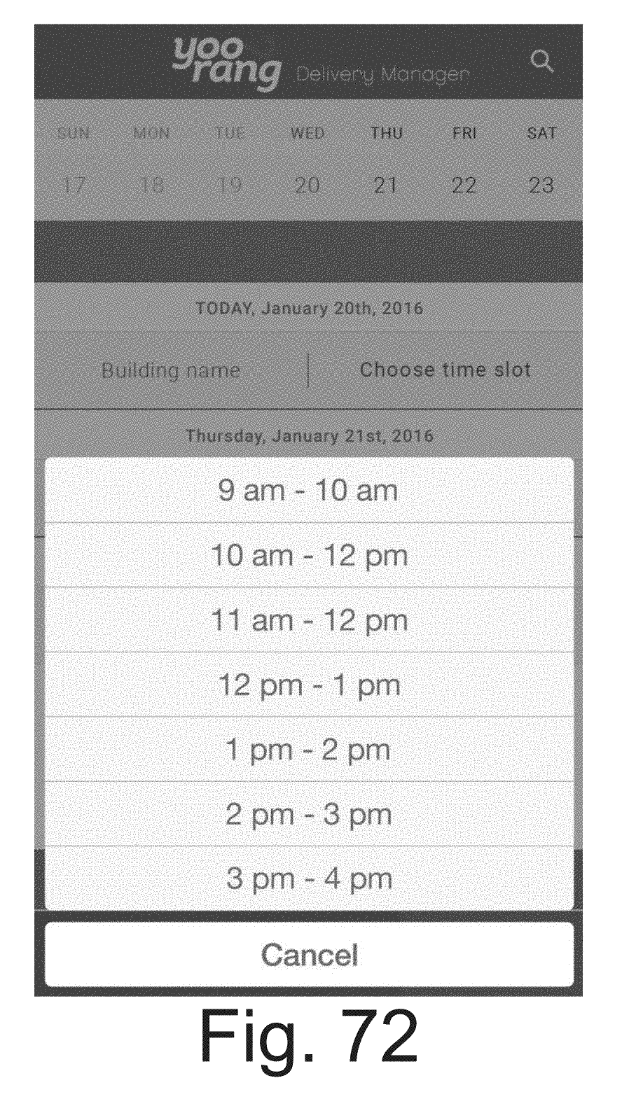

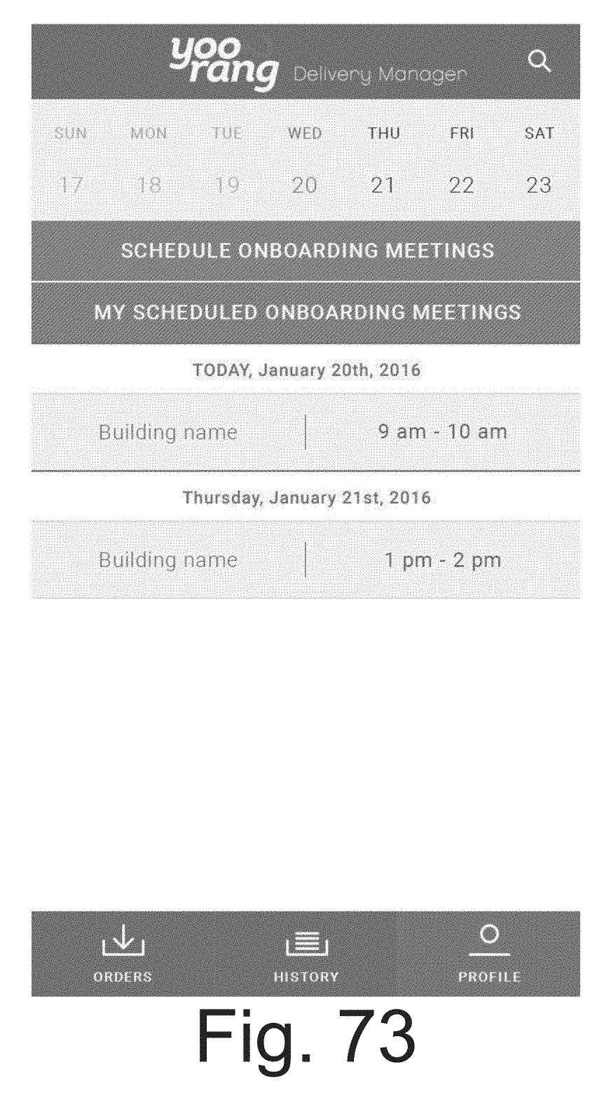

4. The employee must complete in-person onboarding meetings with building ownership/security services. Building ownership/security services indicate availability for interviews on a web-based calendar, employee chooses from available time slots on an onboarding calendar scheduling process located within their runner/dispatch app. This is shown in FIGS. 60-61 and 71-73. FIG. 60 shows a module for a delivery runner to be onboarded within the delivery system. FIG. 61 shows a system for confirming a time for a delivery runner to be onboarded within the delivery system. FIG. 71 shows a delivery runner's schedule of an onboarding within the delivery system. FIG. 72 shows a delivery runner's scheduling of a time for onboarding within the delivery system. FIG. 73 shows a delivery runner's completion of the scheduling of a time for onboarding within the delivery system.

5. Upon completing onboarding meeting, the employee is granted access to shift scheduling for the onboarding meeting approved building. The employee can gain access to more shifts in more buildings by completing more onboarding meetings in different buildings.

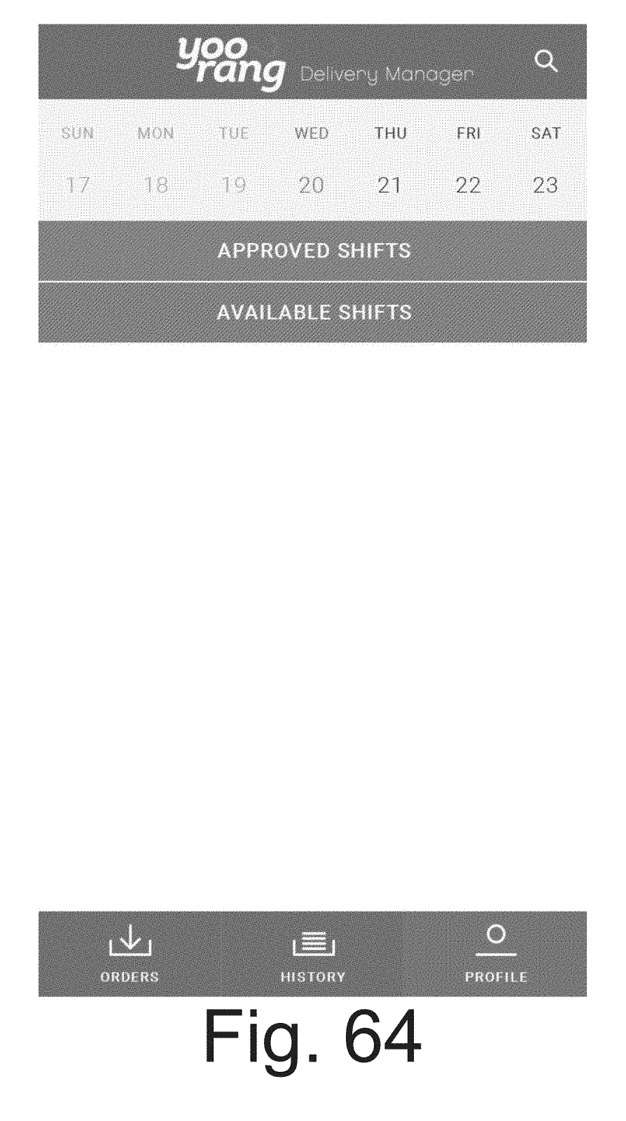

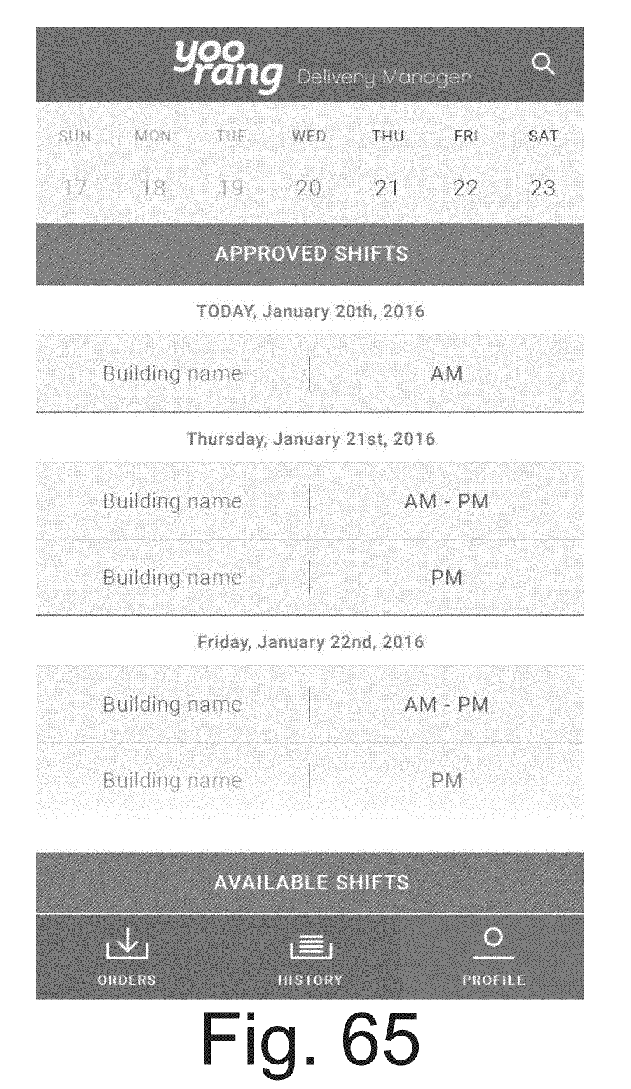

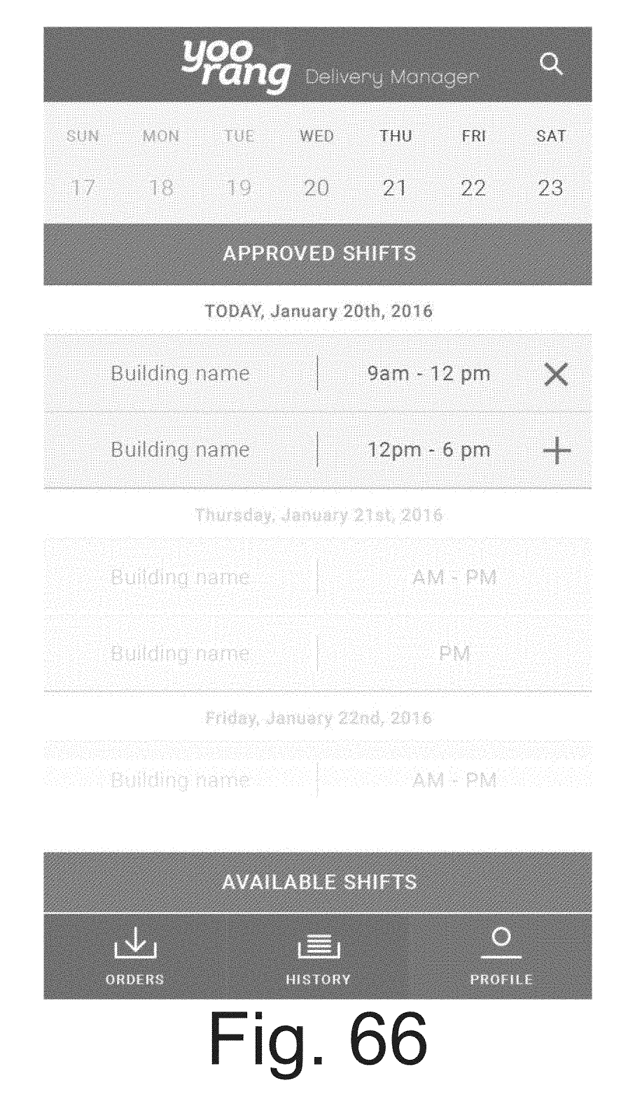

6. The administrator may determine available shifts for a given building, and system can allocate more/less shifts dynamically based on predicted delivery demand. This is illustrated in FIGS. 64-66. FIG. 64 shows a delivery runner's approved shifts and available shifts to work within the delivery system. FIG. 65 shows a delivery runner's approved shifts to work within the delivery system. FIG. 66 shows an expanded menu of a delivery runner's approved shifts to work within the delivery system.

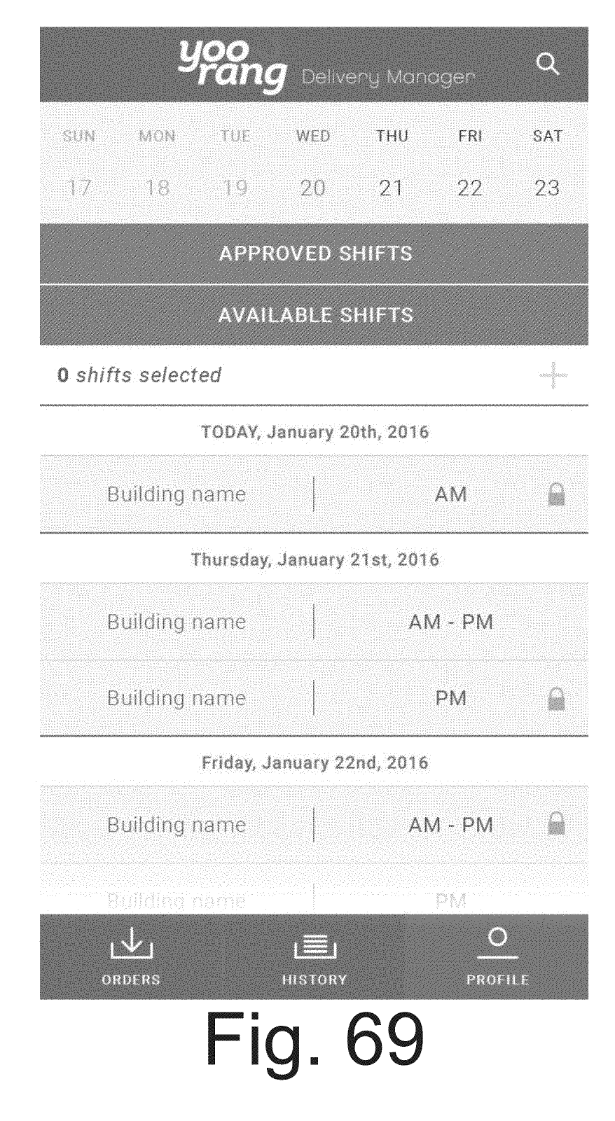

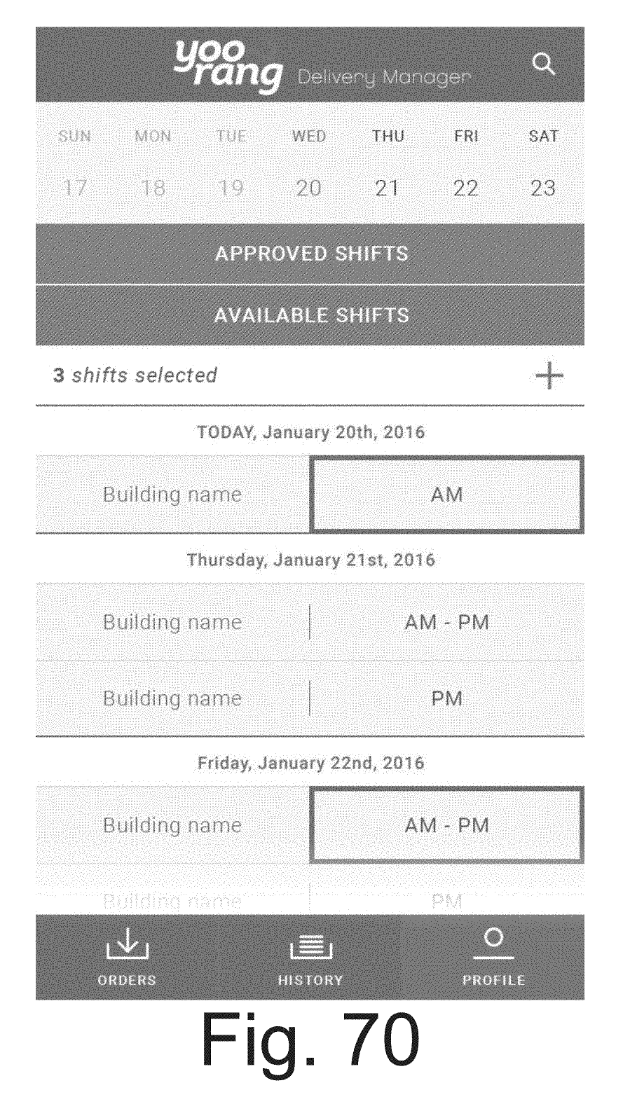

7. The employee may choose from available shifts in buildings for which they have been approved within their runner/dispatch app. This is shown in FIGS. 69-70. FIG. 69 shows a delivery runner's available shifts to work within the delivery system. FIG. 70 shows a delivery runner's highlighted available shifts to work within the delivery system.

8. Upon arrival at a system building for which an employee has a registered shift, the employee can clock in to show admin that they arrived on time for the shift start time. Check in can only happen when the employee is within the specified building's immediate geographic radius.

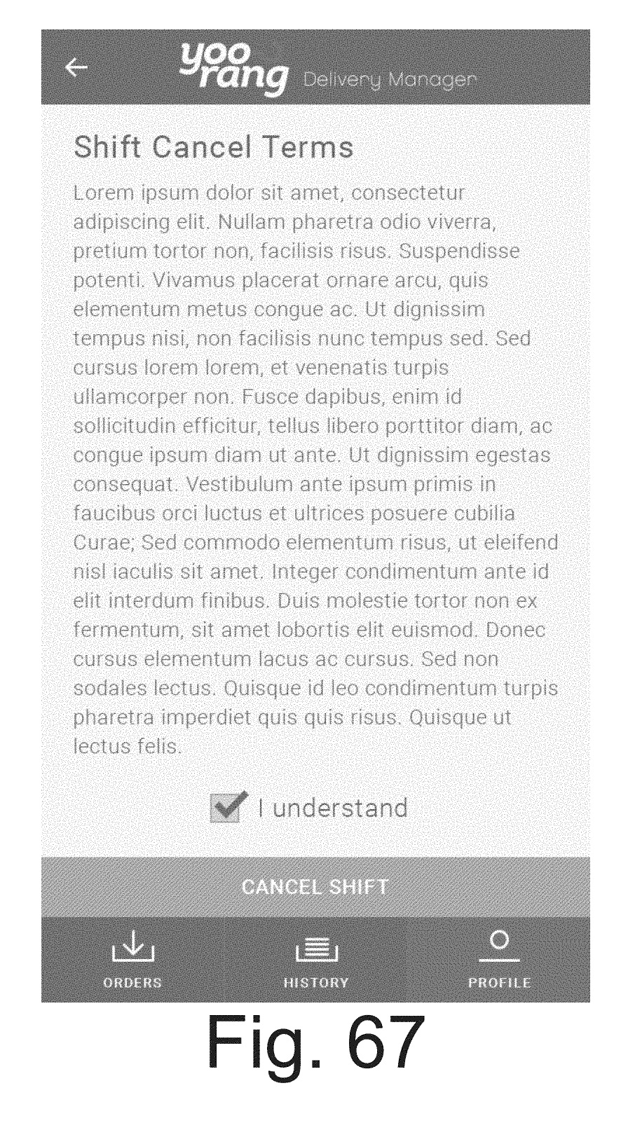

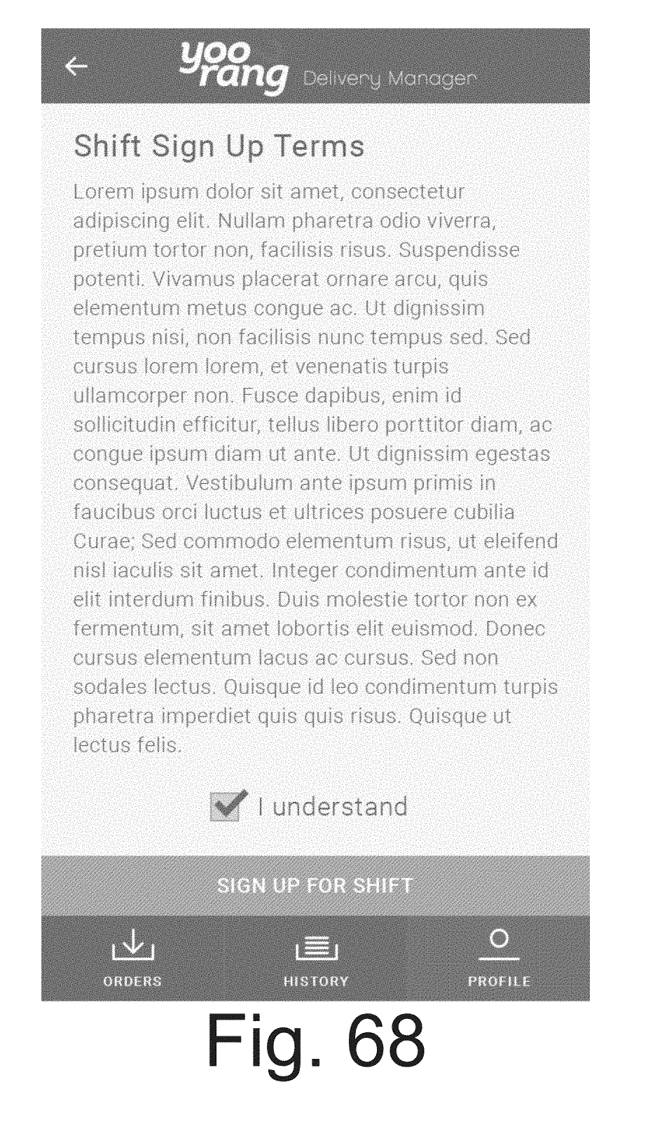

9. All shift sign-ups and cancellations require employee to e-sign a contract with terms specific to the building they are working/would have worked in. This is shown in FIGS. 67-68. FIG. 67 shows an agreement for a delivery runner that cancels a future shift within the delivery system. FIG. 68 shows an agreement for a delivery runner that signs up for a future shift within the delivery system.

V. Administration Module

A. Administrative Tasks

The Administration module allows administrators and super-administrators to oversee and maintain all aspects of the delivery system.

The purpose of the administration panel is to allow the administration team to complete at least the following tasks:

1. Create Buildings

The Administration module allows for unregistered users whose building has not been registered in the delivery system may submit a contact form that is integrated with the homepage map to request the delivery system coming to their building.

The unregistered user gives the following information to begin registration:
Building(s) and companies they are associating with their account.
Name
Title
Cell Phone
Office Phone (Optional)

The administrator may require additional information from building owners to allow entry in the delivery system.

2. Review, manage, and accept runner/dispatch applications and employees.

The administrator may set parameters for the hiring, retention, payment and separation of runner and dispatch employees within a building or group of buildings.

3. Review, manage, and accept “In Your Building” vendors.

The administrator may manage “in your building” vendors by accepting, retaining, paying and separating of vendors in or close to the building in the delivery system.

4. Review, manage, create, and accept group-buy products;

The administrator may manage the group-buy products by setting the parameters for group-buys, including quantity, price and discount. The administrator may also interface with outside vendors to establish products and services that are eligible for group-buys.

5. Review, manage, and accept users;

The administrator may review, manage and accept users. Users may be allocated rights within the delivery system and may be removed by the administrator.

6. Review, manage, accept and disburse payments.

The administrator may coordinate all payments within the delivery system, including payments to “in your building” delivery vendors, payments to employees, payments related to group-buys and all other disbursements within the system.

An administrator level may have access to the above. A “super administrator” level may have the ability to perform the following functions:

1. Create administrator accounts.

2. Perform all the same actions as an administrator.

3. Review and edit prediction models/analytics within the delivery system.

B. Data Extraction

The delivery system may collect and sell unique three-dimensional altitudinal and behavioral data to data services companies encompassing internal building layouts, intra-building travel time, delivery volume, and group purchasing habits.

The use of the delivery system produces different categories of useful data. Specifically:

1. The administrator may plug in building floorplans into a system to map out correlation between office location descriptions and intra-building geographic locations.

2. The administrator may review the average elapsed time that it takes for a delivery runner to get to different floors of the building. This enables the administrator to determine if a delivery runner is late in comparison to this average time.

3. The administrator may review a real-time list of deliveries and review how quickly they are occurring in comparison to historical elapsed time for deliveries to the same floor. This allows the delivery system to be able to add expected delays onto order time estimations.

4. The administrator may determine when there are multiple orders from the same establishment coming within a similar time period. The administrator may then coordinate with the establishment to receive multiple orders in a group delivery, thereby reducing the delivery frequency of the establishment.

5. The administrator may review a list of late deliveries from external vendors.

6. The administrator may review the full list of revenue from affiliate programs, in-building orders, and group buys.

7. The administrator may review the amount that is owed to each building based on the contract that is in place with that building.

C. Advertising Tie-Ins

Products/Services: The delivery system offers a series of diversified and distinct products:

a. Intra-building delivery service for both commercial and residential properties.

b. Affiliate marketing—New customers and orders to existing delivery services such as delivery.com, seamless.com, ubereats.com, amazonnow.com, uberrush.com, googleshopping.com, postmates.com, doordash.com, etc.

c. Ultra-local delivery—Delivery services for food vendors and/or restaurants within the immediate radius and/or inside of buildings containing delivery system kiosks.

d. Advertising—The delivery system provides advertising space on its web portals to delivery services and outside vendors.

e. Group Purchasing—The delivery system allows businesses within an delivery system-enabled building to pool purchasing together for goods and services in order to collectively save money through progressive group discounts called “Group Buys”

g. Resale: This data may be resold to existing mapping and data systems as another layer of unique meta-data.

h. Applications: This data can be utilized for understanding marketing-user behavior, intra-building travel times and how they would affect building safety, government regulation of total building truck load acceptance, and utility companies looking to understand time required to fix services within a building.

VI. Conclusion

It is contemplated that any optional feature of the inventive variations described may be set forth and claimed independently, or in combination with any one or more of the features described herein. Reference to a singular item, includes the possibility that there is a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the to be appended claims. It is further noted that the appended claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the to be appended claims shall allow for the inclusion of any additional element irrespective of whether a given number of elements are enumerated in the to be appended claim, or the addition of a feature could be regarded as transforming the nature of an element set forth in the to be appended claims. Except as specifically defined herein, all technical and scientific terms used herein are to be given as broad a commonly understood meaning as possible while maintaining to be appended claim validity.

The breadth of the present invention is not to be limited to the examples provided and/or the subject specification, but rather only by the scope of the to be appended claim language. Use of the term “invention” herein is not intended to limit the scope of the appended claims in any manner. Rather it should be recognized that the “invention” includes the many variations explicitly or implicitly described herein, including those variations that would be obvious to one of ordinary skill in the art upon reading the present specification. Further, it is not intended that any section of this specification (e.g., the Summary, Detailed Description, Abstract, Field of the Invention, etc.) be accorded special significance in describing the invention relative to another or the to be appended claims. All references cited are incorporated by reference in their entirety. Although the foregoing invention has been described in detail for purposes of clarity of understanding, it is contemplated that certain modifications may be practiced within the scope of the to be appended claims.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A system for providing delivery services, the system comprising:
a user order module interfacing with an coordinating system for storing user ordering information related to an order of a delivery package from a provider to a customer within a secure building;
an external delivery module interfacing with the coordinating system for storing external delivery information related to arranging delivery of the delivery package from the provider to a transfer point within the secure building; and
an internal delivery module interfacing with the coordinating system for storing internal delivery information related to arranging delivery of the delivery package from the transfer point within the secure building to the customer within the secure building;
wherein the coordinating system comprises a processor, an operating system interfacing with the processor a memory interfacing with the processor, an input/output interface interfacing with the processor, an input/output device, a storage system, and a telecommunications network.

2. The system as in claim 1 further comprising:
a delivery employee module interfacing with the coordinating system for storing employment information related to the employment of at least one runner that is responsible for delivery of the delivery package from the transfer point within the secure building to the customer within the secure building;

3. The system as in claim 2, further comprising:
an administrative module interfacing with the coordinating system for coordinating user order module parameters, external delivery module parameters, internal delivery module parameters and delivery employee module parameters.

4. The system as in claim 3, wherein the user ordering information comprise user data, order data, vendor data and vendor payment data.

5. The system as in claim 3, wherein the external delivery module parameters comprise delivery data and location data.

6. The system as in claim 3, wherein the internal delivery module parameters comprise internal building data and employee assignment data .

7. The system as in claim 3, wherein the delivery employee module parameters comprise employee registration data, employee payment data and employee scheduling data.

8. A method of delivering a package, the method comprising:
a user located within a secure building electronically ordering a package from a vendor;
logging the package as incoming within a secure building electronic delivery system;
a delivery person delivering the package to a first employee located at a transfer point within the secure building;
logging the package as arrived within the secure building electronic delivery system;
a first employee transferring the package to a second employee;
logging the package as outgoing within the secure building electronic external delivery system;
a second employee delivering the package to the user located within the secure building; and
logging the package as delivered within the secure building electronic delivery system;
wherein the secure building electronic delivery system comprises a processor, an operating system interfacing with the processor a memory interfacing with the processor, an input/output interface interfacing with the processor, an input/output device, a storage system, and a telecommunications network.

9. The method as in claim 8, wherein the second employee is assigned to the package before the delivery person delivers the package to the first employee located at the transfer point within the secure building.

10. The method as in claim 8, further comprising registering the first employee and the second employee with the secure building electronic delivery system.

11. The method as in claim 8, further comprising scheduling time slots within the secure building electronic delivery system for the first employee and the second employee to work in the secure building.

12. The method as in claim 8, further comprising a user choosing from a plurality of secured buildings as a location for the package.

13. The method as in claim 8, further comprising a user requesting a building to be added to the secure building electronic delivery system.

14. The method as in claim 8 wherein the vendor is located in the same building as the user.

15. A method comprising:
a plurality of users located within a secure building electronically ordering the same product from a vendor;
logging each of the products as incoming within a secure building electronic delivery system;
a delivery person delivering the products to a first employee located at a transfer point within the secure building;
logging each of the products as arrived within the secure building electronic delivery system;
for each package:
i) a first employee transferring the package to a second employee;
ii) logging the package as outgoing within the secure building electronic external delivery system;
iii) a second employee delivering the packages to the users located within the secure building; and
iv) logging the package as delivered within the secure building electronic delivery system;
wherein the secure building electronic delivery system comprises a processor, an operating system interfacing with the processor a memory interfacing with the processor, an input/output interface interfacing with the processor, an input/output device, a storage system, and a telecommunications network.

16. The method as in claim 15 further comprising an administrator setting the price for the product based on the number of users ordering the product.

17. The method as in claim 16, for each package, the second employee is assigned to the package before the delivery person delivers the package to the first employee located at the transfer point within the secure building.

18. The method as in claim 16, further comprising registering the first employee and the second employee with the secure building electronic delivery system.

19. The method as in claim 16, further comprising scheduling time slots within the secure building electronic delivery system for the first employee and the second employee to work in the secure building.

20. The method as in claim 16 wherein the administrator setting the price for the product based on the number of products ordered.
